(19) United States
(12) Patent Application Publication
(10) Pub. No.: US 2010/0250357 A1
(43) Pub. Date: Sep. 30, 2010

(54) ON-LINE ADVERTISING SYSTEM AND METHOD OF THE SAME

(75) Inventor: Pyong-Taek Kim, Seoul (KR)

Correspondence Address: WOLF GREENFIELD & SACKS, P.C., 600 ATLANTIC AVENUE, BOSTON, MA, 02210-2206, US

(73) Assignee: Golconda Co., Ltd., Seoul (KR)

(21) Appl. No.: 12/301,888

(22) PCT Filed: May 22, 2007
(86) PCT No.: PCT/KR2007/002482

§ 371 Date: Nov. 21, 2008

(30) Foreign Application Priority Data
May 22, 2006 (KR) 10-2006-0045900
Jun. 23, 2006 (KR) 10-2006-0056655
Mar. 14, 2007 (KR) 10-2007-0024739

(51) Int. Cl. G06Q 30/00; G06F 17/30

(52) U.S. Cl. 705/14.23; 705/14.73; 705/14.39; 705/14.71; 707/723

(57) ABSTRACT

Provided are an online advertising system and method, which accumulate, in real time, personal reserves earned upon a multiplicity of customers viewing an advertisement by integrated processing, and award the accumulated reserve, i.e., a member integrated reserve earned jointly by a multiplicity of members, as a discount rate of a purchase price when a purchase signal is issued from a certain customer, to thereby revitalize advertisement viewing and shopping. In accordance with the online advertising system and method of the present invention, a multiplicity of customers earn reserves for advertisement information and product information viewing, the earned reserves are accumulated jointly for members to form member integrated reserve points in real time, and the member integrated reserve points accumulated jointly by the members are paid as a discount rate of a product purchase price of a certain customer in response to a purchase signal from the corresponding customer, thereby revitalizing advertising viewing, and the member integrated reserve points displayed on a website are modified in real time, thereby facilitating the revitalization of consumption.

### TECHNICAL FIELD

The present invention relates to an online advertising system and method, and more particularly, to an online advertising system and method, which accumulate, in real time, personal reserves earned upon a multiplicity of customers viewing an advertisement by integrated processing, and award the accumulated reserve as a discount rate of a purchase price when a purchase signal is issued from a certain customer, to thereby revitalize advertisement viewing and shopping.

### BACKGROUND ART

The national and international online market is rapidly growing. The online market is largely divided into the online advertising market and the online shopping market. While the online advertising market is a market indirectly related to the shopping market as it involves advertisements for companies or products after all, the online market is classified into the pure online advertising market and the online shopping market.

As for the main marketing directions in the online advertising market, marketing is being done in two major directions of “How many customers should this advertisement be exposed to?” and “How effectively can this advertisement be exposed to effective consumers?”.

In the online shopping market, market is being done in one direction of “How many customers can we sell this product to?”.

Therefore, the online advertising market and shopping markets of this type are the markets which aim to expose an advertisement or shopping information to many customers and lead them into product purchase after all. Thus, a variety of advertising techniques or shopping revitalization techniques are being introduced.

One of the typical advertising techniques and shopping revitalization techniques is a method for awarding reserves to customers. Namely, if a certain customer views an advertisement or purchases a product, a predetermined reserve amount suitable for that activity is awarded to the corresponding customer so as to encourage him or her to view more advertisements and purchase more products.

Such a method for awarding a reserve when a customer views an advertisement or purchases a product as in the conventional technique is the method in which fixed marketing costs are divided and paid to a multiplicity of customers who have viewed an advertisement or have purchased a product.

### DISCLOSURE

### Technical Problem

However, the conventional method has the drawback that individual customers cannot feel any particular merit since reserves paid are quite a small amount, and accordingly the reserves have not been a big help to seller's marketing or shopping revitalization through advertising.

Furthermore, unlike advertising, any particular reserves have not been paid in the case that product information is viewed in order to purchase the product. Thus, if someone is not an actual purchaser, they tend not to bother viewing product information, and accordingly the basis for revitalization of shopping has not been established.

### Technical Solution

It is, therefore, an object of the present invention to provide an online advertising system and method, which accumulate, in real time, personal reserves earned upon a multiplicity of customers viewing an advertisement by integrated processing, and award the accumulated reserve, i.e., a member integrated reserve earned jointly by a multiplicity of members, as a discount rate of a purchase price when a purchase signal is issued from a certain customer, to thereby revitalize advertisement viewing and shopping.

It is another object of the present invention to provide an online advertising system and method, which accumulate, in real time, personal reserves earned upon a multiplicity of customers viewing an advertisement by integrated processing, and award the accumulated reserve, i.e., a member integrated reserve earned jointly by a multiplicity of members, as a discount rate of a purchase price when a purchase signal is issued from a certain customer, to thereby increase a reserve amount and revitalize shopping.

It is still another object of the present invention to provide an online advertising system and method, which accumulate, in real time, reserves earned upon a multiplicity of customers viewing an advertisement by integrated processing by category, product price range, and product, and awards the accumulated reserves, i.e., an integrated reserve, as a discount rate of a purchase price of a certain customer when a purchase signal from the corresponding customer is issued, to thereby revitalize advertisement viewing and shopping.

It is still another object of the present invention to provide an online advertising system and method, which provide viewable discount rate information, which has been applied to existing customers who purchased, by product so that a customer can judge at what range of discount rate it is advantageous to issue a purchase signal, to thereby revitalize shopping.

It is still another object of the present invention to provide an online advertising system and method, which display cumulative point information different for each advertisement so that a customer can check which advertisement offers more cumulative points upon selection of an advertisement, and which accumulate, in real time, reserves earned upon a multiplicity of customers viewing an advertisement by integrated processing and awards the accumulated reserves, i.e., a member integrated reserve earned jointly by a multiplicity of members, as a discount rate of a purchase price for a certain customer when a purchase signal is issued from the corresponding customer, to thereby revitalize advertisement viewing and shopping.

It is still another object of the present invention to provide an online advertising system and method, which classify classes of users according to conditions (age, sex, hobby, . . . ) for advertisement viewers specified by a seller, accumulate reserves earned upon a multiplicity of customers viewing an advertisement for integrated accumulation, give class points differentially accumulated by class upon a corresponding user's viewing an advertisement, and clear the class points when a certain user classified into the corresponding class group purchases.

It is still another object of the present invention to provide an online advertising system and method, in which a user specifies a specific product and presets integrated reserve points at a purchase point of time, so that a purchase signal is automatically issued from the corresponding user once the integrated reserve points are accumulated as the preset integrated reserve points of user.

It is still another object of the present invention to provide an online advertising system and method, in which a separate program operating in conjunction with a web browser is installed on a user's computer terminal, and a predetermined number of special discount points awardable upon a product purchase is further awarded only to a user who outputs corresponding product information on the screen, at the time a given number of users preset by the seller is viewing the corresponding product information.

It is still another object of the present invention to provide an online advertising system and method, which output user's purchase desired product information, integrated reserve point information, and a screen with a purchase decision means on the corresponding screen in conjunction with the screen pages of a variety of application programs including a word-processing program, an image editing program, a game program, and a windows explorer program that run in Windows, to thereby make it easier to check point information and rapidly issue a purchase decision signal.

It is still another object of the present invention to provide an online advertising system and method, in which an advertising/sales assistant buys an account for advertising expenses of a web server outputting product advertisements and the management is done such that the payment of incentives can be made from a relevant product provider upon sale of a corresponding advertised product, to thereby conduct active public relations for an integrated reserve point awarding system and revitalize the sale of the corresponding product.

It is still another object of the present invention to provide an online advertising system and method, which re-align screen output of information on searched companies outputted by entering a keyword in the search window in association with search portals in the descending order of integrated reserve points cumulatively earned according to a user's selection, or in the order of event generation, or by region.

It is still another object of the present invention to provide an online advertising system and method, which continue to accumulate prize money divided in given time units at a preset period of time by integrally accumulating reserve amounts for individuals in response to clicking on an advertisement, and pay the prize money at a corresponding time point to a user in response to the user's clicking during accumulation, to thereby revitalize clicking on advertisement data.

It is still another object of the present invention to provide an online advertising system and method, which execute an integrated cumulative prize winning process and at the same time execute an individual cumulative prize winning process for each advertisement data (or the homepage of an advertiser company) by dividing a target amount for cumulative prize winning per click on advertisement data displayed on the entire homepage of a specific portal or shopping mall, to thereby encourage users to access each advertisement data or the homepage of an advertiser company.

It is still another object of the present invention to provide an online advertising system and method, which give a user a participation time which can participate in the winning auction of an accumulated amount of money in response to a user's clicking on an advertisement, and allows the participation time of the user who can participate in the winning auction service of an accumulated amount of money to be controlled by the number of advertisement views and an advertisement viewing time, to thereby promote more advertisement viewings.

It is still another object of the present invention to provide an online advertising system and method, which allow a user to freely accumulate an auction participation time capable of participating in the winning auction service of an accumulated amount of money by outputting advertisement data for participation in the winning auction service of an accumulated amount of money to the cellular phone of the corresponding user through the wireless internet by the user's cellular phone authentication.

It is still another object of the present invention to provide an online advertising system and method, which indicate information of an accumulated amount of time which can participate in the winning auction service of an accumulated amount of money, in specific leading keywords among a plurality of similar keywords linked in advance, so that it can be outputted in the keyword window by a specific keyword entered in the search window, and provide a predetermined auction participation time to the corresponding user and outputs search results if the corresponding leading keyword indicating the information of an accumulated amount of time is selected/entered, to thereby encourage the user to enter a specific leading keyword and accordingly output a specific advertisement as a result of the keyword.

### ADVANTAGEOUS EFFECTS

As described above, the online advertising system and method in accordance with the present invention have the merits that a multiplicity of customers earn reserves for advertisement information and product information viewing, the earned reserves are accumulated jointly for members to form member integrated reserve points in real time, and the member integrated reserve points accumulated jointly by the members are paid as a discount rate of a product purchase price of a certain customer in response to a purchase signal from the corresponding customer, thereby revitalizing advertising viewing, and the member integrated reserve points displayed on a website are modified in real time, thereby facilitating the revitalization of consumption.

### DESCRIPTION OF DRAWINGS

The above and other objects and features of the present invention will become apparent from the following description of the preferred embodiments given in conjunction with the accompanying drawings, in which:

FIG. 1 is a perspective view showing the configuration of an online advertising system in accordance with a first embodiment of the present invention;

FIG. 2 is a status view showing a data flow of the online advertising system in accordance with the first embodiment of the present invention;

FIG. 3 is a view showing a website screen provided in the server of the online advertising system in accordance with the first embodiment of the present invention;

FIG. 4 is a block diagram showing the configuration of the online advertising management server in accordance with the first embodiment of the present invention;

FIG. 5 is a flowchart showing a signal flow of the online advertising system in accordance with the first embodiment of the present invention;

FIGS. 6 and 7 are views showing a website screen using an online advertising system in accordance with a second embodiment of the present invention;

FIGS. 8 and 9 are flowcharts showing a signal flow of the online advertising system in accordance with the second embodiment of the present invention;

FIG. 10 is a view showing a website main screen using an online advertising system in accordance with a third embodiment of the present invention;

FIG. 11 is a view showing a data processing state using the online advertising system in accordance with the third embodiment of the present invention;

FIG. 12 is a flowchart showing a signal flow of the online advertising system in accordance with the third embodiment of the present invention;

FIG. 13 is a view showing a data processing state through an online advertising system in accordance with a fourth embodiment of the present invention;

FIG. 14 is a block diagram showing the configuration of the online advertising management server in accordance with the fourth embodiment of the present invention;

FIG. 15 is a flowchart showing a signal flow of the online advertising system in accordance with the fourth embodiment of the present invention;

FIG. 16 is a view showing a data processing state through an online advertising system in accordance with a fifth embodiment of the present invention;

FIG. 17 is a block diagram showing the configuration of the online advertising management server in accordance with the fifth embodiment of the present invention;

FIG. 18 is a flowchart showing a signal flow of the online advertising system in accordance with the fifth embodiment of the present invention;

FIG. 19 is a view showing a data processing state through an online advertising system in accordance with a sixth embodiment of the present invention;

FIG. 20 is a flowchart showing a signal flow of the online advertising system in accordance with the sixth embodiment of the present invention;

FIG. 21 is a view showing a web browser screen outputted from user terminals of an online advertising system in accordance with a seventh embodiment of the present invention;

FIG. 22 is a view showing a data processing state through the online advertising system in accordance with the seventh embodiment of the present invention;

FIG. 23 is a frame format schematically showing the configuration of an online advertising system in accordance with an eighth embodiment of the present invention;

FIG. 24 is a flowchart showing a signal flow of the online advertising system in accordance with the eighth embodiment of the present invention;

FIG. 25 is a view showing a web page screen provided in the server of an online advertising system in accordance with a ninth embodiment of the present invention;

FIG. 26 is a flowchart showing a signal flow of the online advertising system in accordance with the ninth embodiment of the present invention;

FIG. 27 is a frame format schematically showing the configuration of an online advertising system in accordance with a tenth embodiment of the present invention;

FIG. 28 is a view showing the screen of the homepage of a portal site implemented through the online advertising system in accordance with the tenth embodiment of the present invention;

FIG. 29 is a block diagram showing the configuration of the online advertising management server included in the online advertising system in accordance with the tenth embodiment of the present invention;

FIG. 30 is a flowchart showing a signal flow of the online advertising system in accordance with the tenth embodiment of the present invention;

FIGS. 31 and 32 are flowcharts showing another signal flow of the online advertising system in accordance with the tenth embodiment of the present invention;

FIGS. 33 and 34 are flowcharts showing a prize winner selection process of the online advertising system in accordance with the tenth embodiment of the present invention;

FIG. 35 is a view showing the screen of the homepage of a portal site implemented through an online advertising system in accordance with an eleventh embodiment of the present invention;

FIGS. 36 and 37 are a flowchart showing a signal flow of the online advertising system in accordance with the eleventh embodiment of the present invention;

FIG. 38 is a view showing the screen of the homepage of a portal site implemented through an online advertising system in accordance with a twelfth embodiment of the present invention;

FIG. 39 is a flowchart showing a signal flow of the online advertising system in accordance with the twelfth embodiment of the present invention;

FIG. 40 is a frame format schematically showing the configuration of an online advertising system in accordance with a thirteenth embodiment of the present invention;

FIG. 41 is a flowchart showing a signal flow of the online advertising system in accordance with the thirteenth embodiment of the present invention;

FIGS. 42 and 43 are views showing the screen of the homepage of a portal site implemented through an online advertising system in accordance with a fourteenth embodiment of the present invention; and

FIG. 44 is a flowchart showing a signal flow of the online advertising system in accordance with the fourteenth embodiment of the present invention.

### BEST MODE

Hereinafter, a first embodiment of the present invention will be described in detail with reference to the accompanying drawings.

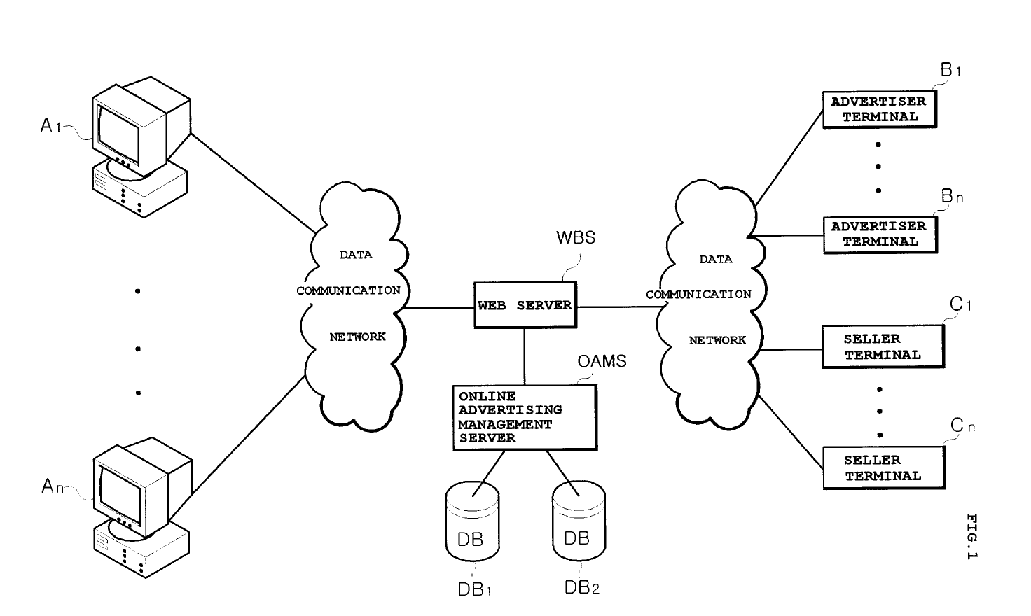

FIG. 1 is a perspective view showing the configuration of an online advertising system in accordance with a first embodiment of the present invention.

Referring to FIG. 1, the online advertising system in accordance with a first embodiment of the present invention accumulates, in real time, personal reserves earned upon a multiplicity of customers viewing an advertisement by integrated processing, and awards the accumulated reserve, i.e., a member integrated reserve earned jointly by a multiplicity of members, as a discount rate of a purchase price when a purchase signal is issued from a certain customer, to thereby revitalize advertisement viewing and shopping.

Further, the online advertising system in accordance with a first embodiment of the present invention accumulates, in real time, personal reserves earned upon a multiplicity of customers viewing an advertisement by integrated processing, and awards the accumulated reserve, i.e., a member integrated reserve earned jointly by a multiplicity of members, as a discount rate of a purchase price when a purchase signal is issued from a certain customer, to thereby increase a reserve amount and revitalize shopping.

In other words, the online advertising system in accordance with the first embodiment of the present invention determines whether a corresponding customer has ever viewed the same advertisement and product information by using the log-in information of the corresponding customer at the instant when a multiplicity of customers who has accessed a specific shopping mall for product shopping clicks on the button for viewing an advertisement or product information, and awards member integrated reserve points only to the corresponding customer if the corresponding customer newly views the corresponding product information and advertisement.

Here, the member integrated reserve points refer to points that are earned by integrating and accumulating all members points in reward for an advertisement and product information viewed by a multiplicity of customers. When a certain customer issues a product purchase signal, he or she can be awarded a price discount for the corresponding product by using all the member integrated reserve points accumulated up to that point of time.

As a conventional reserve system is only a user's own use of his or her reserve, the reserve amount is relatively quite small and thus does not contribute to the revitalization of shopping at all. On the other hand, the online advertising system in accordance with the first embodiment of the invention makes a large contribution to the revitalization of shopping since a specific customer purchasing a product can use the member integrated reserve points accumulated by a multiplicity of members.

Further, with a predetermined amount of the member integrated reserve points accumulated, when a certain customer purchases a product, the accumulated points are cleared to zero (0). Thus, afterwards, the members again view an advertisement and product information and accumulate points.

Accordingly, in the online advertising system in accordance with the first embodiment of the present invention, member integrated reserve points displayed on the screen in a corresponding shopping mall website are changed in real time.

To this end, the online advertising system in accordance with the first embodiment of the present invention is provided with user terminals A1 to An having a communication module, such as a modem, mounted thereon, for viewing advertisement information and product information displayed on web pages by accessing the web pages of an online advertising management server OAMS that offers member integrated reserve points.

In addition, the online advertising system in accordance with the first embodiment of the present invention is provided with first to N-th advertiser terminals B1 to Bn which provide and display advertisement information on the web pages of the online advertising management server OAMS so as to view advertisement information through the user terminals A1 to An, and offer a predetermined amount of member integrated reserve points for a customers' advertisement viewing.

Further, the online advertising system in accordance with the first embodiment of the present invention is provided with first to N-th seller terminals C1 to Cn, which provide and displays product information on the web pages of the online advertising management server OAMS so as to view product information through the user terminals A1 to An, and offer a predetermined amount of member integrated reserve points for the customers' viewing the product information; and

Meanwhile, the online advertising system in accordance with the first embodiment of the present invention is provided with the online advertising management server OAMS, which receives advertisement information and product information from the first to N-th advertiser terminals B1 to Bn and the first to N-th seller servers C1 to Cn and displays them on web pages, cumulatively accumulates member integrated reserve points in response to advertisement information and product information viewing signals transmitted from the user terminals A1 to An, performs a discount processing on the purchase price of a corresponding customer with the member integrated reserve points upon receipt of the customers' product purchase signal, updates reserve point data, and sells products uploaded by the seller.

Further, the online advertising management server OAMS is provided with a web server WBS for routing the URL of the online advertising management server OAMS so that the first to N-th advertiser terminals B1 to Bn, the first to N-th seller servers C1 to Cn, and the user terminals A1 to An can access the online advertising management server OAMS; and first and second databases DB1 and DB2 for storing the member integrated reserve point update information and customer purchase signals, customer information, seller information, advertiser information, advertising/seller assistant information, and equity information for each advertising/seller assistant.

Thus, in the online advertising system in accordance with the first embodiment of the present invention, when a multiplicity of customers access a webpage provided by the online advertising management server OAMS and selects advertisement information and product information displayed on the webpage of the online advertising management server OAMS, member integrated reserve points are accumulated by corresponding members information selection signals.

At this time, even if a plurality of members select the advertisement information and product information displayed on the webpage of the online advertising management server OAMS, reserves are not accumulated as individual reserves for the corresponding members, but accumulated as member integrated reserve points jointly by the members.

In addition, the member integrated reserve points accumulated in the webpage of the online advertising management server OAMS are awarded as discount points to a member who has viewed the product information displayed on the corresponding webpage and wants to buy the product. Therefore, when the member integrated reserve points are awarded to a certain customer as discount points, the member integrated reserve points are all cleared, and thus reserve points start to be accumulated again, starting from a zero state (0).

Hence, the online advertising management server OAMS checks members log-ins for authentication processing, and checks the situations of selection of advertisement information or product information by a multiplicity of members who access for accumulating the integrated reserve points, checks the issuance of a purchase signal from a certain member to award member integrated reserve points to the corresponding purchase member as purchase discount points, and updates the member integrated reserve points in real time.

Preferably, the online advertising management server OAMS provides advertisement information differentiated by age, sex, and region of a customer based on members log-in information so that the corresponding customer can view the advertisement information more willingly. At this time, it is preferable that the advertisement information differentiated by age, sex, and region of customers is configured based on information provided from seller servers C1 to Cn. Namely, as the seller configures advertisement information differentiated by age, sex, and region of customers as a target advertisement for a corresponding sales item, advertisements differentiated according to the web browsers of computer terminals A1 to An for each customer can be outputted by matching the advertisement information with members information.

Further, the online advertising management server OAMS may preset a maximum amount of reserve attainable by clicking according to the seller or advertiser company's request. In other words, it is possible to preset a minimum selling price of a product available displayed in the online advertising management server OAMS according to the seller or advertiser company's request. In this case, such minimum selling price information should be put up in the online advertising management server OAMS.

It is also possible to differentiate the display order of an advertisement or product information according to reserve amounts accumulated in the online advertising management server OAMS. For example, if the display order can be preset such that 10 points of cumulative reserve are earned upon viewing an advertisement displayed at the uppermost edge of the website of the online advertising management server OAMS, 9 points of cumulative reserve can be preset to be earned upon viewing an advertisement thereunder.

Moreover, the online advertising management server OAMS can set an amount of reserve to be earned for each advertisement and product information. For example, when 100 points are preset for a certain advertisement and thus all of the 100 integrated points are paid according to a multiplicity of customers selection, the corresponding advertisement may be automatically deleted from the webpage of the online advertising management server OAMS.

Besides, it is preferable that the online advertising management server OAMS identifies a corresponding member through the members' log-in information, and separately manages each members' viewing information of advertisement information and product information, so that member integrated reserve points are not paid upon the same members' viewing the same advertisement.

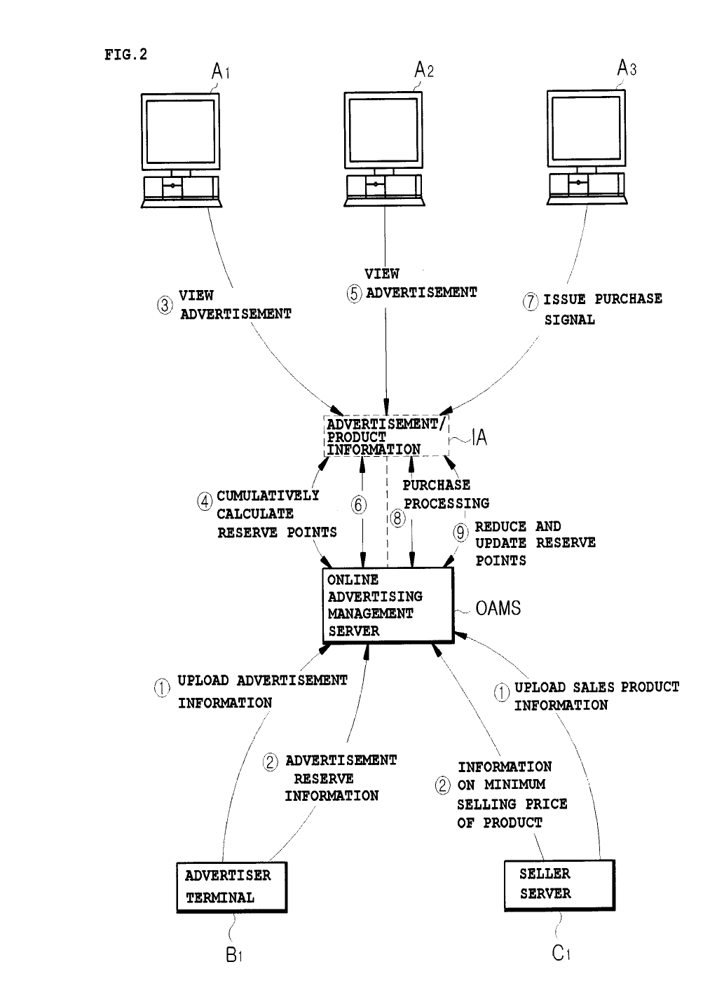

FIG. 2 is a status view showing a data flow of the online advertising system in accordance with the first embodiment of the present invention.

Referring to FIG. 2, in the online advertising system in accordance with the first embodiment of the present invention, a plurality of user terminals (e.g., A1, A2, A3) are connected to an online advertising management server OAMS which selects advertisement information and product information by a multiplicity of members to thus give member integrated reserve points, integrates and accumulates them until a product purchase signal is issued from a specific customer, and pays the member integrated reserve points as discount points when the product purchase signal is issued. Also, an advertiser terminal B1 and a seller server C1 are connected to the online advertising management server OAMS for uploading the advertisement information and sales information thereto.

In this state, the online advertising management server OAMS puts up advertisement information and product information uploaded from an advertiser terminal B1 and a seller server C1 through a separate webpage, to thereby provide them so as be viewable by customers through the user terminals A1, A2, and A3, and puts up reserve information for each advertisement information and product information.

Then, when a viewing signal for the advertisement information and product information displayed on the webpage is applied from the user terminals A1, A2, and A3, the online advertising management server OAMS gives, as member integrated reserve points, a reserve to be earned for the corresponding advertisement information and product information, to thereby update the information of the member integrated reserve points.

In this state, when a purchase signal for a specific product is applied from any one of the user terminals (e.g., A3) to the online advertising management server OAMS, the member integrated reserve points accumulated up to a corresponding point of time are awarded as discount points of the corresponding purchased product, and the online advertising management server OAMS clears all the member integrated reserve points and performs the same accumulation process again.

Therefore, in the online advertising management server OAMS, the accumulation of points for viewing advertisement information and product information is processed in real time, and the member integrated reserve points are cleared in real time upon receipt of a purchase signal.

Such a point awarding activity of the online advertising system in accordance with the first embodiment of the present invention has a similar to a mutual financing association from the aspect that points are integrated and awarded to a purchase customer who purchases a product that is purchased by a multiplicity of customers. However, the mutual financing association awards a predetermined accumulated amount of money deposited by all members in turn, while the online advertising system in accordance with the first embodiment of the present invention awards member integrated reserve points to only a purchase customer. Therefore, the online advertising system in accordance with the first embodiment of the present invention is different from the mutual financing association in terms of service itself.

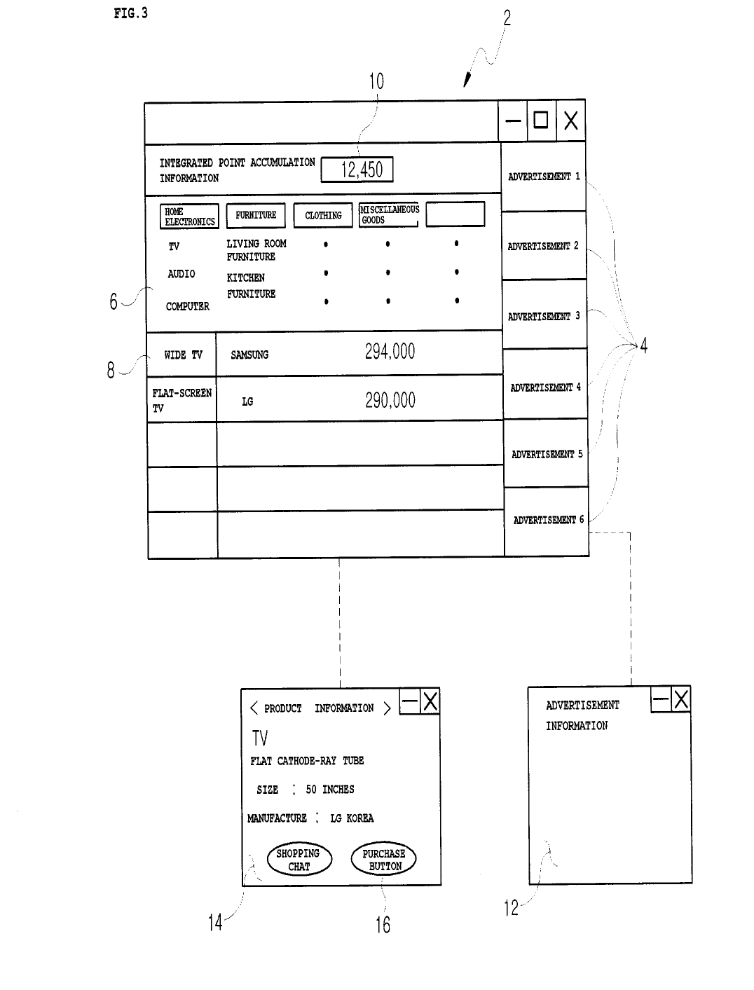

FIG. 3 is a view showing a website screen provided in the server of the online advertising system in accordance with the first embodiment of the present invention.

Referring to FIG. 3, a plurality of advertisement information output fields 4 are displayed on the main screen 2 of the website of the online advertising management server OAMS so as to be viewable. As the online advertising management server OAMS awards member integrated reserve points as purchase discount points, advertisement information and another advertisement information for outputting payment information are displayed on the main screen 2 of the website through popup windows. The product information is organized through an information field 6 classified by category, and detailed product information fields 8 selectable by category are provided.

Further, advertisement information output fields 4 provided available are stored in hyperlink status in the online advertising management server OAMS, by being linked to a popup window 12 for outputting the corresponding advertisement information in detail when a customer selects the advertisement information output fields 4 by using computer terminals A1 to An. And, the detailed product information fields 8 displayed on the main screen of the online advertising management server OAMS are stored in hyperlink status in the online advertising management server OAMS so that detailed information of the corresponding product information is outputted in a popup window 14 when the detailed product information fields 8 are selected. The corresponding product can be purchased by choosing a purchase button 16 in the detailed product information fields 8.

Meanwhile, at the upper edge of the main screen 2 of the website of the online advertising management server OAMS, an integrated point accumulation information field 10 is provided for outputting integrated point accumulation information earned by a multiplicity of members clicking on the advertisement information output fields 4 and the detailed product information fields 8. A customer who wants to buy a product can check the integrated point accumulation information field 10 and buy the product at a discount for the purchase price of the product by using the corresponding accumulated amount of money.

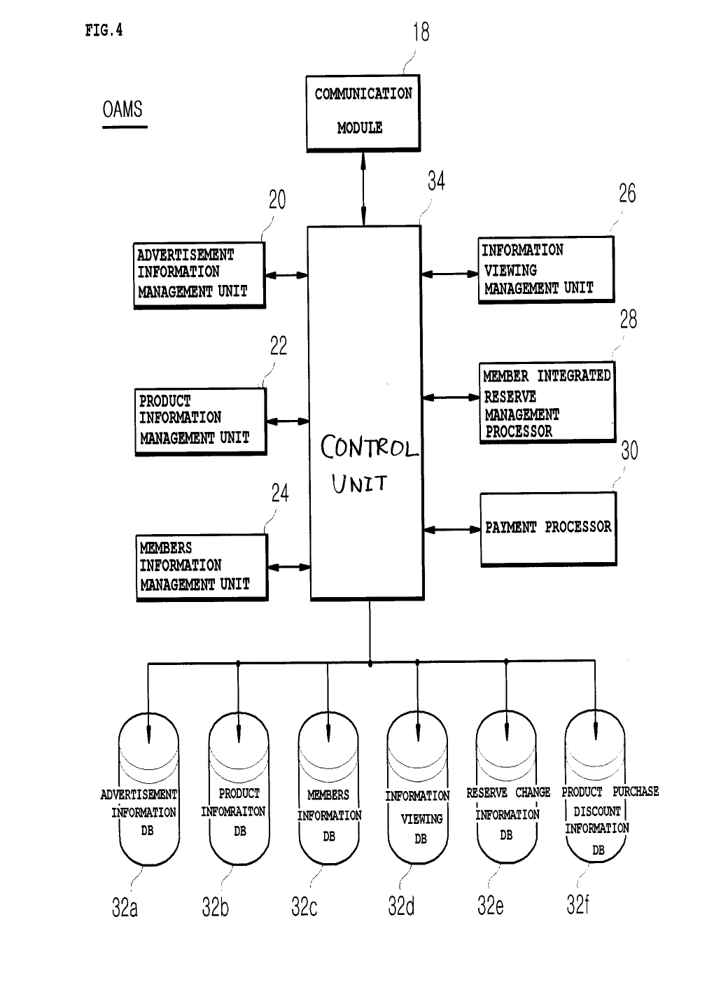

FIG. 4 is a block diagram showing the configuration of the online advertising management server in accordance with the first embodiment of the present invention.

Referring to FIG. 4, the online advertising management server OAMS receives advertisement information and product information from the first to N-th advertiser terminals B1 to Bn and the first to N-th seller servers C1 to Cn and displays them on web pages, cumulatively accumulates member integrated reserve points in response to advertisement information and product information viewing signals transmitted from the user terminals A1 to An, performs a discount processing on the purchase price of a corresponding customer with the member integrated reserve points upon receipt of the customers' product purchase signal, updates reserve point data, and sells products uploaded by the seller.

That is, the online advertising management server OAMS is a server which gives points for a multiplicity of customers viewing advertisement information and product information, integrates and updates the points, pays all of the member integrated reserve points accumulated to a certain customer as a purchase discount amount upon the corresponding customers' issuing a purchase signal for a specific product for clear, and repeats the above procedure, thereby revitalizing shopping and advertisement viewing.

Therefore, the online advertising management server OAMS incorporates therein a communication module, an advertisement information management unit, a product information management unit, a members information management unit, an information viewing management unit, a member integrated reserve management processor, a payment processor, an advertisement information DB, a product information DB, a members information DB, an information viewing DB, a reserve change information DB, a product purchase discount information DB, and a control unit.

Reference numeral 18 denotes a communication module which receives advertisement information and product information from first to N-th advertiser terminals B1 to Bn and first to N-th seller servers C1 to Cn to display them on web pages, and is provided with a modem in order to receive advertisement information and product information viewing signals transmitted from user terminals A1 to An.

Reference numeral 20 represents an advertisement information management unit which uploads and displays advertisement information provided from the first to N-th advertiser terminals B1 to Bn, and checks and manages a customer?access status to the corresponding advertisement information.

Reference numeral 22 represents a product information management unit which uploads and displays product information provided from the first to N-th seller servers C1 to Cn, and checks and manages a customers' access status to the corresponding product information.

Reference numeral 24 represents a members information management unit which manages members information such as members gender, age, and region so as to enable target advertisement for member individuals, and reference numeral 26 represents an information viewing management unit which manages viewing information for each member about advertisement information and product information in conjunction with the advertisement information management unit 20 and the product information management unit 22.

Reference numeral 28 represents a member integrated reserve management processor which receives advertisement information and product information viewing signals transmitted from the user terminals A1 to An and updates member integrated reserve information, and makes payment processing of the corresponding member integrated reserve in response to a product purchase signal transmitted from one of the user terminals A1 to An, to thereby clear the corresponding member integrated reserve.

Reference numeral 30 represents a payment processor which executes the payment processing for a purchase discount using an accumulated member integrated reserve in response to a product purchase signal transmitted from any one of the user terminals A1 to An in conjunction with the member integrated reserve management processor 28.

Reference numeral 32a represents an advertisement information DB for storing advertisement information provided from the first to N-th advertiser terminals B1 to Bn, and reference numeral 32b represents a product information DB for storing product information provided from the first to N-th seller servers C1 to Cn.

Reference numeral 32c represents a members information DB which stores members information such as members gender, age, region, etc. so as to enable target advertisement for member individuals, and reference numeral 32d represents an information viewing DB which stores viewing information for each member about advertisement information and product information in conjunction with the advertisement information management unit 20 and the product information management unit 22.

Reference numeral 32e represents a reserve change information DB which receives advertisement information and product information viewing signals transmitted from the user terminals A1 to An and updates and stores member integrated reserve information, and updates and stores the corresponding member integrated reserve paid in response to a product purchase signal from a certain customer.

Reference numeral 32f represents a product purchase discount information DB which stores information on a purchase discount using an accumulated member integrated reserve in response to a product purchase signal transmitted from any one of the user terminals A1 to An in conjunction with the member integrated reserve management processor 28.

Reference numeral 34 represents a control unit which receives advertisement information and product information from first to N-th advertiser terminals B1 to Bn and first to N-th seller servers C1 to Cn to display them on web pages, drives the member integrated reserve management processor 28 in response to advertisement information and product information viewing signals transmitted from user terminals A1 to An to thus cumulatively save member integrated reserve points, gives a discount on the corresponding customers' purchase price with the member integrated reserve points by the payment processor 30 upon receipt of a customers' product purchase signal, and performs a sales representation of products uploaded by sellers by driving the member integrated reserve management processor 28 to update reserve point data, thereby controlling the revitalization of advertisement viewing.

The functions and operations of the online advertising system configured above in accordance with the first embodiment of the present invention will be described in detail with reference to the accompanying drawings.

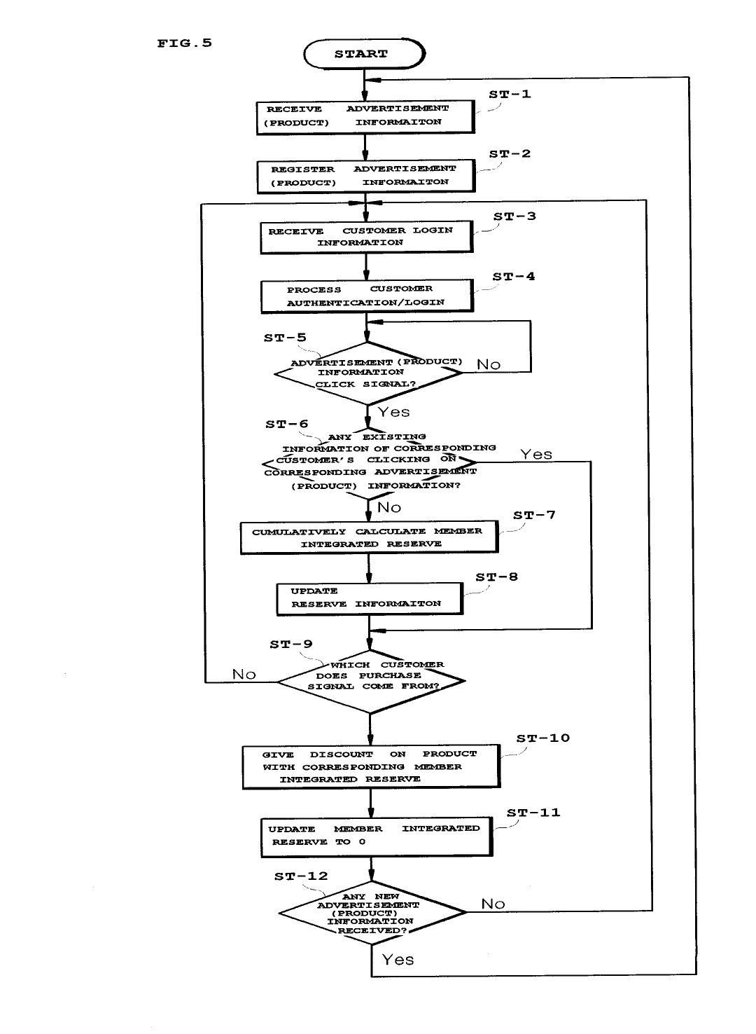

FIG. 5 is a flowchart showing a signal flow of the online advertising system in accordance with the first embodiment of the present invention.

First, in the online advertising system in accordance with the first embodiment of the present invention, a plurality of user terminals (e.g., A1, A2, A3) are connected to an online advertising management server OAMS which selects advertisement information and product information by a multiplicity of members to thus give member integrated reserve points, integrates and accumulates them until a product purchase signal is issued from a specific customer, and pays the member integrated reserve points as discount points when the product purchase signal is issued. Also, an advertiser terminal B1 and a seller server C1 are connected to the online advertising management server OAMS for uploading the advertisement information and sales information thereto.

In this state, the advertiser terminals B1 to Bn and the seller servers C1 to Cn access the online advertising management server OAMS and upload advertisement information and product information on the online advertising management server OAMS, and the online advertising management server OAMS displays the uploaded advertisement information and product information through separate web pages (ST-1 and ST-2).

Next, when an ID and password information are transmitted from the user terminals A1 to An (ST-3), the online advertising management server OAMS executes the customers' log-in process by authentication procedure of the corresponding information (ST-4).

Then, the online advertising management server OAMS determines whether any viewing signal for a specific advertisement or product information is applied from the user terminals A1 to An (ST-5). If any viewing signal is applied, it extracts prestored information about members who have viewed the corresponding advertisement or product information and determines whether the corresponding customer has ever viewed the same advertisement or product information before by their comparison (ST-6).

As a result of the determination of the online advertising management server OAMS, if the corresponding customer has never viewed the corresponding advertisement and product information before, the online advertising management server OAMS gives a predetermined number of points according to the corresponding customers' viewing activity, cumulatively calculates the corresponding points (ST-7), and updates the member integrated reserve point information (ST-8).

On the other hand, as a result of the determination of the online advertising management server OAMS, if the corresponding customer has ever viewed the corresponding advertisement and product information before, the online advertising management server OAMS does not execute the accumulation of member integrated reserve points issued from the corresponding customer.

Further, the online advertising management server OAMS determines whether a purchase signal for a specific product is applied from any one of the user terminals A1 to An (ST-9). If a purchase signal for a specific product is applied from any one of the user terminals A1 to An, the online advertising management server OAMS awards the member integrated reserve points accumulated up to the corresponding point of time as discount points for the corresponding purchased product (ST-10).

Next, the online advertising management server OAMS updates the member integrated reserve points to the initial zero state (0) (ST-11). At this time, the online advertising management server OAMS determines whether an upload signal for separate new advertisement or product information is applied (ST-12). If an upload signal for separate new advertisement or product information is applied, the process returns to the step of uploading the corresponding information. If any upload signal for separate new advertisement or product information is not applied, the process returns to the step of customer log-in to repeat the member integrated reserve awarding process and the sales activity for a customer who purchases a product, as set forth above.

Consequently, the online advertising management server OAMS processes, in real time, the accumulation of points for advertisement information and product information viewing, and also performs the clearing process of the member integrated reserve points in real time upon receipt of a purchase signal.

### MODE FOR INVENTION

Hereinafter, a second embodiment of the present invention will be described in detail with reference to the accompanying drawings.

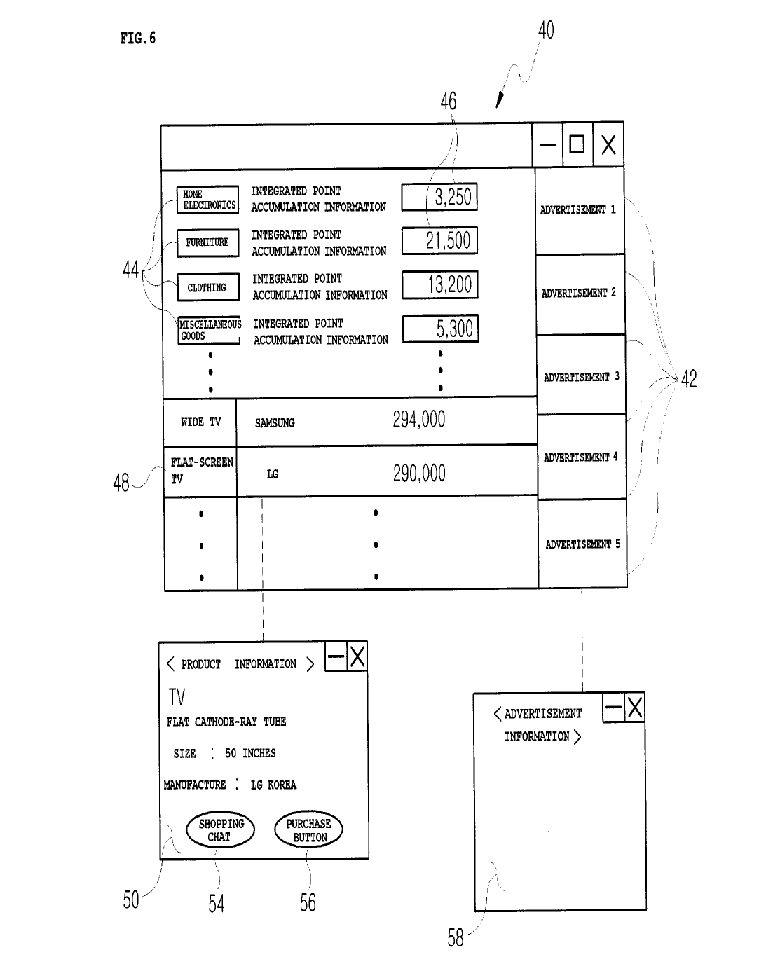

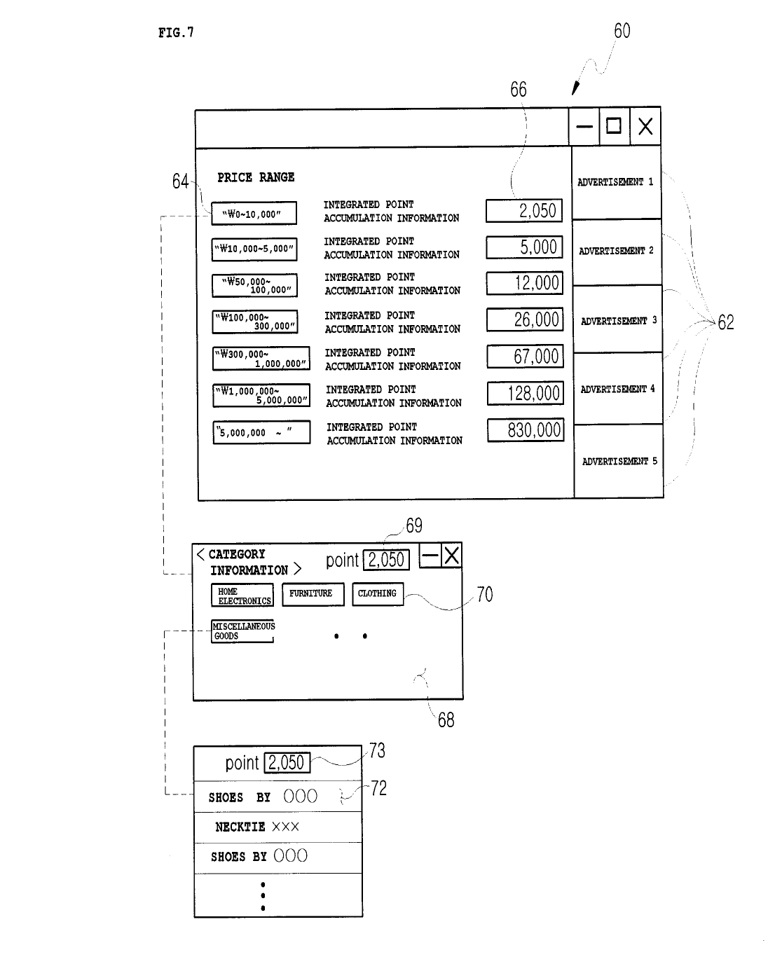

FIGS. 6 and 7 are views showing a website screen using an online advertising system in accordance with a second embodiment of the present invention.

Referring to these drawings, the online advertising system in accordance with the second embodiment of the present invention is a system which accumulates, in real time, reserves earned upon a multiplicity of customers viewing an advertisement by integrated processing by category, product price range, and product, and awards the accumulated reserves, i.e., a member integrated reserve earned jointly by a multiplicity of members, as a discount rate of a purchase price of a certain customer when a purchase signal is issued from the corresponding customer, thereby revitalizing advertisement viewing and shopping.

That is, the member integrated reserve points given by the online advertising management server OAMS may be integrated points given for the entire products, or different integrated points may be given by product category, product price range, or product.

Preferably, the member integrated reserve points given by the online advertising management server OAMS are given differently by product category, product price range, or product, rather than being given for the entire products.

As selling prices are different for each of products available in the online advertising management server OAMS and for each product category, for example, discount purchase points of -W20,000 (where -W is the unit of Korean currency) are quite a small discount rate of a purchase price for a customer who wants to purchase a car, while discount purchase points of -W20,000 are quite a big discount rate for a customer wanting to purchase a pair of jeans equivalent to -W50,000, it is preferable to differentiate point amounts accumulated by product or category. More precisely, the accumulation of reserves should be differentiated according to the selling price of each product.

For this purpose, as shown in FIG. 6, integrated point accumulation information fields 46 are created by category, product, or selling price range on the main screen 40 of the website of the online advertising management server OAMS. Accumulated points may be updated in the integrated point accumulation information fields 46 displayed on corresponding categories 44 upon viewing advertisements 42 or product information 48 in the corresponding categories, or accumulated points may be updated in the integrated point accumulation information fields 46 provided by product and price range.

Accordingly, in the website of the online advertising management server OAMS, when a certain product category is selected, a separate advertisement information output field (not shown) different from the advertisement information output fields 42 displayed on the main screen 40 may be displayed.

Further, as shown in FIG. 7, integrated point accumulation information fields 66 are created by selling price range on the main screen 60 of the web site of the online advertising management server OAMS, and accumulated points are updated in the integrated point accumulation information fields 66 displayed by sale price range upon viewing advertisements 62 or product information 72 in the corresponding categories.

Namely, the online advertising system in accordance with the second embodiment of the present invention gives member integrated reserve points upon a customers' viewing advertisement information 62 or product information 72. Upon giving member integrated reserve points, if the corresponding customer selects one of a plurality of classified price ranges, member integrated reserve points given to the selected price range are accumulated.

More concretely, in the website of the online advertising management server OAMS, a multiplicity of products available in the online advertising management server OAMS are classified by price range. For example, price ranges are classified into “-W0˜10,000”, “-W10,000˜50,000”, “-W50,000˜100,000”, “-W100,000˜300,000”, “-W300,000˜1,000,000”, “-W1,000,000˜5,000, 000” and “-W5,000,000˜”. Thus, it is preferable that a customer directly selects a price range for member integrated reserve points to be given when the customer views advertisement information 62 or product information 72, to thereby accumulate the member integrated reserve points of the selected price range. Hence, the customer is able to accumulate points given to himself or herself to the member integrated reserve points given to the price range in which the customer wants to shop.

The functions and operations of the online advertising system configured above in accordance with the second embodiment of the present invention will be described in detail with reference to the accompanying drawings.

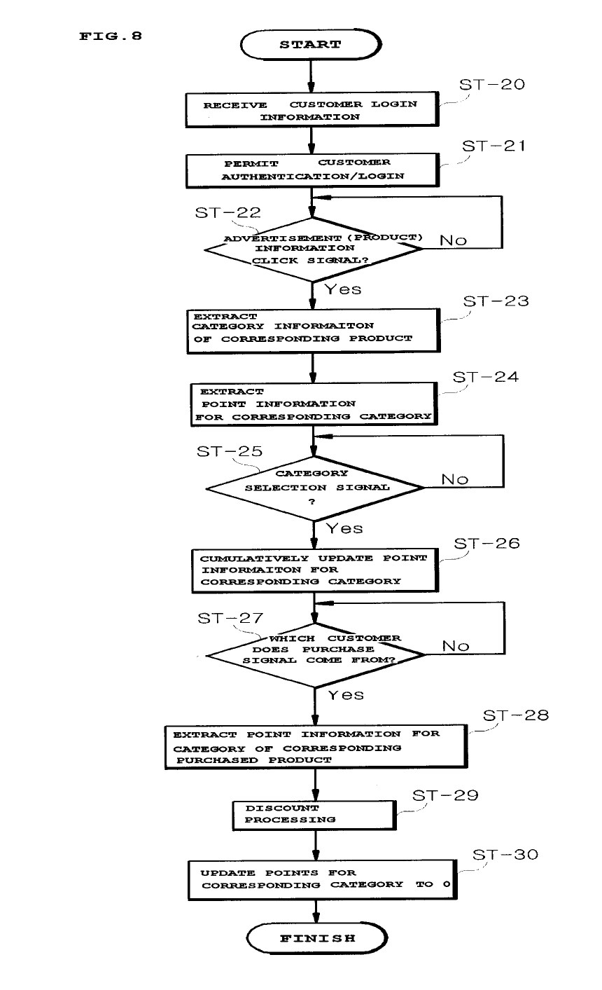

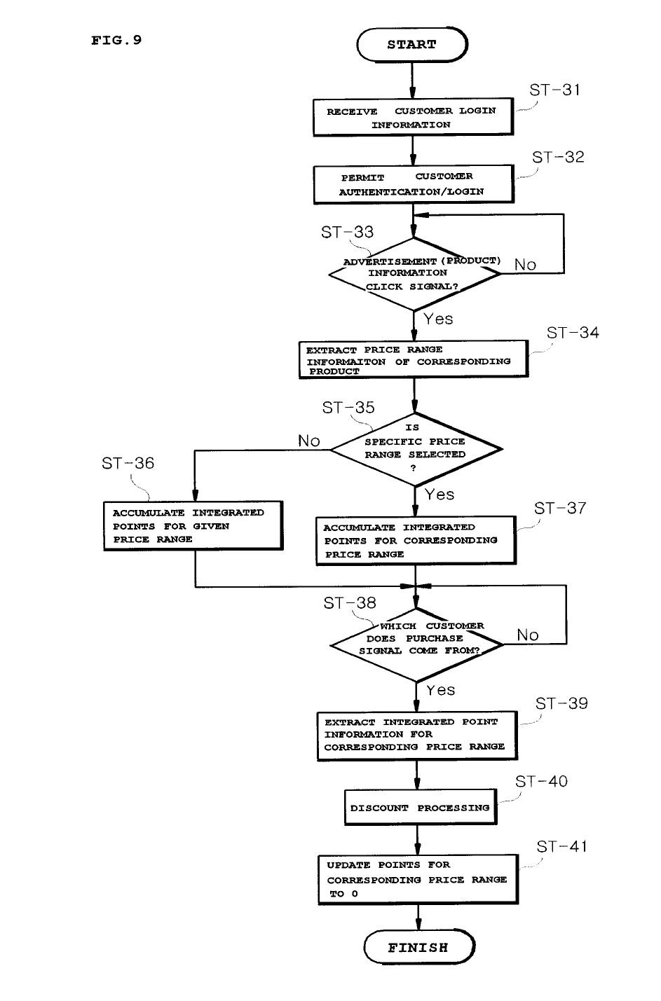

FIGS. 8 and 9 are flowcharts showing a signal flow of the online advertising system in accordance with the second embodiment of the present invention.

FIG. 8 is a view showing a signal flow of the online advertising system in accordance with the second embodiment of the present invention which gives separate member integrated reserve points by category.

First, in the online advertising system in accordance with the second embodiment of the present invention, a plurality of user terminals (e.g., A1, A2, and A3) are connected to the online advertising management server OAMS, which gives member integrated reserve points upon a multiplicity of members' selecting advertisement information and product information, integrates and accumulates them until a specific customer issues a product purchase signal, and pays the member integrated reserve points earned jointly by the members as discount points for the corresponding customer when the purchase signal is issued, and an advertiser terminal B1 and a seller server C1 for uploading advertisement information and sales information to the online advertising management server OAMS are connected thereto.

In this state, when an ID and password information are transmitted from the user terminals A1 to An (ST-20), the online advertising management server OAMS executes customers' log-in process by authentication procedure of the corresponding information (ST-21).

Next, the online advertising management server OAMS determines whether any viewing signal for a specific advertisement or product information is applied from the user terminals A1 to An (ST-22). If any viewing signal is applied, the online advertising management server OAMS extracts category information of a multiplicity of products stored in a database (ST-23 and ST-24).

The online advertising management server OAMS transmits, to the corresponding user terminals A1 to An, a signal for selecting and requesting one of corresponding categories (ST-25). Due to this, the online advertising management server OAMS cumulatively updates the member integrated reserve points accumulated for the corresponding category through the category selection signal transmitted to the user terminals A1 to An (ST-26).

In this state, the online advertising management server OAMS determines whether a purchase signal for a specific product is applied from any one of the user terminals A1 to An (ST-27). If a purchase signal for a specific product is applied from any one of the user terminals A1 to An, the online advertising management server OAMS extracts category information of a product selected by a corresponding customer and member integrated reserve point information accumulated for the corresponding category (ST-28), and awards the member integrated reserve points as discount points for the corresponding purchased product (ST-29).

Further, the online advertising management server OAMS updates the member integrated reserve points for the corresponding category to the initial zero state (0) (ST-30).

Accordingly, the online advertising management server OAMS processes, in real time, the accumulation of points for advertisement information and product information viewing, by category, and also performs the clearing process of the member integrated reserve points in real time upon receipt of a purchase signal.

FIG. 9 is a view showing a signal flow of the online advertising system in accordance with the second embodiment of the present invention which gives separate member integrated reserve points by price range.

In the online advertising system in accordance with the second embodiment of the present invention, a plurality of user terminals (e.g., A1, A2, and A3) are connected to an online advertising management server OAMS which gives member integrated reserve points upon a multiplicity of members selecting advertisement information and product information, integrates and accumulates them until a specific customer issues a product purchase signal, and pays the member integrated reserve points earned jointly by the members as discount points for the corresponding customer when the purchase signal is issued, and an advertiser terminal B1 and a seller server C1 for uploading advertisement information and sales information to the online advertising management server OAMS are connected thereto.

In this state, when an ID and password information are transmitted from the user terminals A1 to An (ST-31), the online advertising management server OAMS executes the customers' log-in process by authentication procedure of the corresponding information (ST-32).

Thereafter, the online advertising management server OAMS determines whether any viewing signal for a specific advertisement or product information is applied from the user terminals A1 to An (ST-33). If any viewing signal is applied, the online advertising management server OAMS extracts price range information of a multiplicity of products stored in a database (ST-34).

Then, the online advertising management server OAMS transmits, to the corresponding user terminals A1 to An, a signal for selecting and requesting one of corresponding price ranges in the corresponding category (ST-35). Due to this, the online advertising management server OAMS cumulatively updates the member integrated reserve points accumulated for the corresponding price range through the price range selection signal transmitted to the user terminals A1 to An (ST-37).

In this state, the online advertising management server OAMS determines whether a purchase signal for a specific product is applied from any one of the user terminals A1 to An (ST-38). If a purchase signal for a specific product is applied from any one of the user terminals A1 to An to the online advertising management server OAMS, the online advertising management server OAMS extracts price range information of a product selected by a corresponding customer and member integrated reserve point information accumulated for the corresponding price range (ST-39), and awards the member integrated reserve points as discount points for the corresponding purchased product (ST-40).

Further, the online advertising management server OAMS updates the member integrated reserve points for the corresponding price range to the initial zero state (0) (ST-41).

Thus, the online advertising management server OAMS processes, in real time, the accumulation of points for viewing advertisement information and product information, by category, and performs the clearing of the member integrated reserve points in real time upon receipt of a purchase signal.

Hereinafter, a third embodiment of the present invention will be described in detail with reference to the accompanying drawings.

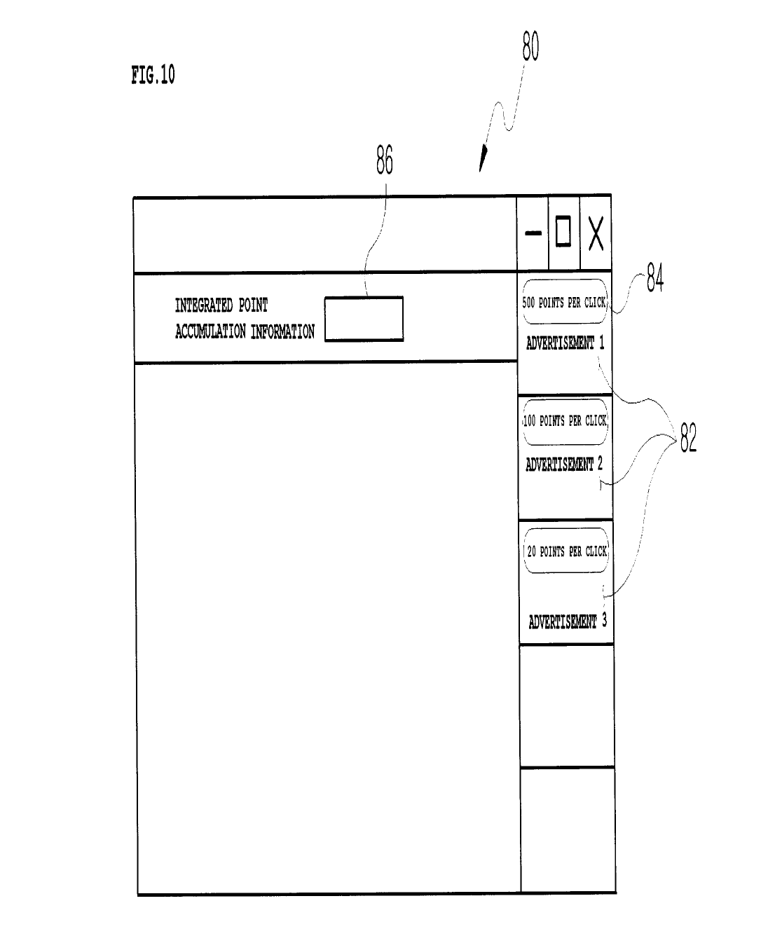

FIG. 10 is a view showing a website main screen through an online advertising system in accordance with a third embodiment of the present invention.

Referring to these drawings, the online advertising system in accordance with the third embodiment of the present invention is a system which displays different cumulative point information for each advertisement so that a customer can check which advertisement offers more cumulative point upon selection of an advertisement, and which accumulates, in real time, reserves earned upon a multiplicity of customers viewing an advertisement by integrated processing and awards the accumulated reserves, i.e., a member integrated reserve earned jointly by a multiplicity of members, as a discount rate of a purchase price for a certain customer when a purchase signal from the corresponding customer is issued, thereby revitalizing advertisement viewing and shopping.

Further, the online advertising system in accordance with the third embodiment of the present invention is a system in which a reserve limit givable by viewing a corresponding advertisement is preset in the server by an advertiser, and once the preset reserve has been all paid by viewing the corresponding advertisement, a note indicative of an advertisement for which no reserve is payable is contained in the advertisement.

That is to say, the online advertising system in accordance with the first embodiment of present invention is a system, in which information on points to be given per advertisement view is displayed within the advertisement according to an advertiser's selection, an advertising rate is fixed in advance and a reserve of only an amount equivalent to the corresponding advertising rate is given upon advertisement viewing to execute effective advertising with fixed amount of money, and information of a point amount given upon viewing and information about whether or not points are payable or not are exposed to customers for each advertisement so that the customers can select.

For example, as shown in FIG. 10, a plurality of advertisement information 82 are displayed on a webpage 80 of the online advertising management server OAMS provided in the online advertising system in accordance with the third embodiment of the present invention, and information 84 of a point amount given upon viewing a corresponding advertisement is contained within each of the advertisement information 82. Also, information 86 of integrated point accumulation to be earned jointly by a multiplicity of members is displayed in the webpage 80.

Therefore, customers can view an advertisement for a larger point amount through the point amount information 84 for each advertisement displayed on the webpage 80 of the online advertising management server OAMS, thereby more effectively accumulating the member integrated reserve points.

It is preferable that the online advertising management server OAMS is configured such that the point amount information 84 for each advertisement displayed on the webpage 80 is arranged in the descending order of point amounts to make a customers' viewing easier.

Meanwhile, the online advertising management server OAMS can preset a total point amount to be paid by viewing a corresponding advertisement according to an advertiser's request, and set a predetermined amount of payment for advertisements in such a manner as to reduce the number of points to be paid per advertisement view from the total point amount whenever a multiplicity of customers view one time. At this time, if the total point amount set for each advertisement is all cleared, the online advertisement managing server OAMS transmits advertisement point amount clearing information to the corresponding advertiser terminals B1 to Bn.

In addition, the online advertising management server OAMS has a program mounted thereon, for automatically deleting corresponding advertisement information from the webpage 80 or re-arranging the advertisement information in low priority if the total point amount set for the advertisement is all cleared.

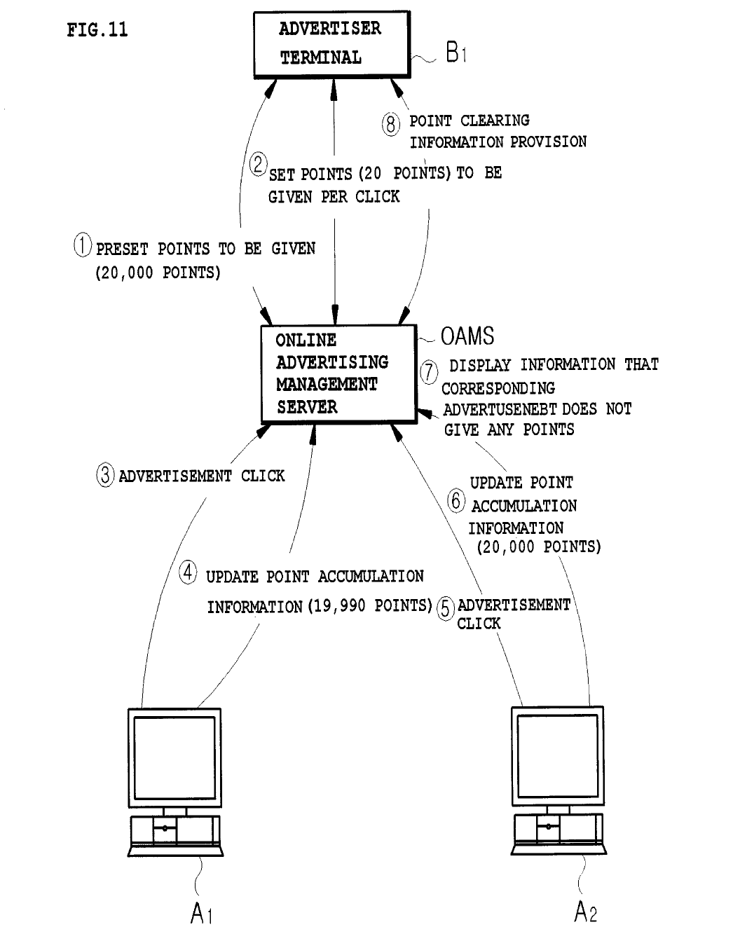

FIG. 11 is a view showing a data processing state using the online advertising system in accordance with the third embodiment of the present invention.

Referring to FIG. 11, in the online advertising system in accordance with the third embodiment of the present invention, an advertisement point payment management program (not shown) is installed in the online advertising management server OAMS. Through the advertisement point payment management program, the online advertising management server OAMS registers setting information transmitted from an advertiser terminal (e.g., B1) and pays points upon a customers' advertisement viewing by comparison between the setting information and a set amount by the corresponding advertiser.

In other words, the advertiser terminal B1 presets a total point amount (e.g., 20,000 points) to be given upon advertisement viewing in the online advertising management server OAMS. Also, the advertiser terminal B1 presets information on a point amount (e.g., 20 points) to be given per advertisement to the online advertising management server OAMS.

Then, with the number of points to be given per advertisement viewing and a total of points paid being set for each advertiser, when a customers' advertisement selection signal is transmitted from a user terminal A1, the online advertising management server OAMS extracts point setting information of the corresponding advertisement, and determines whether there exist any remaining points to be paid for the corresponding advertisement. If there exist no remaining points to be paid for the corresponding advertisement, information that points are unpayable upon advertisement viewing is displayed in the advertisement information 82 displayed on the webpage 80.

Next, the online advertising management server OAMS transmits point clearing information to the corresponding advertiser terminal B1, to thereby conduct point charging.

Moreover, in some cases, it is possible for the online advertising management server OAMS to automatically set the advertisement information 82, the payable points for which are all used up, so that the advertisement information 82 can be outputted on the screen in lower priority than other advertisement information.

The functions and operations of the online advertising system thus configured in accordance with the third embodiment of the present invention will be described in detail with reference to the accompanying drawings.

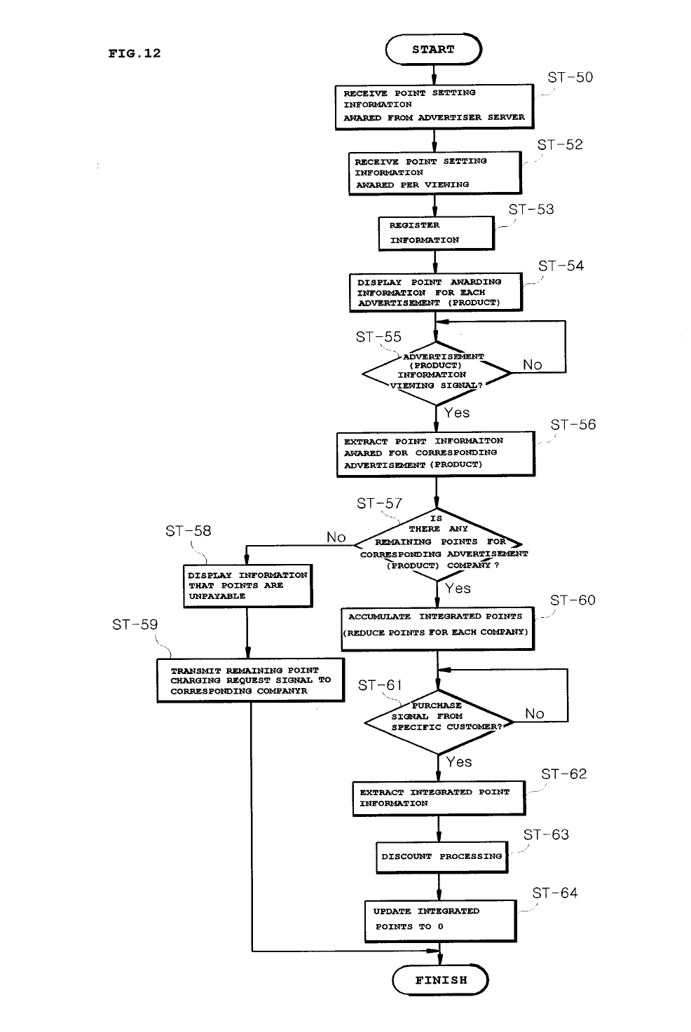

FIG. 12 is a flowchart showing a signal flow of the online advertising system in accordance with the third embodiment of the present invention.

First, in the online advertising system in accordance with the third embodiment of the present invention, the advertiser terminal B1 presets a total point amount to be given upon advertisement viewing to the online advertising management server OAMS (ST-50). The advertiser terminal B1 presets information on a point amount (e.g., 20 points) to be given per advertisement viewing to the online advertising management server OAMS (ST-52).

Then, the online advertising management server OAMS sets and registers the number of points to be given per advertisement viewing and a total of points to be paid for each advertiser (ST-53 and ST-54). And, the online advertising management server OAMS determines whether a customers' advertisement selection signal is transmitted from a user terminal A1 (ST-55).

If a customers' advertisement selection signal is transmitted from the user terminal A1, the online advertising management server OAMS extracts point setting information of the corresponding advertisement (ST-56), and determines whether there exist any remaining points to be paid for the corresponding advertisement (ST-57).

If there exist no remaining points to be paid for the corresponding advertisement, information that points are unpayable upon advertisement viewing is displayed in the advertisement information 82 displayed on the webpage 80 (ST-58). Next, the online advertising management server OAMS transmits point clearing information to the corresponding advertiser terminal B1, to thereby conduct point charging (ST-59).

On the other hand, if there exist any remaining points to be paid for the corresponding advertisement, the online advertising management server OAMS cumulatively updates awarded points to the corresponding member integrated reserve points accumulated (ST-60).

In this state, the online advertising management server OAMS determines whether a purchase signal for a specific product is applied from any one of the user terminals A1 to An (ST-61). If a purchase signal for a specific product is applied from any one of the user terminals A1 to An, the online advertising management server OAMS extracts member integrated reserve point information (ST-62), and awards the same as discount points for the corresponding purchased product (ST-63).

Further, the online advertising management server OAMS updates the member integrated reserve points to the initial zero state (0) (ST-64).

Moreover, in some cases, it is possible for the online advertising management server OAMS to automatically set the advertisement information 82, the payable points for which are all used up, so that the advertisement information 82 can be outputted on the screen in lower priority than other advertisement information.

Hereinafter, a fourth embodiment of the present invention will be described in detail with reference to the drawings.

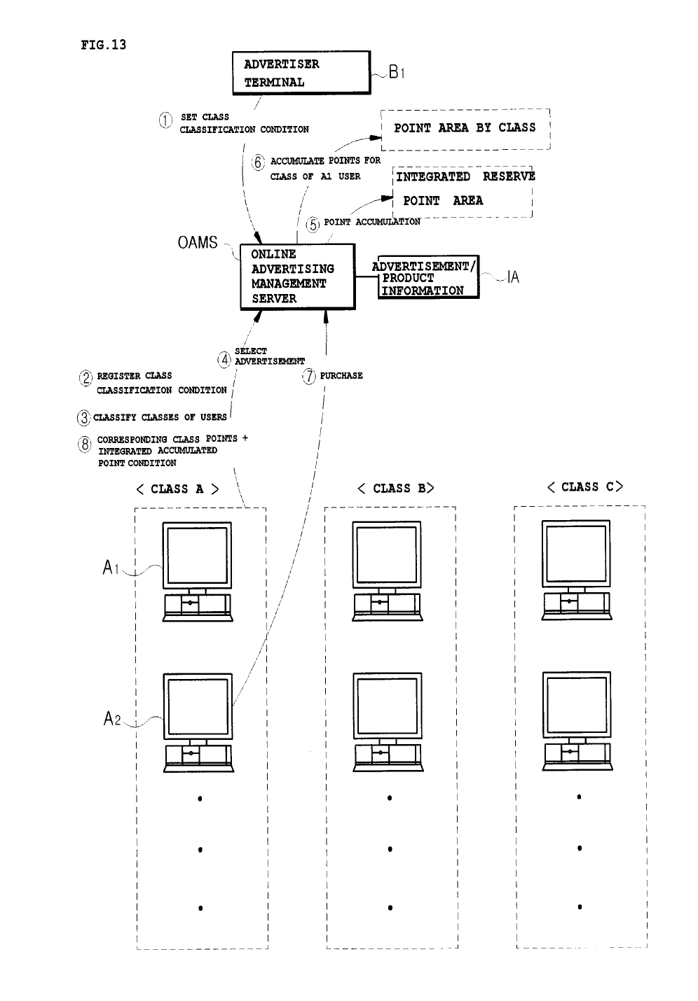

FIG. 13 is a view showing a data processing state through an online advertising system in accordance with a fourth embodiment of the present invention.

Referring to FIG. 13, the online advertising system in accordance with the fourth embodiment of the present invention is a system which classifies classes of users according to conditions (age, sex, hobby, . . . ) for advertisement viewers specified by a seller, accumulates reserves earned upon a multiplicity of customers viewing an advertisement for integrated accumulation, gives class points differentially accumulated by individual class upon a corresponding user's viewing an advertisement, and clears the class points when a certain user classified into the corresponding class group purchases.

In other words, the online advertising system in accordance with the fourth embodiment of the present invention is a system which classifies classes of users into a plurality of classes according to conditions (age, sex, hobby, . . . ) for advertisement viewers specified by a seller, accumulates separate by-class discount points by individual according to the class of a user, regardless of member integrated reserve points automatically accumulated, upon the corresponding user's viewing an advertisement, and uses the corresponding by-class discount points only when the corresponding user purchases a product.

By this, the online advertising system in accordance with the fourth embodiment of the present invention allows a user within the purchase range of a product that the seller wants to sell to earn more by-class discount points. At this time, the seller may be an advertiser because the seller is a person who allows a user to earn by-class discount points differentiated in consideration of the class of the corresponding user when the user clicks on product information displayed in the online advertising management server OAMS, with a variety of product information for product sales displayed in the online advertising management server OAMS.

For example, the seller or the advertiser presets target user groups of sales products, classifies a multiplicity of classes according to the target user groups, and registers them in advance in the online advertising management server OAMS. Namely, products like MP3 tend to be purchased by teenagers or people in 20's and early 30's, have a higher purchase rate among females than among males, and are more likely to be purchased by users whose hobby is music, and have a higher possibility of purchase in the metropolitan areas. Thus, it is preferred to set target classes by product in consideration of age, region, hobby, and gender altogether.

Preferably, the classes are classified in the order of classes of A, B, C? namely, in a given order starting from a target class (A class), or may be classified into subdivided classes.

With a plurality of user classes classified and registered by product in the online advertising management server OAMS, if a signal for selecting and viewing a specific product information or advertisement is applied from any one of the user terminals A1 to An, the online advertising management server OAMS extracts product or advertisement information selected by the corresponding user, extracts the registered class information based on the corresponding user's login information, and further pays special purchase discount points to the corresponding user. At this time, the special purchase discount points refer to points that are additionally discounted only when the corresponding user issues a purchase signal.

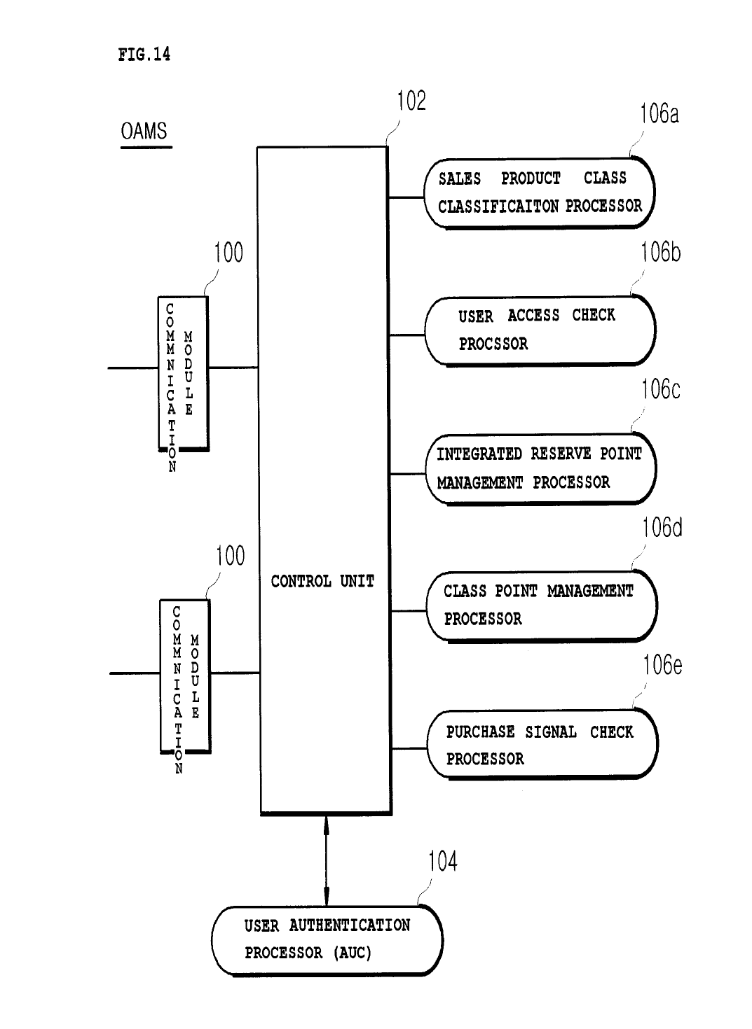

FIG. 14 is a block diagram showing the configuration of the online advertising management server in accordance with the fourth embodiment of the present invention.

Referring to FIG. 14, the online advertising management server OAMS executes overall control for registering by-product class information in advance by a seller or advertiser, checking any product for which the user terminals A1 to An issue a viewing signal, extracting the registered class information, determining the class of a user based on the corresponding user's login information, and giving the user special purchase discount points corresponding to the class, and the online advertising management server OAMS incorporates therein a communication module, a user authentication processor, a control unit, a sales product class classification processor, a user access check processor, an integrated reserve point processor, a class point management processor, and a purchase signal check processor.

Reference numeral 100 represents a communication module which is connected to advertiser servers B1 to Bn, seller servers C1 to Cn, and user computer terminals A1 to An, matches a protocol for uploading and downloading various data, and executes data compatible processing.

Reference numeral 104 represents a well-known user authentication processor which executes authentication of a corresponding user based on the user's login information transmitted from the user computer terminals A1 to An.

Reference numeral 102 represents a control unit which controls the entire processors for registering by-product class information in advance, checking any product for which the user terminals A1 to An issue a viewing signal, extracting the registered class information, determining the class of a user based on the corresponding user's login information, and giving the user special purchase discount points corresponding to the class.

Reference numeral 106a represents a sales product class classification processor which registers information by sales product and user class classification information by product transmitted from the advertiser servers B1 to Bn and the seller servers C1 to Cn, checks an accessed user, and specifies the class of the corresponding user by product.

Reference numeral 106b represents a user access check processor for checking a connection state of the user terminals A1 to An signal-connected via the communication module 100. Reference numeral 106c represents an integrated reserve point management processor which manages integrated reserve points given as discount points upon a specific members' issuing a purchase signal and earned jointly by members, regardless of special purchase discount points, in response to an advertisement and product information viewing signal transmitted from the user computer terminals A1 to An.

Reference numeral 106d represents a class point management processor which accumulates and manages class points by product given for each user in conjunction with the sales product class classification processor 106a. Reference numeral 106e represents a purchase signal check processor which executes payment processing upon receipt of a purchase signal transmitted from any of the user terminals A1 to An.

The functions and operations of the online advertising system thus configured in accordance with the fourth embodiment of the present invention will be described in detail with reference to the accompanying drawings.

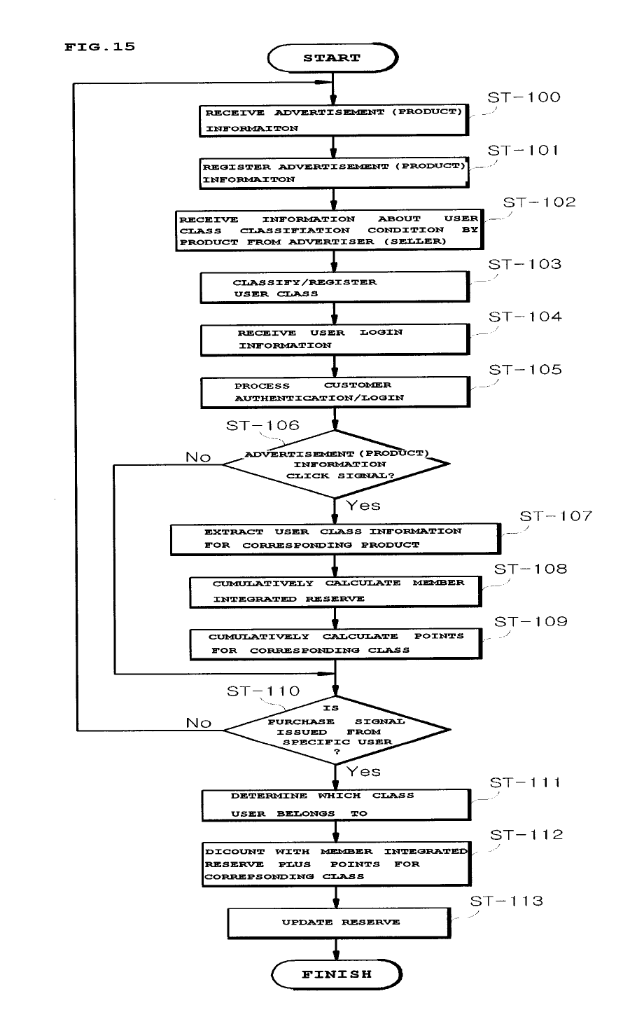

FIG. 15 is a flowchart showing a signal flow of the online advertising system in accordance with the fourth embodiment of the present invention.

First, in the online advertising system in accordance with the fourth embodiment of the present invention, a plurality of user terminals (e.g., A1, A2, and A3) are connected to the online advertising management server OAMS, which gives member integrated reserve points upon a multiplicity of members selecting advertisement information and product information, integrates and accumulates them until a specific customer issues a product purchase signal, pays the member integrated reserve points as discount points when the purchase signal is issued, and which registers by-product class information in advance by a seller or advertiser, checks any product for which the user terminals A1 to An issue a viewing signal, extracts the registered class information, determines the class of a user based on the corresponding user's login information, and gives the user special purchase discount points corresponding to the class. Also, an advertiser terminal B1 and a seller server C1 for uploading advertisement information and sales information to the online advertising management server OAMS are connected thereto.

In this state, the advertiser terminals B1 to Bn and the seller servers C1 to Cn are connected to the online advertising management server OAMS, for uploading advertisement information and product information to the online advertising management server OAMS (ST-100 and ST-101).

Further, the advertiser terminals B1 to Bn and the seller servers C1 to Cn transmit class information (classified by age, region, and gender) of users who are targeted for advertisement information and product information to the online advertising management server OAMS (ST-102).

Then, the online advertising management server OAMS displays the uploaded advertisement information and product information and class information of users by product and advertisement through separate web pages, and sets the class information to be automatically processed by the processor (ST-103).

Next, when an ID and password information are transmitted from the user terminals A1 to An (ST-104), the online advertising management server OAMS executes the customers' log-in process by authentication procedure of the corresponding information (ST-105).

Thereafter, online advertising management server OAMS determines whether any viewing signal for a specific advertisement or product information is applied from the user terminals A1 to An (ST-106). If any viewing signal is applied, it extracts prestored information about members who have viewed the corresponding advertisement or product information, and extracts class information of users stored in conjunction with the corresponding product information and advertisement information (ST-107), thereby determining the class of the corresponding user.

Subsequently, the online advertising management server OAMS gives a predetermined number of points according to the corresponding customers' viewing activity, cumulatively calculates the corresponding points (ST-108), and updates the member integrated reserve point information.

Meanwhile, the online advertising management server OAMS cumulatively calculates and updates special purchase discount points by class according to the determined class of the corresponding user based on the class information of users stored in conjunction with the corresponding product information and advertisement information (ST-109).

That is to say, if class information of a product is classified into A, B, C, D, and E classes, the corresponding user is a member of class A for the corresponding product only, the points of class A accumulated so far are 100 points, and the points given to the corresponding user are 10 points, then the total points of class A are cumulatively calculated as 110 points. Namely, the 100 points, which are the class points integrated and accumulated for class A, are paid as a discount rate to a user who issues a purchase signal at the instant the purchase signal is issued regardless of which class the user belongs to, and cleared and updated to zero state (0).

Afterwards, the online advertising management server OAMS determines whether a purchase signal for a specific product is applied from any one of the user terminals A1 to An (ST-110). If a purchase signal for a specific product is applied from any one of the user terminals A1 to An, the online advertising management server OAMS checks the class information of the corresponding user (ST-111), and pays the member integrated reserve points accumulated up to the corresponding point of time and the class points of the corresponding user as discount points (ST-112).

Further, the online advertising management server OAMS updates the member integrated reserve points and the class points of the corresponding user with the original zero state (0) (ST-113).

Therefore, in the online advertising management server OAMS, the accumulation of points for advertisement information and product information viewing is processed in real time, and the member integrated reserve points are cleared in real time upon receipt of a purchase signal. As class points classified by product are operated in a member integration manner, if a certain user issues a purchase signal for a specific product, they are classified in advance in conjunction with the corresponding product, and the class points are additionally paid as discount points according to the class of the corresponding user, thereby facilitating the product purchase by users belonging to the corresponding class, and each product seller and advertiser pay more points to customers of a target class, thereby enabling target marketing.

Hereinafter, a fifth embodiment of the present invention will be described in detail with reference to the drawings.

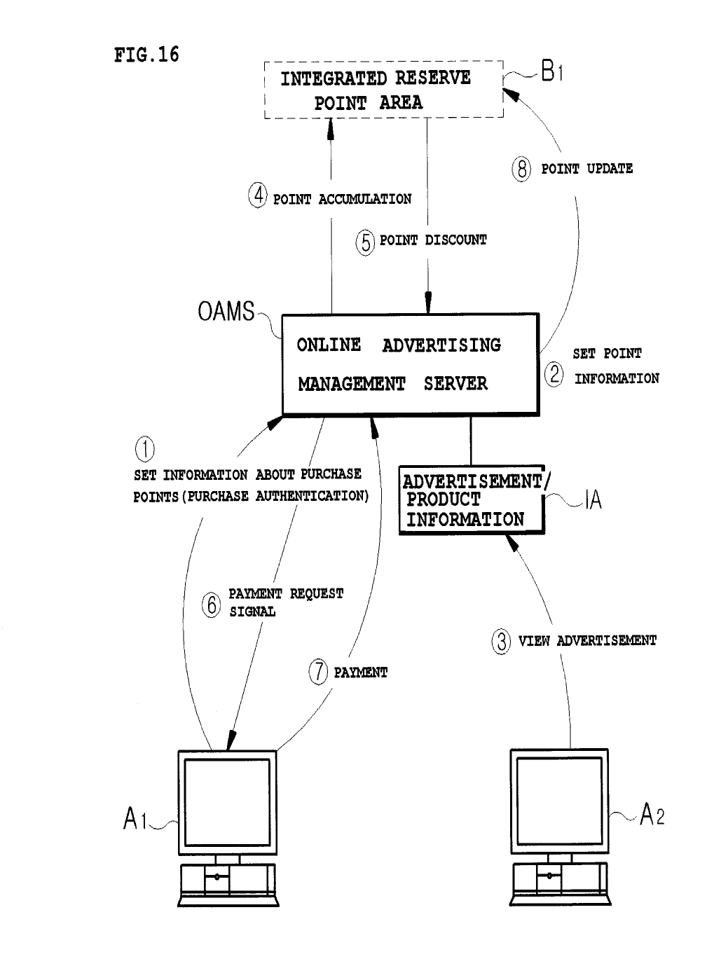

FIG. 16 is a view showing a data processing state through an online advertising system in accordance with a fifth embodiment of the present invention.

Referring to FIG. 16, the online advertising system in accordance with the fifth embodiment of the present invention is a system, in which a user specifies a specific product and presets the number of integrated reserve points at the point of time of purchase, so that when integrated reserve points are accumulated as the preset number of integrated reserve points of the user, the corresponding user automatically issues a purchase signal.

More concretely, the online advertising system in accordance with the fifth embodiment of the present invention is a system, in which a user selects and registers a specific product in advance, specifies an amount to be discounted with integrated reserve points, and registers an accumulated amount of the integrated reserve points in the online advertising management server OAMS, so that when member integrated reserve points integrated and accumulated by viewing advertisement or product information by the user reach a set number of points of the corresponding user, the online advertising management server OAMS automatically issues a purchase signal.

At this time, in the online advertising management server OAMS, the member integrated reserve points accumulated whenever a user's purchase signal is issued are given as a discount amount of the corresponding purchase user, and thus the member integrated reserve points are cleared and updated to zero (0) state. Accordingly, another user does not issue a purchase signal until the number of reserved purchase points set by the corresponding user is reached, so that the purchase of a product can be done automatically while getting the corresponding member integrated reserve points as discount points.

Meanwhile, in the online advertising management server OAMS, the seller may find out the reserved purchase points of the corresponding user in advance, and further pays additional discount points to the corresponding user only. In other words, if there are 10 users who set that a product of -W10,000 should be purchased at the instant member integrated reserve points of -W2,000 are paid, the seller may set the online advertising management server OAMS to further pay additionally points of -W1,000 when the corresponding member integrated reserve points are accumulated to be equivalent to -W1,000, and the online advertising management server OAMS gives the member integrated reserve point information to the advertiser terminal B1 to Bn and the seller servers C1 to Cn in real time.

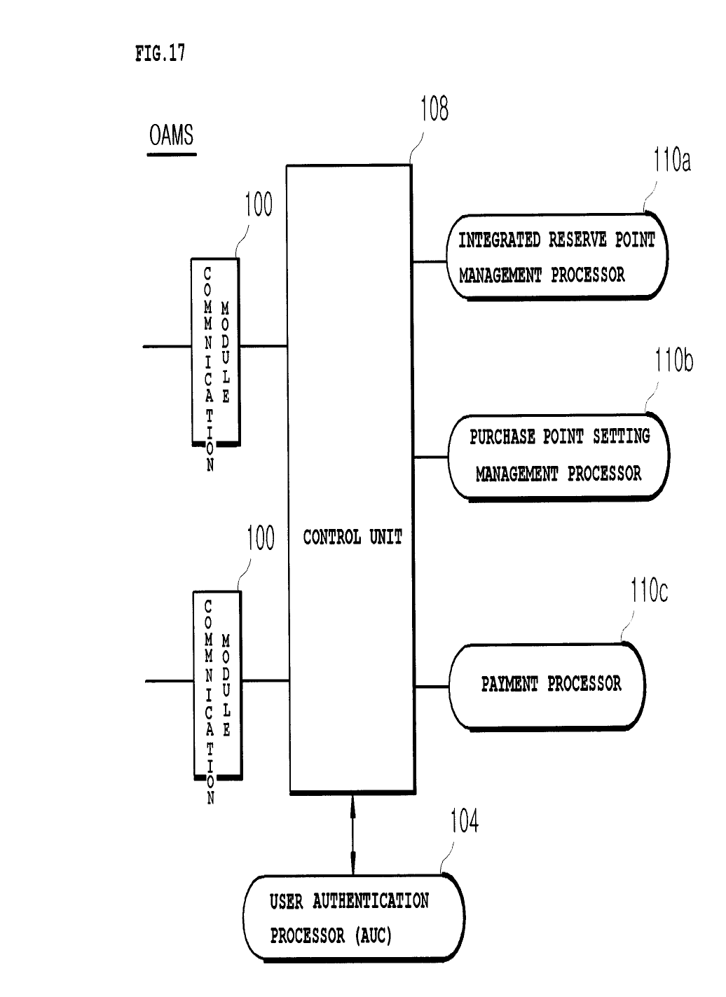

FIG. 17 is a block diagram showing the configuration of the online advertising management server in accordance with the fifth embodiment of the present invention.

Referring to FIG. 17, when the online advertising management server OAMS receives integrated reserve point setting and reserved purchase signals for a specific member transmitted from the user terminals A1 to An, it automatically gives the member integrated reserve points of a corresponding set amount to the user who set the amount for a discount purchase unless any purchase signal from another user is issued until the corresponding set amount of member integrated reserve points is reached; and incorporates therein a communication module, a user authentication processor, a control unit, an integrated reserve point processor, a purchase point setting management processor, and a payment processing check processor.

Reference numeral 100 represents a communication module which is connected to advertiser servers B1 to Bn, seller servers C1 to Cn, and user computer terminals A1 to An, matches a protocol for uploading and downloading various data, and executes data compatible processing.

Reference numeral 104 represents a well-known user authentication processor which executes authentication of a corresponding user based on the user's login information transmitted from the user computer terminals A1 to An.

Reference numeral 102 represents a control unit which automatically gives a given amount of points in response to advertisement viewing and product information viewing signals transmitted from the user terminals A1 to An, cumulatively calculates and manages member integrated reserve points by accumulating the points so that a specific user issuing a purchase signal can get a discount, receives and registers a reserved purchase signal and point setting information from the user terminals A1 to An, and automatically issues a purchase signal of the corresponding user at the point of time the member integrated reserve points reaches the set amount of points of the corresponding user to execute a purchase process.

Reference numeral 110a represents an integrated reserve point management processor which manages integrated reserve points given as discount points upon a specific members' issuing a purchase signal and earned jointly by members, regardless of special purchase discount points, in response to an advertisement and product information viewing signal transmitted from the user computer terminals A1 to An.

Reference numeral 110b represents a purchase point setting management processor which receives and registers a reserved purchase signal and point setting information from the user terminals A1 to An, and automatically issues a purchase signal of the corresponding user at the point of time the member integrated reserve points reach the set amount of points of the corresponding user to execute a reserved purchase process. Reference numeral 110c represents a payment processing check processor which executes payment processing upon receipt of a purchase signal transmitted from any one of the user computer terminals A1 to An.

The functions and operations of the online advertising system thus configured in accordance with the fifth embodiment of the present invention will be described in detail with reference to the accompanying drawings.

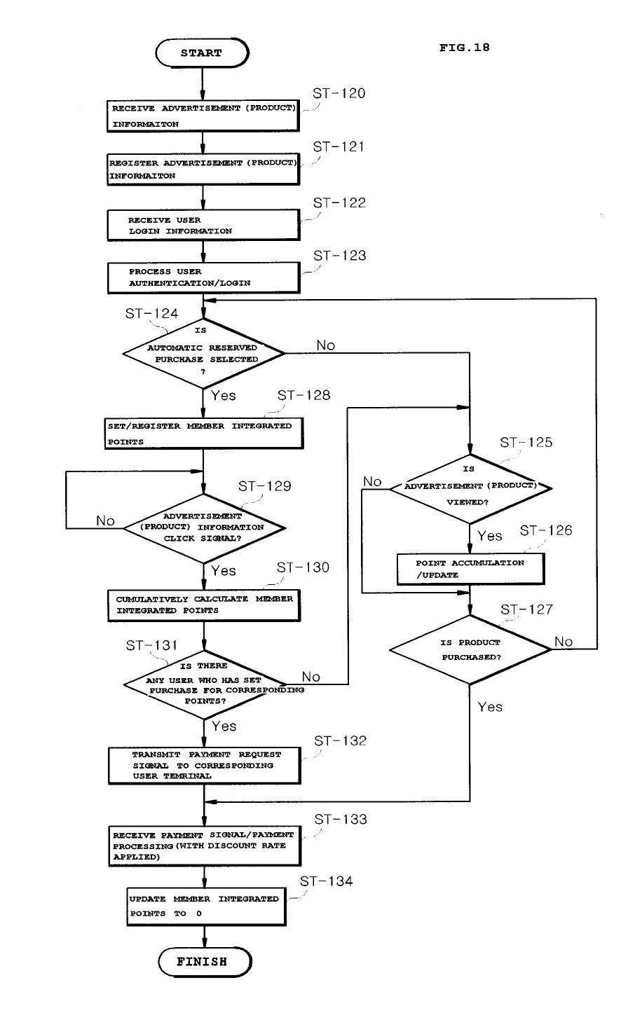

FIG. 18 is a flowchart showing a signal flow of the online advertising system in accordance with the fifth embodiment of the present invention.

First, in the online advertising system in accordance with the fifth embodiment of the present invention, a plurality of user terminals (e.g., A1, A2, and A3) are connected to an online advertising management server OAMS, which gives member integrated reserve points upon a multiplicity of members' selecting advertisement information and product information, integrates and accumulates them until a specific customer issues a product purchase signal, pays the member integrated reserve points as discount points when the purchase signal is issued, and which receives integrated reserve point setting and reserved purchase signals for a specific member transmitted from the user terminals A1 to An, and automatically gives the member integrated reserve points of a corresponding set amount to the user who set the amount for a discount purchase unless any purchase signal from another user is issued until the corresponding set amount of member integrated reserve points is reached. Also, an advertiser terminal B1 and a seller server C1 for uploading advertisement information and sales information to the online advertising management server OAMS are connected thereto.

In this state, the advertiser terminals B1 to Bn and the seller servers C1 to Cn are connected to the online advertising management server OAMS, for uploading advertisement information and product information to the online advertising management server OAMS (ST-120).

Then, the online advertising management server OAMS displays the uploaded advertisement information and product information through separate web pages (ST-121)

Thereafter, when an ID and password information are transmitted from the user terminals A1 to An (ST-122), the online advertising management server OAMS executes the customers' log-in process by authentication procedure of the corresponding information (ST-123).

Next, the online advertising management server OAMS determines whether an automatic reserved purchase signal is applied from the user terminals A1 to An connected thereto (ST-124).

If any automatic reserved purchase signal is not applied from the user terminals A1 to An, the online advertising management server OAMS determines whether any viewing signal for a specific advertisement or product information is applied from the user terminals A1 to An (ST-125). If any viewing signal is applied, it extracts prestored information about members who have viewed the corresponding advertisement or product information, and cumulatively adds a predetermined amount of points to the member integrated reserve points in reward of the viewing (ST-126).

Afterwards, the online advertising management server OAMS determines whether a purchase signal for a specific product is applied from any one of the user terminals A1 to An (ST-127).

If an automatic reserved purchase signal, product information and set point information are applied from any one of the user terminals A1 to An, the online advertising management server OAMS registers the corresponding product information, set point information and user information (ST-128).

In this state, the online advertising management server OAMS determines whether a viewing signal for specific advertisement or product information is applied from any one of the user terminals A1 to An. If a viewing signal is applied (ST-129), the online advertising management server OAMS extracts prestored information about members who have viewed the corresponding advertisement or product information, and cumulatively adds a predetermined amount of points to the member integrated reserve points in reward of the viewing (ST-130).

Further, the online advertising management server OAMS determines whether the accumulated member integrated reserve points are equal to registered reserved purchase points. If reserved purchase points preset by a certain user are equal to the member integrated reserve points (ST-131), the online advertising management server OAMS transmits a payment request signal to the corresponding user computer terminals A1 to An (ST-132).

Then, the online advertising management server OAMS, upon receipt of a payment signal from the corresponding user computer terminals A1 to An, executes payment processing at a discount amount equivalent to the accumulated amount of member integrated reserve points (ST-133).

Further, the online advertising management server OAMS updates the member integrated reserve points to the original zero state (0) (ST-134).

Hereinafter, a sixth embodiment of the present invention will be described in detail with reference to the drawings.

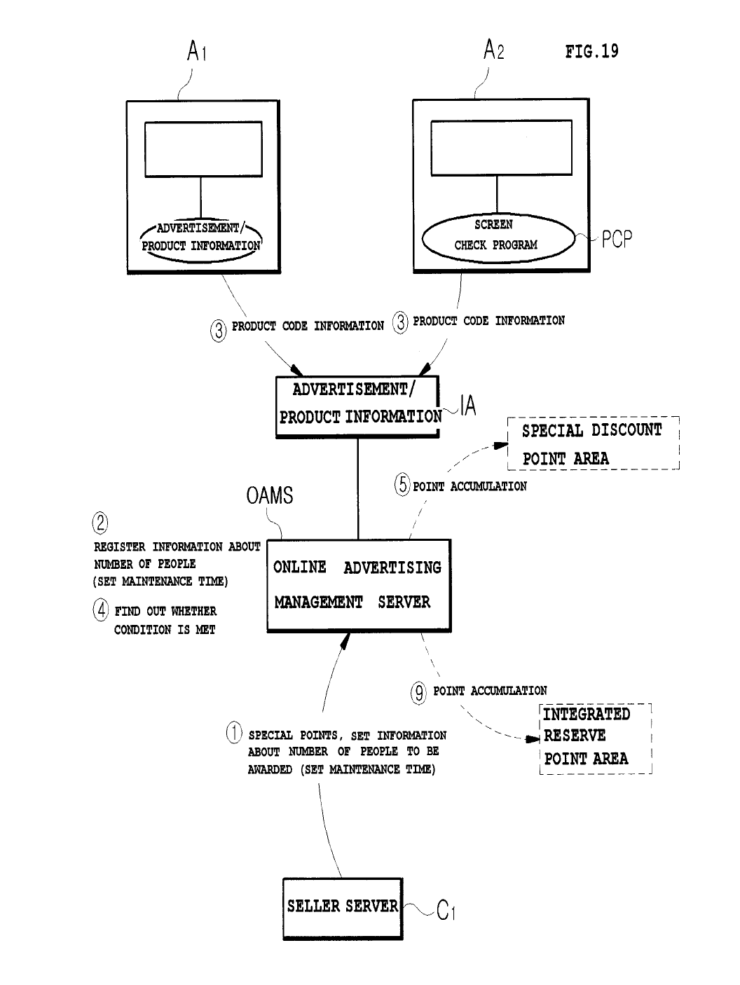

FIG. 19 is a view showing a data processing state through an online advertising system in accordance with a sixth embodiment of the present invention.

Referring to FIG. 19, the online advertising system in accordance with the sixth embodiment of the present invention is a system, in which a program operating in conjunction with a web browser is installed on a user's computer terminal, and a predetermined number of special discount points awardable upon a product purchase is further awarded only to a user who outputs corresponding product information on the screen, at the point of time a given number or less of users preset by the seller is viewing the corresponding product information.

More specifically, the online advertising system in accordance with the sixth embodiment of the present invention is a system, in which a seller provides product information to the online advertising management server OAMS, sets a specific number of people and maintenance time information as the condition of payment of special points, the online advertising management server OAMS finds out a total number of users and maintenance time information for outputting corresponding product information on the screen through a screen check program of the user terminals A1 to An, with the screen check program installed on the user terminals A1 to An so as to check output product information of a web browser, and if a specific or less number of people set by the seller is viewing the corresponding product information for a given period of time, the online advertising management server OAMS pays further special discount points only to the user who outputs the corresponding product information on the screen. That is, further special points are paid for a product whose product information is less viewed, in order to encourage a user who is viewing the corresponding product information to purchase the product by setting of the seller.

For this, in order for the online advertising management server OAMS to check product information outputted from the user terminals A1 to An more easily, unique code information is stored in each product information data, and the screen check program installed on the user terminals A1 to An transmits, to the online advertising management server OAMS, code data of product information to be outputted on the screen in real time.

By this, the online advertising management server OAMS can check in real time which product information is viewed by the corresponding user terminals A1 to An, and whether viewing of the corresponding product information is finished.

For this, the online advertising system in accordance with the sixth embodiment of the present invention has a screen check program PCP installed on the user terminals A1 to An, for checking output product information of a web browser, and automatically transmits, to the online advertising management server OAMS, product code information to be outputted to the web browser at regular time intervals.

Further, the online advertising system in accordance with the sixth embodiment of the present invention is provided with a seller server C1 for transmitting user and time condition information to the online advertising management server OAMS so as to pay special purchase points if the number of users displaying the company's product information on the screen and the number of corresponding users are maintained for a predetermined period of time.

Meanwhile, the online advertising system in accordance with the sixth embodiment of the present invention is provided with the online advertising management server OAMS which receives and registers the number of users displaying the company's product information from the seller servers C1 to Cn on the screen, and user and time condition information so as to pay special purchase points if the number of corresponding users are maintained for a predetermined period of time, receives product code information from the screen check program PCP installed on the plurality of user terminals A1 to An to calculate the total number of users viewing the corresponding product information, and pays special purchase points at the point of time there are a predetermined or less number of corresponding users set by the seller and the number of corresponding users viewing the product information is maintained for a predetermined period of time. At this time, the special purchase points refer to points payable as a discount amount only upon issuing a purchase signal.

Further, in order for the screen check program PCP installed on the plurality of user terminals A1 to An to more easily transmit, to the online advertising management server OAMS, product information for viewing at regular time intervals, code information is contained in the product information provided by the online advertising management server OAMS, and the screen check program installed on the user terminals A1 to An is configured so as to transmit the corresponding product code information to the online advertising management server OAMS at regular time intervals.

The functions and operations of the online advertising system thus configured in accordance with the sixth embodiment of the present invention will be described in detail with reference to the accompanying drawings.

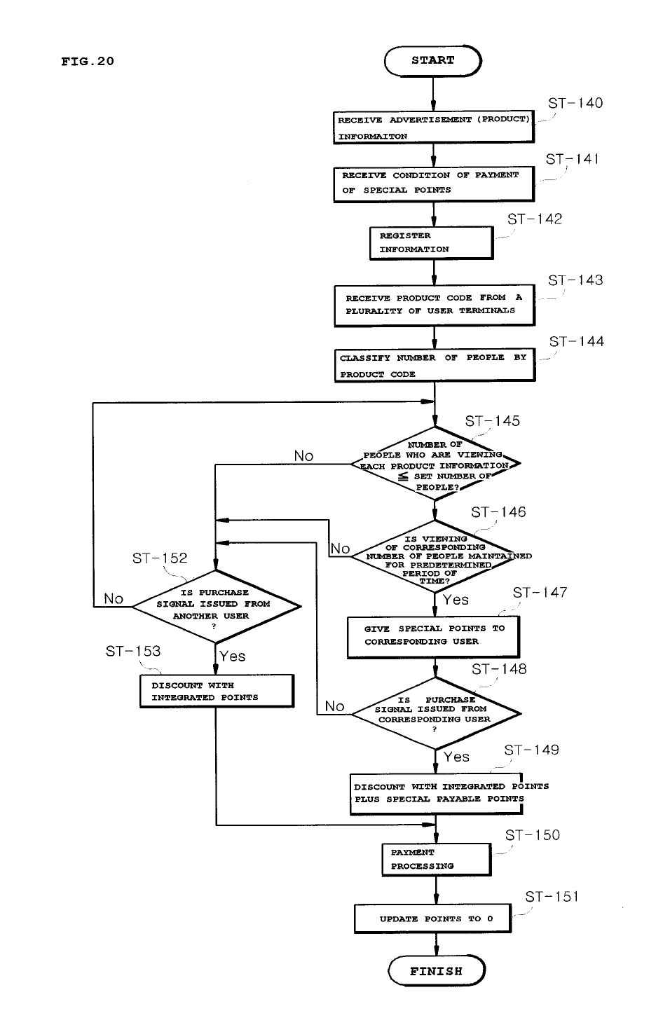

FIG. 20 is a flowchart showing a signal flow of the online advertising system in accordance with the sixth embodiment of the present invention.

First, a plurality of user terminals (e.g., A1, A2, and A3) are connected to the online advertising management server OAMS. Also, an advertiser terminal B1 and a seller server C1 for uploading advertisement information and sales information to the online advertising management server OAMS are connected thereto.

In this state, the advertiser terminals B1 to Bn and the seller servers C1 to Cn are connected to the online advertising management server OAMS, for uploading, on the online advertising management server OAMS, advertisement information, product information, the number of users who are displaying the company's product information on the screen, and user and time condition information for paying special purchase points if the number of corresponding users is maintained for a predetermined period of time (ST-140 and ST-141).

Then, the online advertising management server OAMS displays the uploaded advertisement information, product information, and special purchase point payment condition information through separate web pages (ST-142).

Next, the online advertising management server OAMS receives product code information from the screen check program PCP installed on the user computer terminals A1 to An (ST-143), and calculates the total number of users who are viewing the corresponding product information (ST-144).

In succession, the online advertising management server OAMS determines whether the number of users who are viewing the same product information is less than a predetermined number set by the seller (ST-145), and determines whether the corresponding number of users who are viewing is maintained less than the predetermined number for a predetermined period of time (ST-146), and gives special purchase points at that point of time (ST-147).

If the number of users who are viewing the same product information is not less than the predetermined number set by the seller, or a purchase signal is applied from another user's terminals A1 to An at the point of time the corresponding number of users who are viewing is not maintained less than a predetermined number for a predetermined period of time (ST-152), the online advertising management server OAMS gives member integrated reserve points to the corresponding user as discount points (ST-153).

On the other hand, if the number of users who are viewing the same product information is less than the predetermined number set by the seller, and a purchase signal is applied from the user's terminals A1 to An that have received special purchase points at the point of time the corresponding number of users who are viewing is maintained less than a predetermined number for a predetermined period of time (ST-148), the online advertising management server OAMS gives member integrated reserve points and special purchase points to the corresponding user as discount points (ST-149) and executes payment processing (ST-150).

Further, the online advertising management server OAMS updates the member integrated reserve points and class points of the corresponding user with the initial zero state (0) (ST-151).

Hereinafter, a seventh embodiment of the present invention will be described with reference to the drawings.

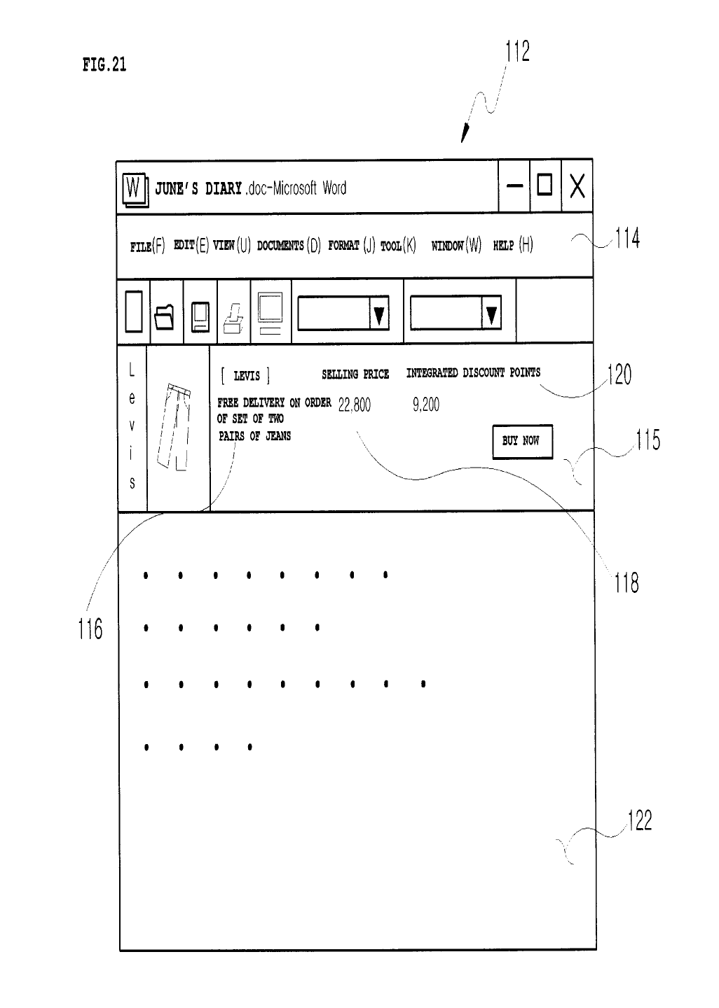

FIG. 21 is a view showing a web browser screen outputted from user terminals of an online advertising system in accordance with a seventh embodiment of the present invention.

Referring to FIG. 21, the online advertising system in accordance with the seventh embodiment of the present invention is a system, which outputs user's purchase desired product information, integrated reserve point information, and a screen provided with a purchase decision means on the corresponding screen in conjunction with the screen pages of a variety of application programs including a word-processing program, an image editing program, a game program, and a windows explorer program that run in Windows, thereby making it easier to check point information and rapidly issuing a purchase decision signal.

In other words, the online advertising system in accordance with the seventh embodiment of the present invention is a system, which outputs a screen with purchase desired product information specified by the user in advance, integrated reserve point information, and a purchase decision means on the corresponding screen in conjunction with a variety of application programs, for example, a word-processing program, an image editing program, a game program, and a windows explorer program that run in Windows.

Therefore, various tool windows 114 for operating an application program is provided on a screen 112 of the application program outputted in the web browser of the user terminals A1 to An, and a task window 122 is prepared on the lower side of the tool windows 114.

The online advertising system in accordance with the seventh embodiment of the present invention displays a point output window 115 between the tool windows 114 and the task window 122 on the screen 112 of the application program.

The point output window 115 is provided with purchase desired product information 116 specified by the user in advance, selling price information 118, integrated reserve point information 120, and a purchase decision button.

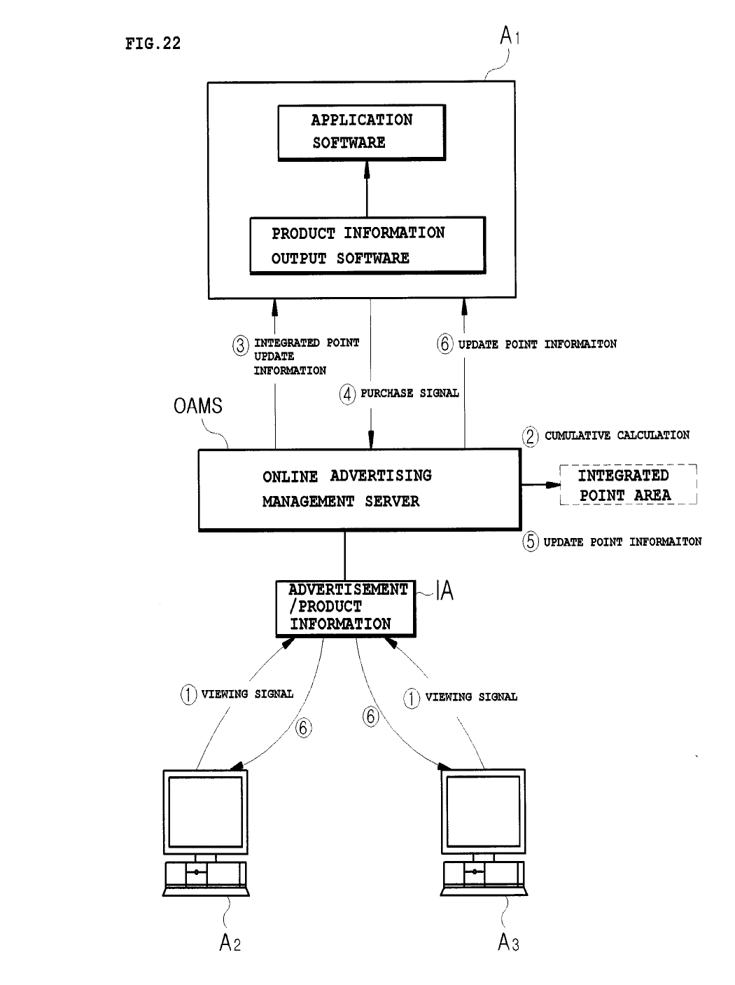

FIG. 22 is a view showing a data processing state through the online advertising system in accordance with the seventh embodiment of the present invention.

Referring to this, the online advertising system in accordance with the seventh embodiment of the present invention has a product information display software installed to output purchase desired product information specified by the user in advance, integrated reserve point information, and a screen with a purchase decision means on the corresponding screen in conjunction with a variety of application programs, such as a word-processing program, an image editing program, a game program, and a windows explorer program, which run in Windows of the user terminals A1 to An.

Then, the product information display software outputs a screen with purchase desired product information specified by the user in advance, integrated reserve point information, and a purchase decision means on the corresponding screen in conjunction with a variety of application programs, for example, a word-processing program, an image editing program, a game program, and a windows explorer program. When a purchase signal is issued through the purchase decision button with reference to the purchase desired product information 116, selling price information 118, and integrated reserve point information 120 created in the point display window 115, the online advertising management server OAMS receives the purchase signal, and pays the member integrated reserve points as discount points for payment processing, and the integrated reserve point information 120 created in the point display window 115 is updated to the zero state (0).

Hereinafter, an eighth embodiment of the present invention will be described with reference to the drawings.

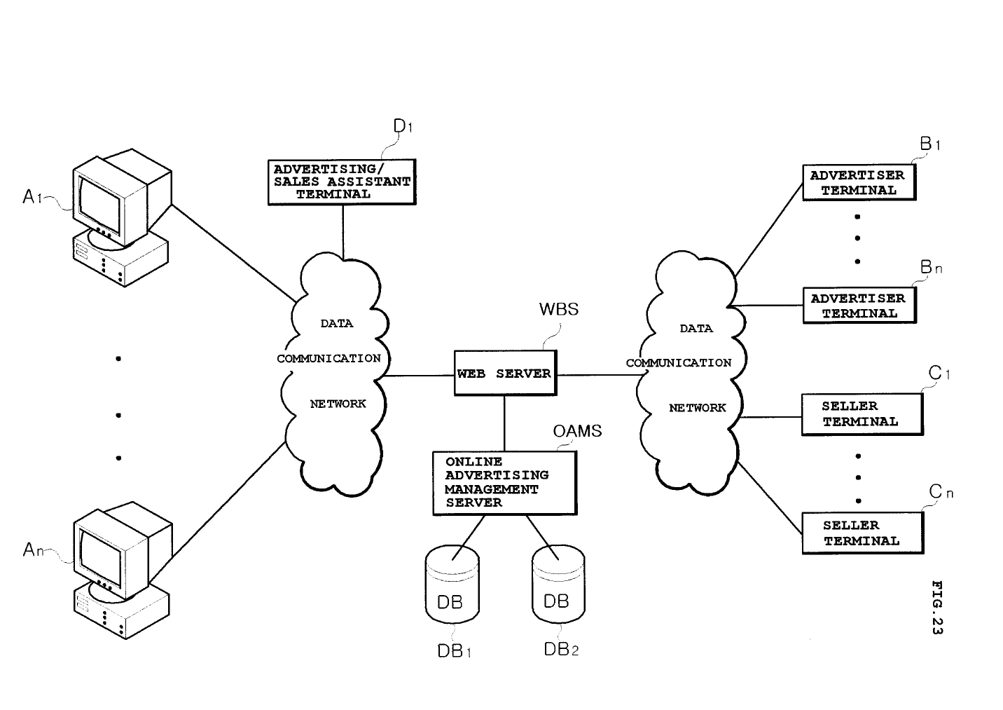

FIG. 23 is a frame format schematically showing the configuration of an online advertising system in accordance with an eighth embodiment of the present invention.

Referring to FIG. 23, the online advertising system in accordance with the eighth embodiment of the present invention is a system, in which an advertising/sales assistant buys an account for advertising expenses of a web server outputting product advertisements, and the account is managed such that they payment of incentives from a relevant product provider can be made upon sale of a corresponding advertisement product, thereby conducting active public relations for an integrated reserve point awarding system and revitalizing the sale of the corresponding product.

That is, the online advertising system in accordance with the eighth embodiment of the present invention applies an advertising/sales assistant in order to revitalize sales through advertisement viewing and product information viewing, divides and prepays advertising rates through a plurality of advertising/sales assistants, and awards selective incentives according to each advertising/sales assistant's equity upon selling a corresponding product later.

For this, the online advertising system in accordance with the eighth embodiment of the present invention is provided with user terminals A1 to An having a communication module, such as a modem, installed therein, for viewing advertisement information and product information displayed on web pages by accessing the web pages of the online advertising management server OAMS that offers member integrated reserve points.

Further, the online advertising system in accordance with the eighth embodiment of the present invention is provided with first to N-th advertiser terminals B1 to Bn, which provide and display advertisement information on the web pages of the online advertising management server OAMS so that a customer can view advertisement information through the user terminals A1 to An, offer a predetermined amount of member integrated reserve points for the customers' advertisement viewing, sell the advertising/sales assistants advertising costs in an equity manner, and award selective incentives according to the advertising/sales assistant's equity upon selling a product.

In addition, the online advertising system in accordance with the eighth embodiment of the present invention is provided with first to N-th seller terminals C1 to Cn, which provide and display product information on the web pages of the online advertising management server OAMS so that a customer can view product information through the user terminals A1 to An, offer a predetermined amount of member integrated reserve points for the customers' viewing the product information, sell the advertising/sales assistants advertising costs in an equity manner, and award selective incentives according to the advertising/sales assistant's equity upon selling a product.

Besides, there are provided advertisement/sales assistant terminals D1 to Dn, which view advertisement information and product information uploaded by the first to N-th advertiser terminals B1 to Bn and the first to N-th seller servers C1 to Cn, issue an advertisement/sales assistant apply signal and an advertisement equity purchase signal to the online advertising management server OAMS, with a specific product being specified, and issue a payment signal for advertising equity costs.

Meanwhile, the online advertising system in accordance with the eighth embodiment of the present invention is provided with the online advertising management server OAMS, which receives advertisement information and product information from the first to N-th advertiser terminals B1 to Bn and the first to N-th seller servers C1 to Cn and displays them on web pages, cumulatively accumulates member integrated reserve points in response to advertisement information and product information viewing signals transmitted from the user terminals A1 to An, performs a discount processing on the purchase price of a corresponding customer with the member integrated reserve points upon receipt of a customers' product purchase signal, updates reserve point data, sells products uploaded by the seller, sells the advertising/sales assistants advertising costs in an equity manner, and awards selective incentives according to the advertising/sales assistant's equity upon payment processing by a product sales.

Further, a web server WBS for routing the URL of the online advertising management server OAMS is provided in the online advertising management server OAMS so that the first to N-th advertiser terminals B1 to Bn, the first to N-th seller servers C1 to Cn, and the user terminals A1 to An can access the online advertising management server OAMS. In addition, the online advertising management server OAMS is provided with first and second databases DB1 and DB2 for storing the member integrated reserve point update information and customer purchase signals, customer information, seller information, advertiser information, advertising/sales assistant information, and equity information for each advertising/seller assistant.

Therefore, in the online advertising system in accordance with the eighth embodiment of the present invention, when a multiplicity of customers access a webpage provided by the online advertising management server OAMS and select advertisement information and product information displayed on the webpage of the online advertising management server OAMS, member integrated reserve points are accumulated by corresponding members information selection signals.

At this time, even if a plurality of members selects the advertisement information and product information displayed on the webpage of the online advertising management server OAMS, reserves are not accumulated as individual reserves for the corresponding members, but accumulated as member integrated reserve points jointly earned by the members.

In addition, the member integrated reserve points accumulated in the webpage of the online advertising management server OAMS are awarded as discount points to a member who has viewed the product information displayed on the corresponding webpage and wants to buy the product. Therefore, when the above member integrated reserve points are awarded to a certain customer as discount points, the member integrated reserve points are all cleared, and thus reserve points start to be accumulated again, starting from a zero state (0).

Meanwhile, the online advertising management server OAMS can easily advertise without the seller and advertiser's paying enormous costs and predict preference for released products in advance through the advertiser/sales assistant, by selling the advertising/sales assistants advertising costs in an equity manner, and awarding selective incentives according to the advertising/sales assistant's equity upon payment processing by a product sales.

In addition, online activities for the sale of a specific product can be encouraged through the advertiser/sales assistant, thereby revitalizing product sales.

The functions and operations of the online advertising system thus configured in accordance with the eighth embodiment of the present invention will be described in detail with reference to the accompanying drawings.

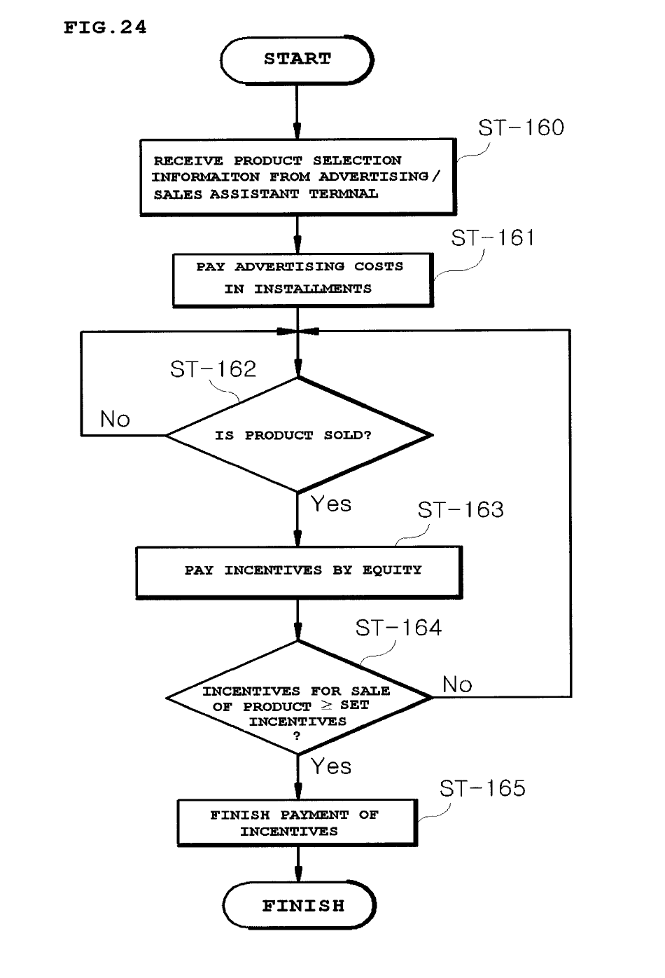

FIG. 24 is a flowchart showing a signal flow of the online advertising system in accordance with the eighth embodiment of the present invention.

First, in the online advertising system in accordance with the second embodiment of the present invention, a plurality of user terminals (e.g., A1, A2, and A3) and advertising/sales assistant terminals D1 to Dn are connected to the online advertising management server OAMS, which gives member integrated reserve points upon a multiplicity of members selecting advertisement information and product information, sells the advertising/sales assistants advertising costs in an equity manner, and awards selective incentives according to the advertising/sales assistant's equity upon payment processing by a product sales. Also, an advertiser terminal B1 and a seller server C1 for uploading advertisement information and sales information to the online advertising management server OAMS are connected thereto.

In this state, the advertiser terminals B1 to Bn and the seller servers C1 to Cn are connected to the online advertising management server OAMS, for uploading advertisement information and product information to the online advertising management server OAMS.

Then, the online advertising management server OAMS displays the uploaded advertisement information and product information through separate web pages.

Then, the online advertising management server OAMS receives product selection information and advertising equity payment information from the advertisement/sales assistant terminals D1 to Dn (ST-160), pays an advertising amount for a corresponding equity (ST-161), and registers the corresponding advertisement/sales assistant information and payment information.

In this state, the online advertising management server OAMS determines whether a product is sold (ST-162), and whether advertising/sales assistant information related to the corresponding product exists.

As a result of determination of the online advertising management server OAMS, if there exist advertising/sales assistant information related to a sold product, sales incentives are given to the corresponding advertising/sales assistant terminals D1 to Dn based on equity information contained in the corresponding advertising/sales assistant information (ST-163).

Meanwhile, the online advertising management server OAMS determines whether the incentives paid due to product sale are greater than or equal to preset incentives by comparison between preset incentive information and information about the incentives paid due to product sales (ST-164).

If the incentives paid due to product sale are greater than or equal to the preset incentives, the online advertising management server OAMS does no longer pay incentives to the corresponding advertising/sales assistant. In contrast, if the incentives paid due to product sale are smaller than the preset incentives, the online advertising management server OAMS continues to pay incentives on the sale of the corresponding specified product (ST-165).

Hereinafter, a ninth embodiment of the present invention will be described in detail with reference to the accompanying drawings.

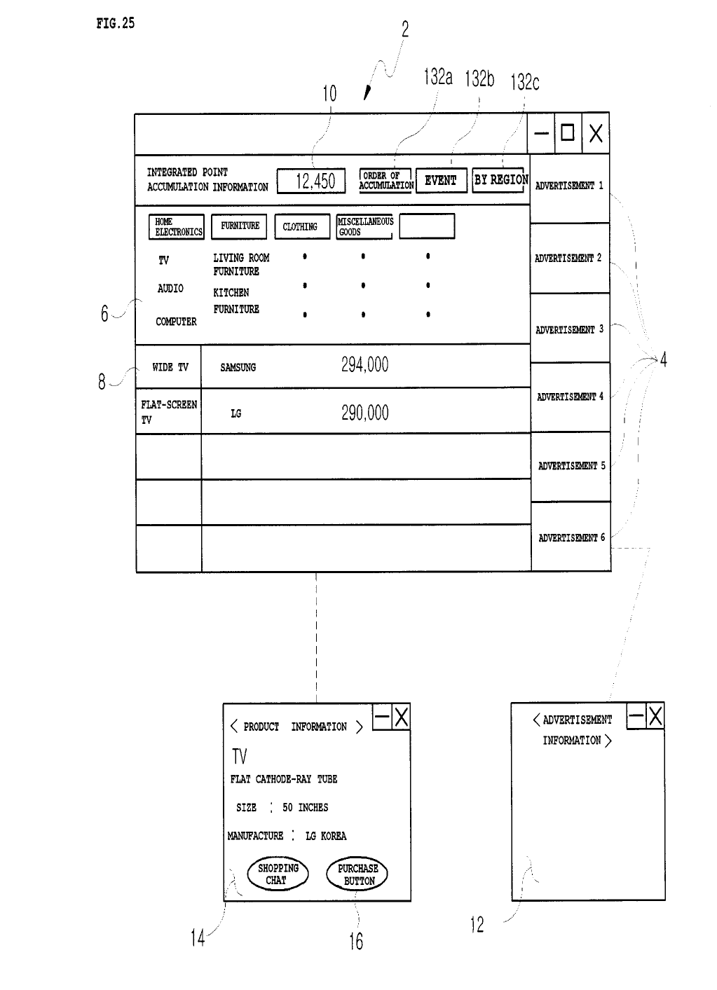

FIG. 25 is a view showing a webpage screen provided in a server of an online advertising system in accordance with a ninth embodiment of the present invention.

Referring to FIG. 25, the online advertising system in accordance with the ninth embodiment of the present invention is a system, which realigns screen outputs of information on searched companies outputted by entering a keyword in the search window in conjunction with search portals in the descending order of integrated reserve points cumulatively earned according to a user's selection, or in the order of event occurrence, or by region.

That is, the online advertising system in accordance with the ninth embodiment of the present invention is a system, in which when the system is applied and used for search portals having shopping malls installed therein or for shopping malls provided with a search window, if a specific product name is entered through the search window, search result information is realigned in the descending order of member integrated reserve points, or in the descending order of an event amount or discount rate, or search result information is selected by region.

For this, a plurality of advertisement information output fields 4 are displayed on the main screen 2 of the website of the online advertising management server OAMS so as to be viewable. As the online advertising management server OAMS awards member integrated reserve points as purchase discount points, advertisement information and another advertisement information for outputting payment information are displayed on the main screen 2 of the web site through popup windows. The product information is organized through an information field 6 classified by category, and detailed product information fields 8 selectable by category are provided.

Further, advertisement information output fields 4 provided available are stored in hyperlink status in the online advertising management server OAMS, in conjunction with a popup window 12 for outputting the corresponding advertisement information in detail, when a user selects the advertisement information output fields 4 by using computer terminals A1 to An. And, the detailed product information fields 8 displayed on the main screen of the online advertising management server OAMS are stored in hyperlink status in the online advertising management server OAMS so that detailed information of the corresponding product information is outputted in a popup window 14 when the detailed product information fields 8 are selected. The corresponding product can be purchased by choosing a purchase button 16 in the detailed product information fields 8.

Meanwhile, at the upper end of the main screen 2 of the web site of the online advertising management server OAMS, an integrated point accumulation information field 10 is provided for outputting integrated point accumulation information earned by a multiplicity of members clicking on the advertisement information output fields 4 and the detailed product information fields 8. A customer who wants to buy a product can check the integrated point accumulation information field 10 and buy the product at a discount for the purchase price of the product by using the corresponding accumulated amount of money.

In addition, a search window 130 for entering a keyword is provided at a predetermined portion of the upper end of the main screen 2 of the web site of the online advertising management server OAMS in order to display a search result of a specific product on the screen; and an accumulation order alignment button 132a, an event alignment button 132b, and an alignment-by-region button 132c are provided at the lower end thereof in order to realign search result information in the descending order of member integrated reserve points, or in the descending order of an event amount or discount rate, or to select search result information by region.

The functions and operations of the online advertising system thus configured in accordance with the ninth embodiment of the present invention will be described in detail with reference to the accompanying drawings.

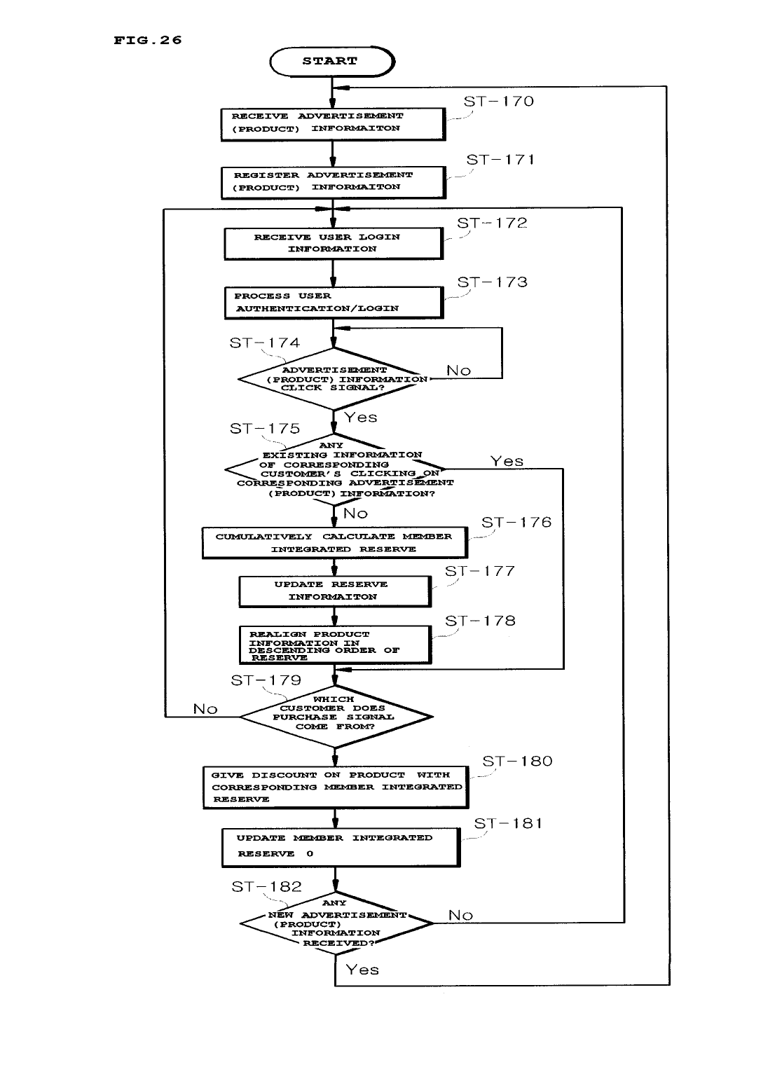

FIG. 26 is a flowchart showing a signal flow of the online advertising system in accordance with the ninth embodiment of the present invention.

First, in the online advertising system in accordance with the ninth embodiment of the present invention, a plurality of user terminals (e.g., A1, A2, and A3) are connected to the online advertising management server OAMS, which gives member integrated reserve points upon a multiplicity of members selecting advertisement information and product information, integrates and accumulates them until a specific customer issues a product purchase signal, and pays the member integrated reserve points saved as discount points when the purchase signal is issued. Also, an advertiser terminal B1 and a seller server C1 for uploading advertisement information and sales information to the online advertising management server OAMS are connected thereto.

In this state, the advertiser terminals B1 to Bn and the seller servers C1 to Cn are connected to the online advertising management server OAMS, for uploading advertisement information and product information to the online advertising management server OAMS (ST-170), wherein the online advertising management server OAMS displays the uploaded advertisement information and product information through separate web pages (ST-171).

Next, when an ID and password information are transmitted from the user terminals A1 to An (ST-172), the online advertising management server OAMS executes the customers' log-in process by authentication procedure of the corresponding information (ST-173).

Thereafter, the online advertising management server OAMS determines whether any viewing signal for a specific advertisement or product information is applied from the user terminals A1 to An (ST-174). If any viewing signal is applied, it extracts prestored information about members who have viewed the corresponding advertisement or product information and determines whether the corresponding customer has ever viewed the same advertisement or product information before by their comparison (ST-175).

As a result of the determination of the online advertising management server OAMS, if the corresponding customer has never viewed the corresponding advertisement and product information before, the online advertising management server OAMS gives a predetermined number of points according to the corresponding customers' viewing activity, cumulatively calculates the corresponding points (ST-176), and updates the member integrated reserve point information (ST-177).

On the other hand, as a result of the determination of the online advertising management server OAMS, if the corresponding customer has ever viewed the corresponding advertisement and product information before, the online advertising management server OAMS does not execute the accumulation of member integrated reserve points for the corresponding customer.

At this time, the online advertising management server OAMS realigns product information in the descending order of member integrated reserve points, or in the descending order of an event amount or discount rate, or by region in response to a product alignment signal (in order of point accumulation, in order of events, and by region) transmitted from the user terminals A1 to An (ST-178), and then sends the product information to the user terminals A1 to An for its output on the screen.

Next, the online advertising management server OAMS determines whether a purchase signal for a specific product is applied from any one of the user terminals A1 to An (ST-179). If a purchase signal for a specific product is applied from any one of the user terminals A1 to An, the online advertising management server OAMS awards the member integrated reserve points accumulated up to the corresponding point of time as discount points for the corresponding purchased product (ST-180).

Subsequently, the online advertising management server OAMS updates the member integrated reserve points to the initial zero state (0) (ST-181). At this time, the online advertising management server OAMS determines whether an upload signal for separate new advertisement or product information is applied (ST-182). If the upload signal for separate new advertisement or product information is applied, the process returns to the step of uploading the corresponding information. If any upload signal for separate new advertisement or product information is not applied, the process returns to the step of customer log-in to repeat the member integrated reserve awarding process and the sales activity for a customer who purchases a product.

Thus, the online advertising management server OAMS processes, in real time, the accumulation of points for advertisement information and product information viewing, and performs the clearing process of the member integrated reserve points in real time upon receipt of a purchase signal.

Hereinafter, an online advertising system in accordance with a tenth embodiment of the present invention will be described in detail with reference to the accompanying drawings.

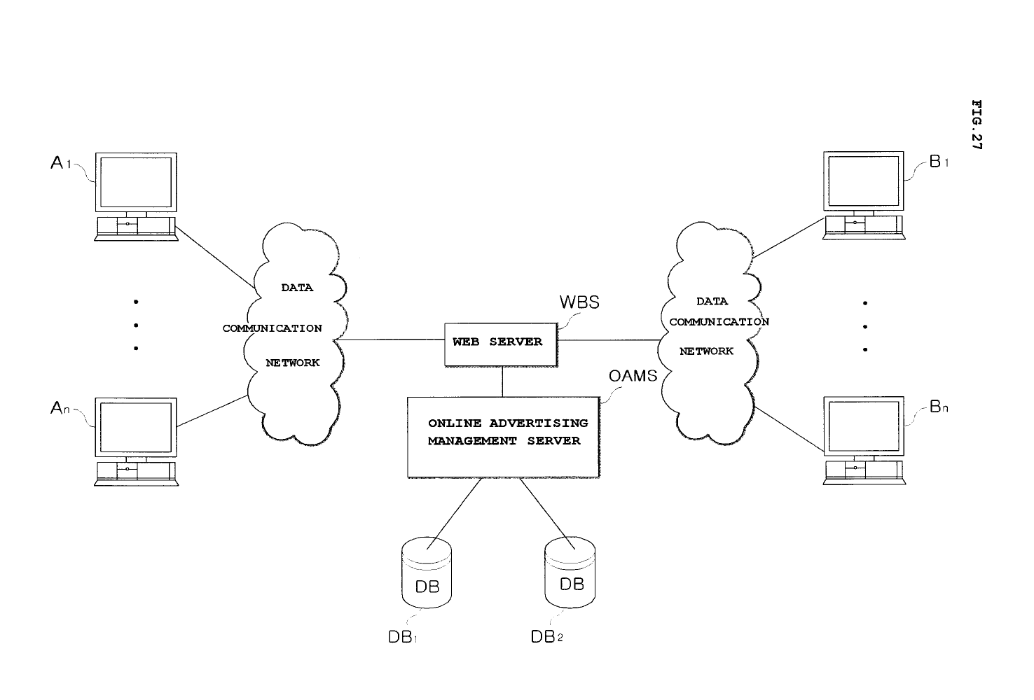

FIG. 27 is a frame format schematically showing the configuration of an online advertising system in accordance with a tenth embodiment of the present invention.

Referring to FIG. 27, the online advertising system in accordance with the tenth embodiment of the present invention is a system, which continues to accumulate prize money divided in given time units at a preset period of time by integrated accumulation of reserve amounts for individuals in response to clicking on an advertisement, and pays the prize money at a corresponding time point to a user in response to the user's clicking during accumulation, thereby revitalizing clicking on advertisement data.

That is, the online advertising system in accordance with the tenth embodiment of the present invention is a system, which provides an auction bid service for accumulated prize money by integrating all amounts of reserve per advertisement click preset in response to the number of user's clicking on an advertisement, dividing the total accumulated amount of reserve at a specific period of time to cumulatively increase prize money in proportion to the lapse of time, and selecting the corresponding user as a prize winner to award the prize money if a certain user clicks on a bid button during the cumulative increase of the prize money.

Meanwhile, although the online advertising system in accordance with the tenth embodiment of the present invention uses expressions like an auction system, bid, prize winning, etc., the related art is actually different from general auction. While in general auction, each of users suggests their bidding price for a specified product, and the user who has suggested the highest bidding price is selected as a successful bidder, the auction mentioned in the description of the online advertising system in accordance with the tenth embodiment of the present invention is to select a prize winner through a click time or given number while a plurality of users check a change in prize money in real time. However, the present invention uses the expression of [symbol] uction in the sense that a multiplicity of users compete for a specific target, and the meaning of [symbol] idding mentioned in the present invention is to issue a click signal to the server side so that a user can secure an amount of prize money.

Such an auction bidding service takes place in multiple sessions in a row at a given period of time (i.e., 12 to 12:30 am). Financial resources of accumulated amounts to be awarded as prize money in the auction bidding service are resources of amounts obtained by integrating reserves accumulated in reward for a multiplicity of users?clicking on advertisement data.

Further, the duration of one session is not preset, but set such that when the prize winner is decided, the auction bidding service for the corresponding session is finished, and an auction bidding service for the next session is automatically carried out. If it is assumed that the duration of an entire auction bidding service is 30 minutes, the prize money to be awarded upon the entire auction bidding service is divided by 30 minutes to calculate the accumulated portion of the prize money per second or per minute, so that the prize money continues to increase in per-second or per-minute intervals.

Accordingly, in the online advertising system in accordance with the tenth embodiment of the present invention, although the first user who clicks the bid button during the progress of the auction bidding service is selected as the prize winner, the latter the user clicks on the bid button, the more the amount of prize money for the corresponding session. That is, the total amount of prize money to be given by the system does not change no matter how much prize money and at which point of time the user takes.

Meanwhile, in the online advertising system in accordance with the tenth embodiment of the present invention, the user who can participate in an auction bidding service is limited to a user who clicks advertisement data more than a predetermined number of times, so as to encourage the viewing of advertisement data.

Moreover, in the online advertising system in accordance with the tenth embodiment of the present invention, if the same user has viewed the same advertisement data multiple times by storing and comparing the user's IP, MAC address, and cookie information, the corresponding advertisement data is processed as being viewed one time, thereby enabling the viewing of multiple advertisement data.

Further, the online advertising system in accordance with the tenth embodiment of the present invention makes it possible to select, as the prize winner, not only the first user who clicks on the bid button but also a given-numbered user who clicks on the bid button upon selecting the prize winner, thereby offering the equal opportunity of bidding to users whose communication rate is rather slow.

For this, the online advertising system in accordance with the tenth embodiment of the present invention is provided with advertiser terminals B1 to Bn which register advertisement data in the server, transfers advertising costs per click, and receive member information registered in the server.

The online advertising system in accordance with the tenth embodiment of the present invention is provided with user terminals A1 to An and a web browser, the user terminals A1 to An having a communication module, such as a modem, installed therein, for viewing advertisement information registered in the server, checking accumulated prize money information increasing in proportion to the lapse of time at a preset period of time for the auction bidding of advertisement prize money, and issuing a bidding signal for a specific prize money.

The online advertising system in accordance with the tenth embodiment of the present invention is provided with an online advertising management server OAMS, which receives and registers advertisement data from the advertiser terminals B1 to Bn, receives an advertisement data viewing signal from the user terminals A1 to An and pays advertising costs, accumulates the advertising costs, cumulatively outputting information of accumulated amount in proportion to the lapse of time when a specific period of time is reached, receives a bidding signal for a specific accumulated amount from the user terminals A1 to An, selects the corresponding user as the prize winner to award the user the prize money, and executes the accumulation of prize money of the next session.

A web server WBS for executing web communication with the advertiser terminals B1 to Bn and the user terminals A1 to An is provided within the online advertising management server OAMS.

Meanwhile, the online advertising management server OAMS is set such that when it receives a bidding signal for a specific accumulated amount from the user terminals A1 to An, it is determined if the user is a user who clicks on advertisement data more than a predetermined number out of the registered advertisement data, and then the user is selected as the prize winner.

Moreover, the online advertising management server OAMS is preset in such a manner that if the same user has viewed the same advertisement data multiple times by storing and comparing the IP address, MAC address, and cookie information of the user terminals A1 to An, the corresponding advertisement data is processed as being viewed one time.

Further, the online advertising management server OAMS is preset in such a manner as to select, as the prize winner, a given-numbered user who clicks on the bid button, rather than the first user who clicks on the bid button, upon selecting the prize winner, and the order of winning is randomly extracted for each session.

Meanwhile, the present invention is provided with many company servers (not shown) which operate in conjunction with the online advertising management server OAMS, and display advertisement data transmitted from the online advertising management server OAMS on the homepages. The servers displaying advertisement data are company servers of general portals or the like, so a detailed description thereof will be omitted here.

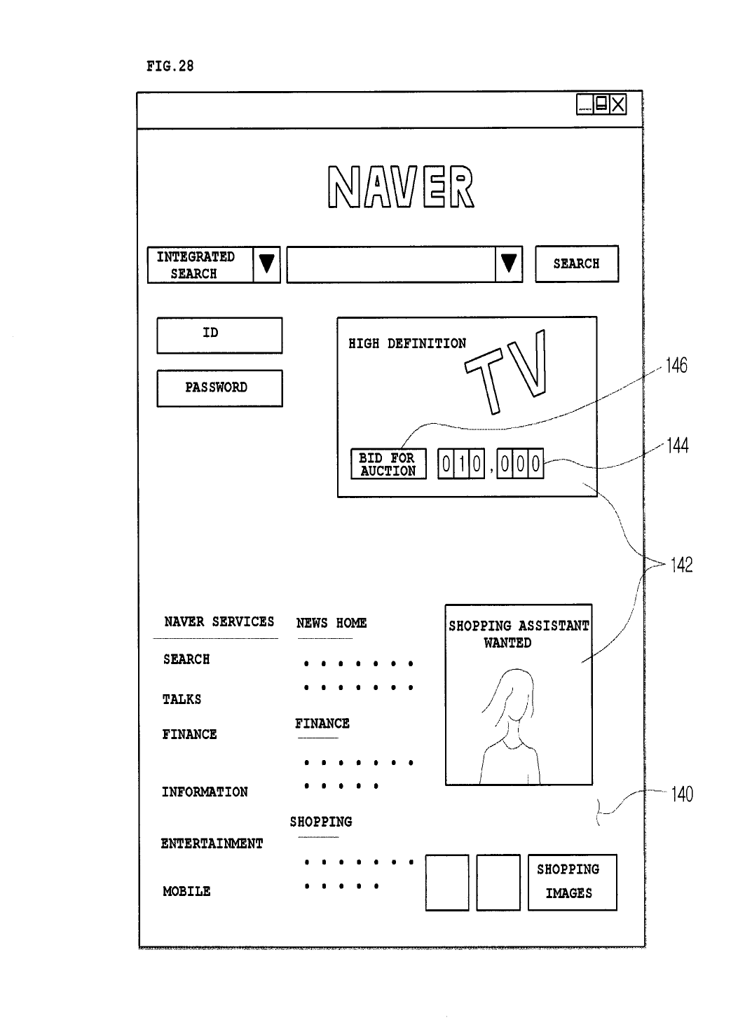

FIG. 28 is a view showing the screen of the homepage of a portal site implemented through the online advertising system in accordance with the tenth embodiment of the present invention.

Referring to FIG. 28, a screen as in FIG. 28 is outputted on the homepage 140 of a portal site implemented through the online advertising system in accordance with the tenth embodiment of the present invention through the web browser of the user terminals A1 to An.

A multiplicity of advertisement data 142 is displayed on the homepage 140 of the portal site, and the advertisement data 142 is displayed in such a manner to divide the amount integrated and accumulated by a multiplicity of users viewing the advertisement data 142 at a preset auction period of time and increase the same with the lapse of time. Thus, winnable amount information 144 changing with the lapse of time is provided at a predetermined portion of the upper end of the homepage 140 of the portal site.

Further, an action bid button 146 is prepared at a side of the winnable amount information 144. A user checks the winnable amount information 144 changed with the lapse of time on the homepage 140 of the portal site through the web browser of the user terminals A1 to An, and clicks on the auction bid button 146, when a desired appropriate amount is reached, to be awarded prize money.

As explained above, although the user wants to get more money as the prize money, he or she cannot wait blindly because another user may be awarded the corresponding prize money, and at the same time cannot easily click on the auction bid button 146 in order to secure too small an amount of prize money.

A multiplicity of auction sessions is carried out at a corresponding auction bidding period of time (e.g., from 12:00 to 12:30). The auction time for each session is not preset because it is until the prize winner is decided.

Preferably, the prize winner who has won in an auction bid for the corresponding day only is not permitted to win a plurality of times through a plurality of sessions. That is, the user decided as the prize winner in a certain session is excluded from prize winners for other sessions.

This is accomplished by managing prize winner information for each session in the online advertising management server OAMS and comparing information of a preliminary winner for another session with information of the previous prize winners.

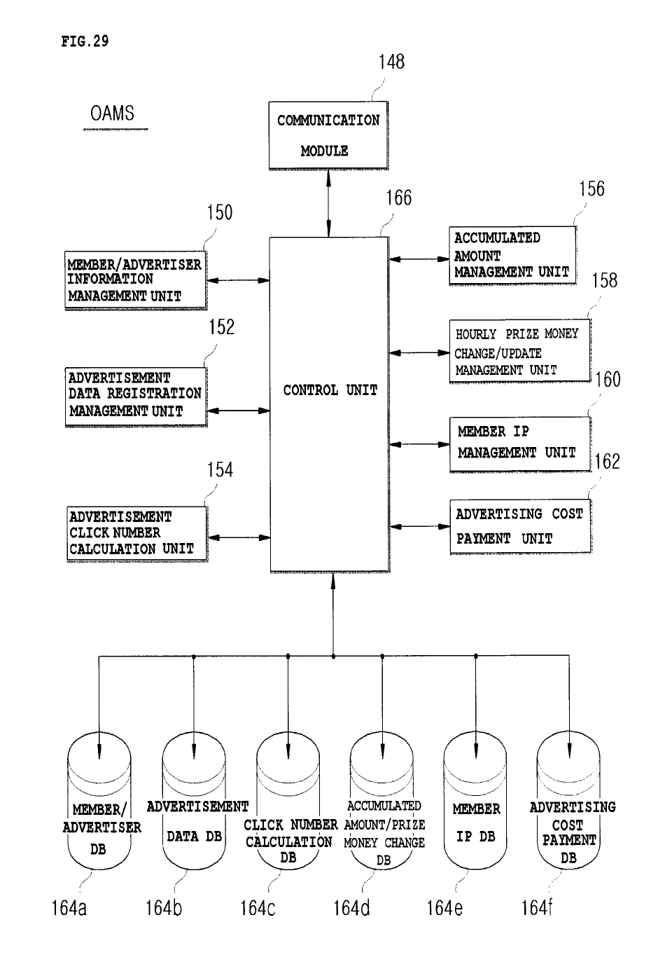

FIG. 29 is a block diagram showing the configuration of an online advertising management server included in the online advertising system in accordance with the tenth embodiment of the present invention.

Referring to FIG. 29, the online advertising management server OAMS included in the online advertising system in accordance with the present invention comprises therein a communication module, a member/advertiser information management unit, an advertisement data registration management unit, an advertisement click number calculation unit, an accumulated amount management unit, an hourly prize money change/update management unit, a member IP management unit, an advertising cost payment unit, a member/advertiser DB, an advertisement data DB, a click number calculation DB, an accumulated amount/prize money change DB, a member IP DB, an advertising cost payment DB, and a control unit.

Reference numeral 148 represents a communication module which receives advertisement data from the advertiser terminals B1 to Bn, receives an advertisement click signal from the user terminals A1 to An, provides accumulated reserve information in real time at an auction period of time, and receives a bidding signal from the user terminals.

Reference numeral 150 represents a member/advertiser information management unit which registers member information and advertiser information and authenticates them. Reference numeral 152 represents an advertisement data registration management unit which registers and manages advertisement data transmitted from the advertiser terminals B1 to Bn.

Reference numeral 154 represents an advertisement click number calculation unit which receives member information and click information for each advertisement from many company servers having advertisement data displayed on the homepages and calculates and manages them. Reference numeral 156 represents an accumulated amount management unit which cumulatively manages advertising costs per advertisement/per click in conjunction with the advertisement click number calculation unit 154.

Reference numeral 158 represents an hourly prize money change/update management unit which cumulatively changes the amount of prize money divided by session with the lapse of time, and resets the amount of prize money for the corresponding session when the prize winner is selected. Reference numeral 160 represents a member IP management unit which stores and manages the IP or MAC address and cookie information of members in order to prevent repeated clicks on advertisement data and repeated prize winnings in daily auctions.

Reference numeral 164a represents a member/advertiser DB for registering member information and advertiser information, and Reference numeral 164b represents an advertisement data DB for registering advertisement data transmitted from the advertiser terminals B1 to Bn information. And, reference numeral 164c represents a click number operation DB for receiving and storing member information and click information by advertisement from many company servers that have displayed advertisement data in the homepage.

Reference numeral 164d represents an accumulated amount/prize money change DB for storing advertising costs per advertisement/per click number, and reference numeral 164e represents a member IP DB for storing the IP or MAC address and cookie information of members in order to prevent repeated clicks on advertisement data and repeated prize winnings in daily auctions. Reference numeral 164f represents an advertising cost payment dB which calculates click signals for advertisement data received from the user terminals A1 to An and stores advertisement cost information.

Reference numeral 166 represents a control unit which receives and registers advertisement data from the advertiser terminals B1 to Bn, pays advertising costs upon receipt of an advertisement data viewing signal from the user terminals A1 to An, accumulates the advertising costs in real time, determines whether an auction time is reached, divides and accumulates prize money in proportion to the lapse of time, receives a selection signal for a specific amount of prize money from the user terminals A1 to An, selects the corresponding user as the prize winner to award him or her the prize money, and executes the accumulation of prize money for the next session.

The functions and operations of the online advertising system thus configured in accordance with the tenth embodiment of the present invention will be described in detail with reference to the accompanying drawings.

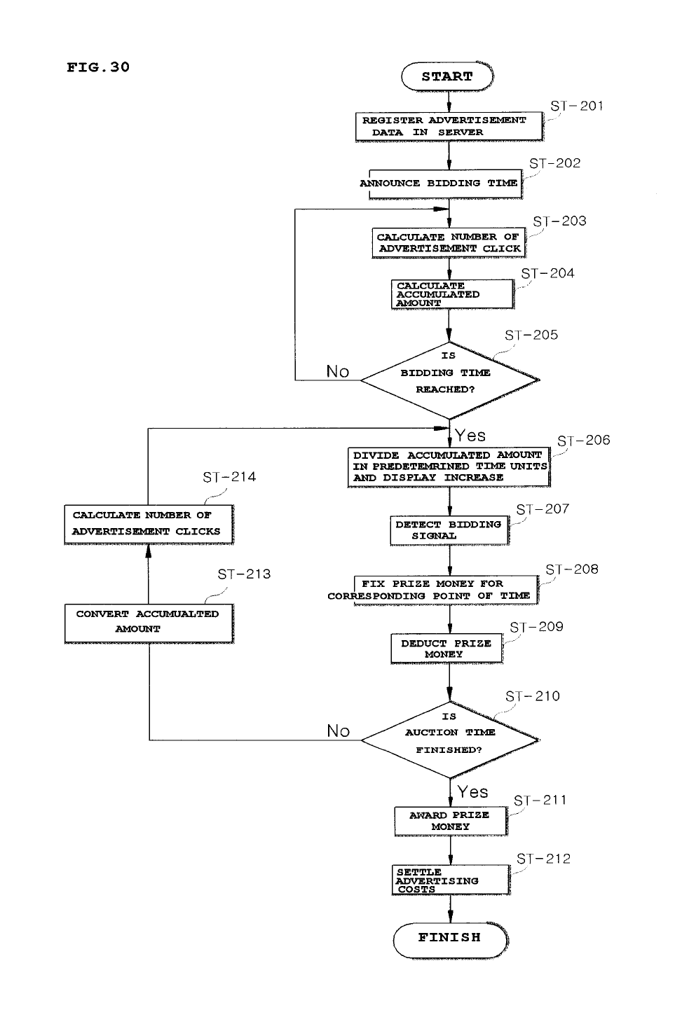

FIG. 30 is a flowchart showing a signal flow of the online advertising system in accordance with the tenth embodiment of the present invention.

First, the online advertising management server OAMS receives and registers advertisement data from the advertiser terminals B1 to Bn (ST-201), and announces an auction bidding time on the homepage where the advertisement data is displayed (ST-202).

Then, the online advertising management server OAMS receives the advertisement data information and click information thereof transmitted from the user terminals A1 to An to calculate the number of clicks per advertisement (ST-203), and integrates and accumulates the amount of reserve per click for the corresponding advertisement (ST-24).

In this state, the online advertising management server OAMS determines whether the auction bidding time is reached (ST-205). If the auction bidding time is reached, the online advertising management server OAMS divides the total amount of reserve in the auction in given time units (e.g., seconds or minutes), and displays an increase in the reserve amount with the lapse of each time unit (ST-206).

If the online advertising management server OAMS receives a bidding signal from any one of the user terminals A1 to An during the displaying of an increase in the reserve amount (ST-207), the online advertising management server OAMS fixes the accumulated prize money at the corresponding point of time as the prize money to be awarded to the user (ST-208), and deducts the prize money for the corresponding session from the total accumulated amount of prize money (ST-209).

Then, the online advertising management server OAMS determines whether the auction time is finished. If there exists any remaining auction time, it receives an advertisement data click signal again from the user terminals A1 to An and calculates it, converts the total accumulated amount of money, and then returns to the step ST-206.

If the auction time is finished, the online advertising management server OAMS awards the prize winner for each session the prize money.

In summary, if the total auction time is 30 minutes, this equals to 1,800 seconds and the total accumulated amount to be paid to the advertiser by advertisement clicking is -W18,000,000, the prize money to be awarded to the user for 30 minutes is -W18,000,000, and thus the online advertising management server OAMS displays that the prize money increases per second by -W10,000. If a user clicks on a predetermined amount of prize money increased, the prize money at the corresponding point of time is given to the user who clicks, and then the prize money is rest to -W0, and displays that the prize money increases per second by -W10,000.

That is, if the auction bidding time is within 30 minutes, a plurality auction of sessions is performed, and a multiplicity of prize winners is selected. The prize money to be awarded to a user from the start of an auction increases per second by -W10,000, and the user can get the prize money only by issuing a bidding signal. And, the online advertising management server OAMS manages user information so that there is no plurality of prize winners within 30 minutes on the same date which is the auction bidding time. Thus, it cannot be said that it is always advantageous to get a small amount of prize money by issuing a bidding signal blindly faster than other users. In the end, different users are awarded different prize money for each session.

Further, the online advertising management server OAMS may receive a click signal and user information transmitted from each of the user terminals A1 to An, sequentially accumulate them in a DB, and select a given-numbered user as a prize winner.

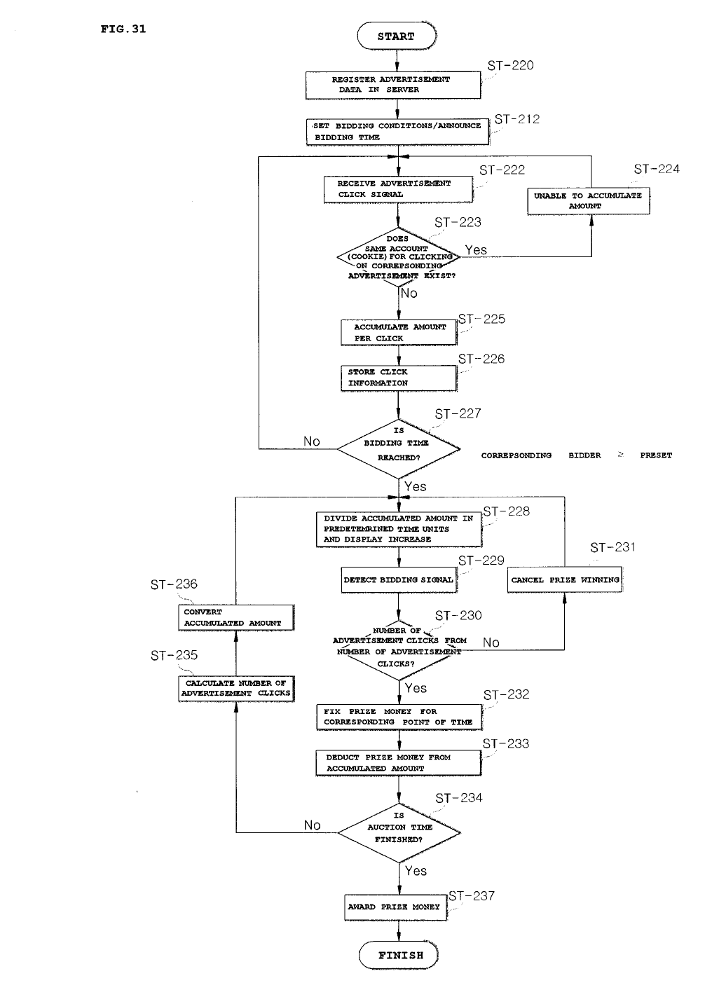

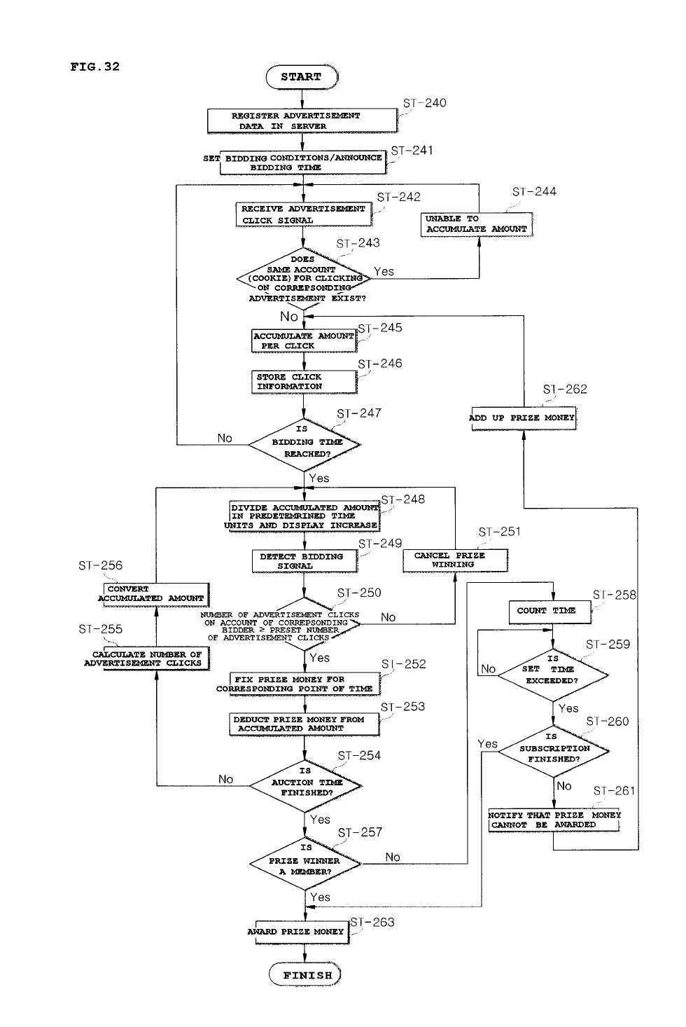

FIGS. 31 and 32 are flowcharts showing another signal flow of the online advertising system in accordance with the tenth embodiment of the present invention.

FIG. 31 is a signal flow for preventing the same user from increasing the total accumulated prize money by repeated clicks on the same advertisement data, and revitalizing the viewing of advertisement data, through the online advertising system in accordance with the tenth embodiment of the present invention.

First, the online advertising management server OAMS receives advertisement data from the advertiser terminals B1 to Bn and registers it (ST-220), and announces an auction bidding time and bidding conditions on the homepage where the advertisement data is displayed (ST-212).

At this time, the bidding conditions are as follows: a) the user who clicks on more than a predetermined number of advertisement data can participate in an auction; and b) an accumulated amount is calculated for one click even if the same advertisement data is clicked more than two times.

Then, when the online advertising management server OAMS receives advertisement data information and its click information from the user terminals A1 to An (ST-222), it determines whether there exists an account of the same user for the click information of the corresponding advertisement (ST-223). The user account includes all the information, such as an ID, cookie information, an IP, and an MAC address, that can be used to identify the corresponding user.

As a result of determination of the online advertising management server OAMS, if the same user has ever clicked on the same advertisement data, the online advertising management server OAMS does not accumulate a reserve for the user's clicking (ST-224).

On the other hand, as a result of determination of the online advertising management server OAMS, if the same user has never clicked on the same advertisement data, the number of clicks per advertisement is calculated, the amount of reserve per click for the corresponding advertisement is integrated and accumulated (ST-225), and the click information for the advertisement is stored (ST-226).

In this state, the online advertising management server OAMS determines whether the auction bidding time is reached (ST-227). If the auction bidding time is reached, the online advertising management server OAMS divides the total amount of reserve in the auction in given time units (e.g., seconds or minutes), and displays an increase in the reserve amount with the lapse of each time unit (ST-228).

If the online advertising management server OAMS receives a bidding signal from any one of the user terminals A1 to An during the displaying of an increase in the reserve amount (ST-229), it determines whether the number of the corresponding user's clicks on the advertisement on the same date is greater than or equal to a preset number of clicks by authentication of account information of the corresponding user (ST-230).

As a result of determination of the online advertising management server OAMS, if the number of the corresponding user's clicks on the advertisement on the same date is smaller than a preset number of clicks, the prize winning of the corresponding user is canceled (ST-231).

In contrast, as a result of determination of the online advertising management server OAMS, if the number of the corresponding user's clicks on the same advertisement is greater than or equal to a preset number of clicks, the online advertising management server OAMS fixes the accumulated prize money at the corresponding point of time as the prize money to be awarded to the user (ST-232), and deducts the prize money for the corresponding session from the total accumulated amount of prize money (ST-233).

Then, the online advertising management server OAMS determines whether the auction time is finished (ST-234). If there exists any remaining auction time, it receives an advertisement data click signal again from the user terminals A1 to An and calculates it (ST-235), converts the total accumulated amount of money (ST-236), and then returns to the step ST-228.

If the auction time is finished, the online advertising management server OAMS awards the prize winner for each session the prize money (ST-237).

On the other hand, FIG. 32 is a flowchart showing the process for allowing non-members to bid for an auction and encourage non-members to subscribe through the system of the present invention.

First, the online advertising management server OAMS receives advertisement data from the advertiser terminals B1 to Bn and registers it (ST-240), and announces an auction bidding time and bidding conditions on the homepage where the advertisement data is displayed (ST-241).

At this time, the bidding conditions are as follows: a) the user who clicks on more than a predetermined number of advertisement data can participate in an auction; and b) an accumulated amount is calculated for one click even if the same advertisement data is clicked more than two times.

Then, when the online advertising management server OAMS receives advertisement data information and its click information from the user terminals A1 to An (ST-242), it determines whether there exists an account of the same user for the click information of the corresponding advertisement (ST-243). The user account includes all the information, such as an ID, cookie information, an IP, and an MAC address, that can be used to identify the corresponding user.

As a result of determination of the online advertising management server OAMS, if the same user has ever clicked on the same advertisement data, the online advertising management server OAMS does not accumulate a reserve for the user's clicking (ST-244).

On the other hand, as a result of determination of the online advertising management server OAMS, if the same user has never clicked on the same advertisement data, the number of clicks per advertisement is calculated, the amount of reserve per click for the corresponding advertisement is integrated and accumulated (ST-245), and the click information for the advertisement is stored (ST-246).

In this state, the online advertising management server OAMS determines whether the auction bidding time is reached (ST-247). If the auction bidding time is reached, the online advertising management server OAMS divides the total accumulated amount in the auction in given time units (e.g., seconds or minutes), and displays an increase in the accumulated amount with the lapse of each time unit (ST-248).

If the online advertising management server OAMS receives a bidding signal from any one of the user terminals A1 to An during the displaying of an increase in the reserve amount (ST-249), it determines whether the number of the corresponding user's clicks on the advertisement on the same date is greater than or equal to a preset number of clicks by authentication of account information of the corresponding user (ST-250).

As a result of determination of the online advertising management server OAMS, if the number of the corresponding user's clicks on the advertisement on the same date is smaller than a preset number of clicks, the prize winning of the corresponding user is canceled (ST-251).

In contrast, as a result of determination of the online advertising management server OAMS, if the number of the corresponding user's clicks on the advertisement on the same date is greater than or equal to a preset number of clicks, the online advertising management server OAMS fixes the accumulated prize money at the corresponding point of time as the prize money to be awarded to the user (ST-252), and deducts the prize money for the corresponding session from the total accumulated amount of prize money (ST-253).

Then, the online advertising management server OAMS determines whether the auction time is finished (ST-254). If there exists any remaining auction time, it receives an advertisement data click signal again from the user terminals A1 to An and calculates it (ST-255), converts the total accumulated amount of money (ST-256), and then returns to the step ST-248.

If the auction time is finished, the online advertising management server OAMS determines whether a corresponding preliminary winner is a member or not through a member account received through the user terminals A1 to An (ST-257). If he or she is not a member, it counts a stand-by time (ST-258). After the lapse of a given set time (ST-259), the online advertising management server OAMS determines whether the corresponding preliminary winner has subscribed (ST-260). If he or she has not subscribed, it cancels the winning of the corresponding user (ST-261), and adds the prize winning amount for the corresponding session to the total accumulated amount (ST-262).

On the other hand, if the corresponding preliminary winner has subscribed for a predetermined time or is an existing member, the online advertising management server OAMS decides the corresponding preliminary winner as the prize winner for the corresponding session, and awards him or her the prize money (ST-263).

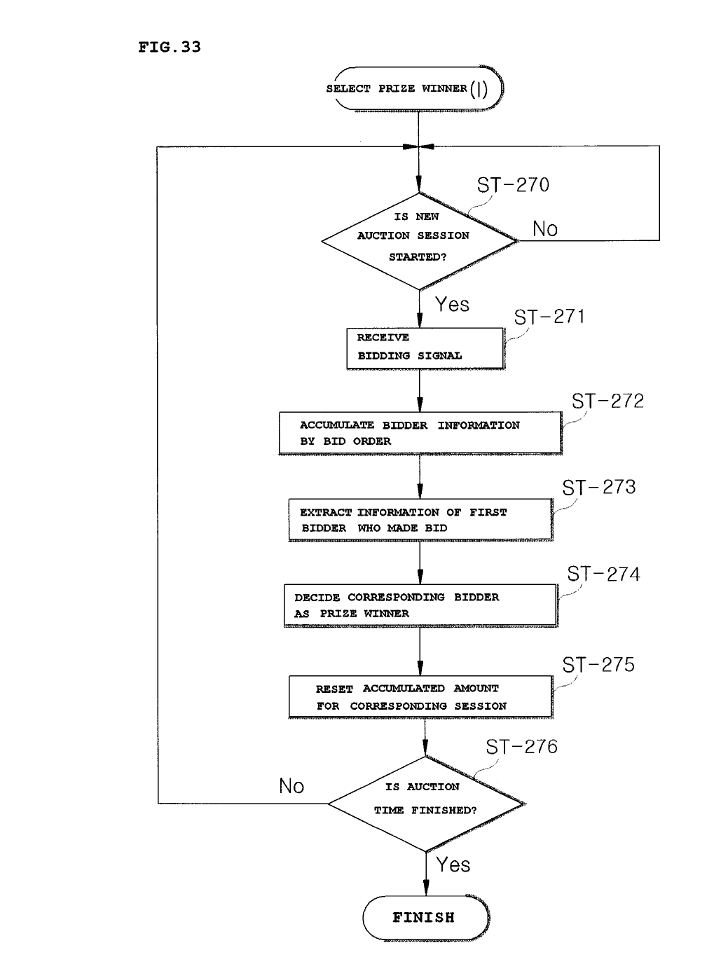

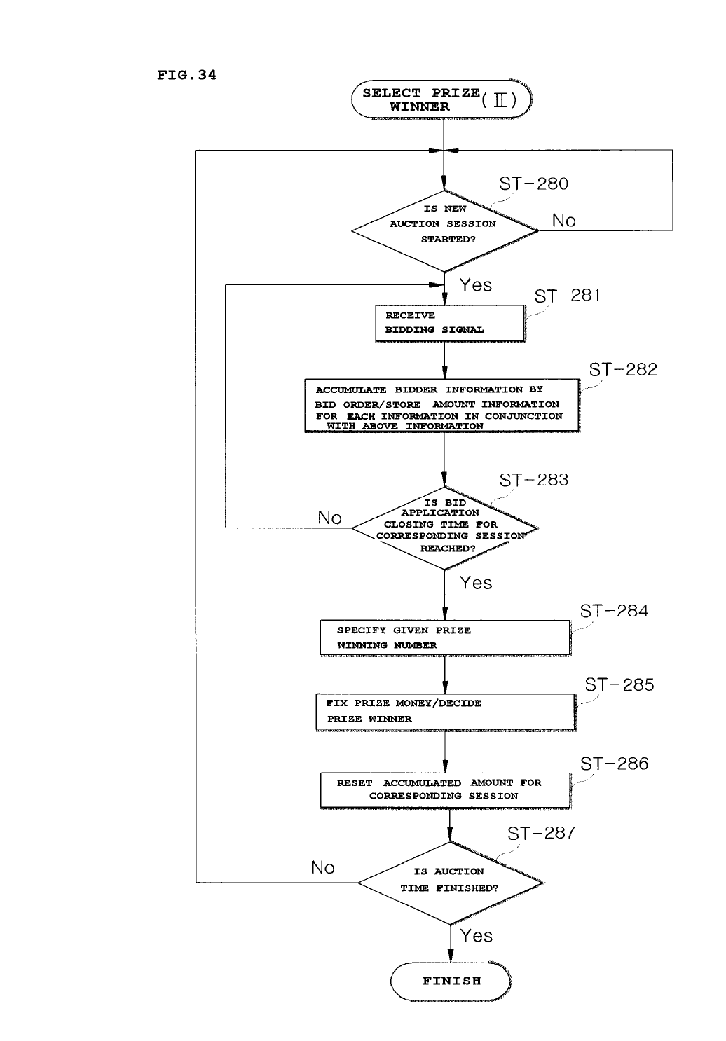

FIGS. 33 and 34 are flowcharts showing a prize winner selection process of the online advertising system in accordance with the tenth embodiment of the present invention.

First, the online advertising management server OAMS determines whether an auction time is reached and a new auction session is started (ST-270). If a new auction session is started, the online advertising management server OAMS receives a bidding signal and user account information from the user terminals A1 to An (ST-271).

Then, the online advertising management server OAMS accumulates and stores bidder information by bid order (ST-272), and extracts information of the first bidder who issues a bidding signal and decides him or her as a prize winner (ST-273).

In this state, the online advertising management server OAMS terminates the corresponding session, awards an accumulated amount for the corresponding session as prize money, and resets the accumulated amount information for the corresponding session (ST-275).

Next, the online advertising management server OAMS determines whether the auction time is finished (ST-276). If there exists any remaining auction time, it returns to the step ST-270.

FIG. 34 shows another prize winner selection process different from that of FIG. 33. The online advertising management server OAMS determines whether an auction time is reached and a new auction session is started (ST-280). If a new auction session is started, the online advertising management server OAMS receives a bidding signal and user account information from the user terminals A1 to An (ST-281).

Then, the online advertising management server OAMS stores bidder information by bid order and accumulated amount information for corresponding bidding information in conjunction with the above information (ST-282).

In this state, the online advertising management server OAMS determines whether a bid application closing time for the corresponding session is reached (ST-283). If the closing time is reached, a given numbered bid number among the bid information for the corresponding session is specified as the prize winner (ST-284 and ST-285)

In this state, the online advertising management server OAMS terminates the corresponding session, awards an accumulated amount for the corresponding session as prize money, and resets the accumulated amount information for the corresponding session (ST-286).

Next, the online advertising management server OAMS determines whether the auction time is finished (ST-287). If there exists any remaining auction time, it returns to the step ST-280.

Hereinafter, an online advertising system in accordance with an eleventh embodiment of the present invention will be described in detail with reference to the accompanying drawings.

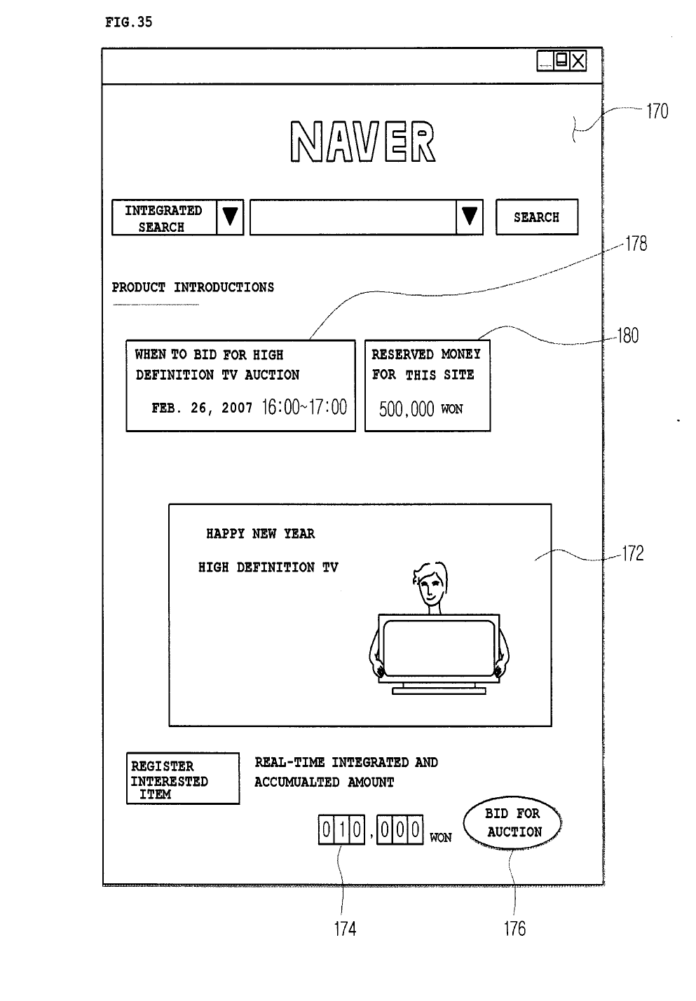

FIG. 35 is a view showing the screen of the homepage of a portal site implemented through an online advertising system in accordance with an eleventh embodiment of the present invention

Referring to FIG. 35, the online advertising system in accordance with the eleventh embodiment of the present invention is a system, which executes both an integrated cumulative prize winning process and an individual cumulative prize winning process for each advertisement data (or the homepage of an advertiser company) by dividing a target amount for cumulative prize winning per click on advertisement data displayed on the entire homepage of a specific portal or shopping mall, thereby encouraging users to access each advertisement data or the homepage of an advertiser company.

In other words, the online advertising system in accordance with the eleventh embodiment of the present invention provides a combined advertising auction service, which divides an accumulated reserve by users clicking on advertisement data, performs a whole integrated auction in the homepage of the company where the corresponding advertisement data is displayed by using some part of the divided reserve, and at the same time performs an individual auction for each company that has provided each advertisement data by using the other part of the divided reserve.

As for the auction duration, an individual advertising auction for each company is carried out after the integrated auction service is finished.

After the advertising auction system as in the first embodiment of the present invention is performed and finished, when a user selects a specific advertisement data on the homepage of the company where the advertisement data is displayed, screen information of a sub page 170 as shown in FIG. 35 is displayed on the web browser of the user terminals A1 to An.

An advertisement display window 172 for displaying the contents of the corresponding advertising data is provided on the sub page 170. Auction bidding time information 178 for the corresponding advertiser and reserve amount information 180 for the corresponding site are displayed at the upper end of the advertisement display window 172, and information 174 of prize money increasing in proportion to the lapse of time in given time units on the progress of an auction and an auction bid button 176 are provided at the lower end of the advertisement display window 172.

Accordingly, as in the first embodiment, the user checks the auction reserve information 174 displayed on the sub page 170 of an individual company to be outputted on the web browser through the terminals A1 to An, and clicks on the auction bid button 176 at a specific point of time to be awarded the reserve.

Meanwhile, the online advertising system in accordance with the eleventh embodiment of the present invention can register a specific advertisement data as an interested item to allow the user to display the sub page of an individual advertising company and to participate in the auction for each company more conveniently. The registered information is stored and managed for each user in the online advertising management server OAMS.

The functions and operations of the online advertising system thus configured in accordance with the eleventh embodiment of the present invention will be described in detail with reference to the accompanying drawings.

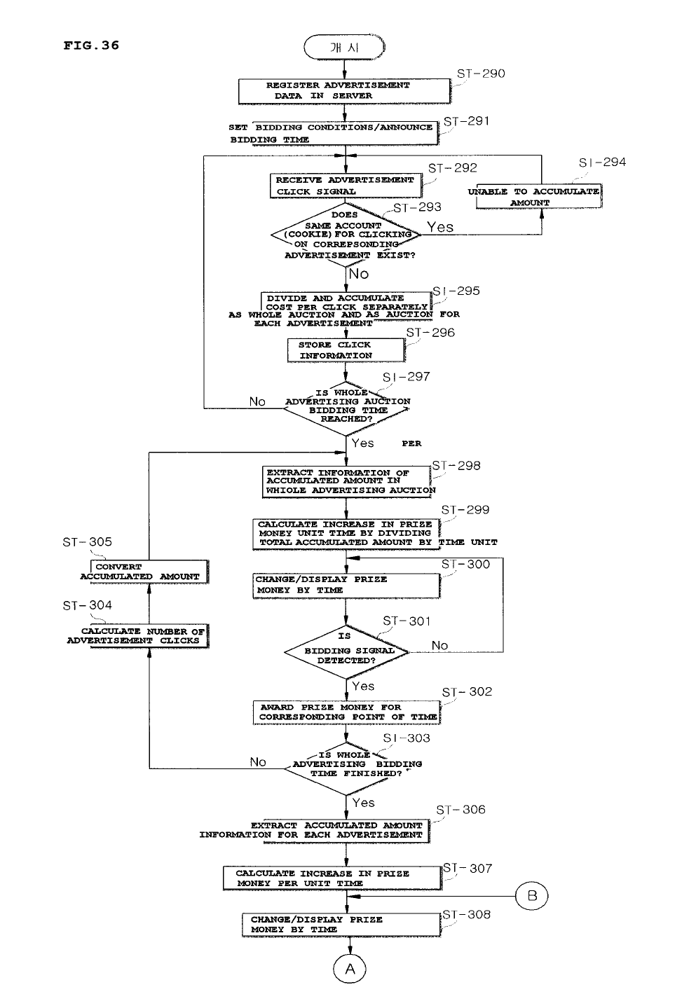

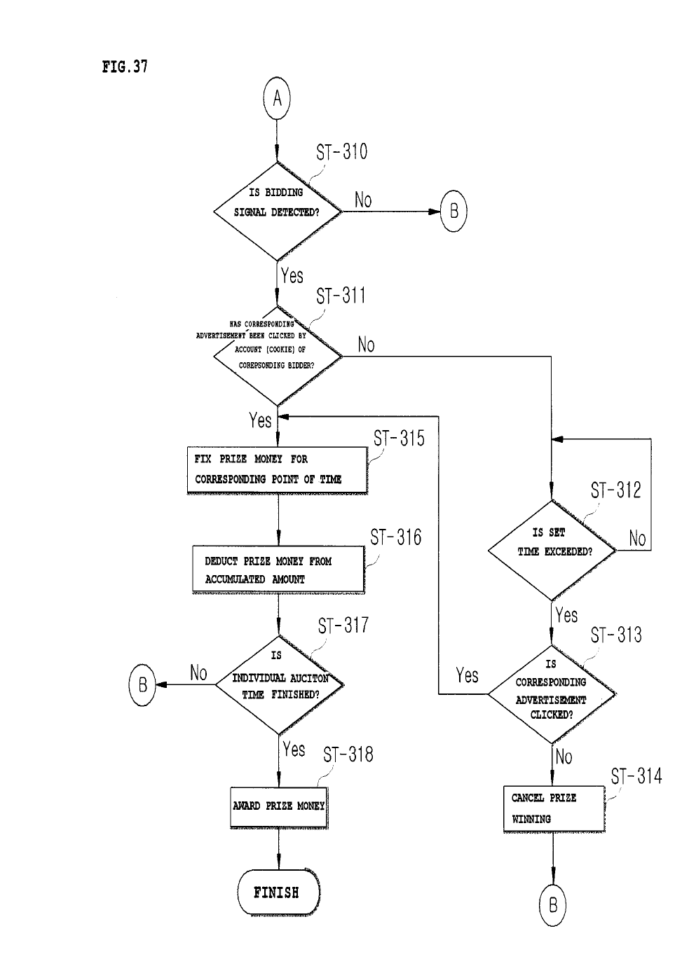

FIGS. 36 and 37 are a flowchart showing a signal flow of the online advertising system in accordance with the eleventh embodiment of the present invention.

First, the online advertising management server OAMS receives advertisement data from the advertiser terminals B1 to Bn and registers it (ST-290), and announces an auction bidding time and bidding conditions on the homepage where the advertisement data is displayed (ST-291).

At this time, the bidding conditions are as follows: upon participating in an advertising action for each company, prize winning process is carried out only for the user who clicks on the advertisement data of the corresponding company.

Then, when the online advertising management server OAMS receives advertisement data information and its click information from the user terminals A1 to An (ST-292), it determines whether there exists an account of the same user for the click information of the corresponding advertisement (ST-293). The user account includes all the information, such as an ID, cookie information, an IP, and an MAC address, that can be used to identify the corresponding user.

As a result of determination of the online advertising management server OAMS, if the same user has ever clicked on the same advertisement data, the online advertising management server OAMS does not accumulate a reserve for the user's clicking (ST-294).

On the other hand, as a result of determination of the online advertising management server OAMS, if the same user has never clicked on the same advertisement data, the number of clicks per advertisement is calculated, the amount of reserve per click for the corresponding advertisement is integrated and accumulated separately as a share of the whole advertising auction and a share of the advertising auction for each company (ST-295), and the click information for the advertisement is stored (ST-296).

In this state, the online advertising management server OAMS determines whether the whole advertising auction bidding time is reached (ST-297). If the whole advertising auction bidding time is reached, the online advertising management server OAMS divides the accumulated amount for the whole advertising auction in given time units (e.g., seconds or minutes), and displays an increase in the accumulated amount with the lapse of each time unit (ST-298). That is, the total accumulated amount for the whole advertising auction is divided by the whole advertising auction time, to calculate and display an increase per unit time in the prize money (ST-299 and ST-300).

If the online advertising management server OAMS receives a bidding signal from any one of the user terminals A1 to An during the displaying of an increase in the reserve amount (ST-301), it decides the corresponding user as the prize winner by authentication of account information of the corresponding user and awards him or her the prize money (ST-302).

Then, the online advertising management server OAMS determines whether the whole advertising auction time is finished (ST-303). If there exists any remaining auction time, it receives an advertisement data click signal again from the user terminals A1 to An and calculates it (ST-304), converts the total accumulated amount of money (ST-305), and then returns to the step ST-298.

If the whole advertising auction time is finished, the online advertising management server OAMS extracts information of the accumulated amount for each advertisement data (ST-306).

Then, the online advertising management server OAMS divides the accumulated amount for the corresponding advertisement in given time units (e.g., seconds or minutes), and displays an increase in the accumulated amount with the lapse of each time unit. That is, the accumulated amount for each advertisement is divided by the advertising auction time to calculate and display an increase per unit time in the prize money (ST-307).

If the online advertising management server OAMS receives a bidding signal from any one of the user terminals A1 to An during the displaying of an increase in the reserve amount (ST-310), it determines whether the corresponding user has ever clicked on the corresponding advertisement data on the corresponding date based on the account information of the corresponding user (ST-311).

Namely, in order to be a prize winner of an individual advertising auction for each advertisement, the user has to view the corresponding advertisement information on the corresponding date. This condition can be applied not only to the prize winner, but also set to bidding condition.

As a result of determination of the online advertising management server OAMS, if the corresponding user has never clicked on the corresponding advertisement data on the corresponding date, the online advertising management server OAMS determines whether the corresponding advertisement has ever clicked for a set period of time by counting the number of clicks for a predetermined time (ST-312 and ST-313). If the advertisement has been clicked, the prize money is fixed and the corresponding prize money amount is deducted from the accumulated prize money amount. If the advertisement has never been clicked, the corresponding prize winner is canceled (ST-314).

As a result of determination of the online advertising management server OAMS, if the corresponding user has ever clicked on the corresponding advertisement data on the corresponding date, the amount of prize money for the corresponding point of time is fixed (ST-315), and the corresponding prize money amount is deducted from the accumulated prize money amount (ST-316).

Meanwhile, the online advertising management server OAMS determines whether the corresponding individual advertising auction time is finished (ST-317). If there exists any remaining auction time, it receives an advertisement data click signal again from the user terminals A1 to An and calculates it, converts the total accumulated amount of money (ST-308), and then returns to the step ST-309.

If the individual advertising auction time is finished, the online advertising management server OAMS awards the prize money to the prize winner for each session (ST-318).

Accordingly, through this embodiment, the whole advertising auction can be performed by integrating and accumulating the reserve obtained by user clicking on advertisement data, dividing some parts thereof, and accumulating them differentially by individual advertisement data, and an individual advertising auction can also be performed by each advertisement data (each advertiser site) after the whole advertising auction is finished. Thus, the user can have multiple opportunities to participate in auctions, and the advertiser can virtually encourage the user to access the page displaying the advertiser site or the advertisement information.

At this time, it is also possible for the advertiser terminals B1 to Bn, rather than the online advertising management server OAMS, to perform an individual advertising auction for each advertiser site.

Hereinafter, an online advertising system in accordance with a twelfth embodiment of the present invention will be described in detail with reference to the accompanying drawings.

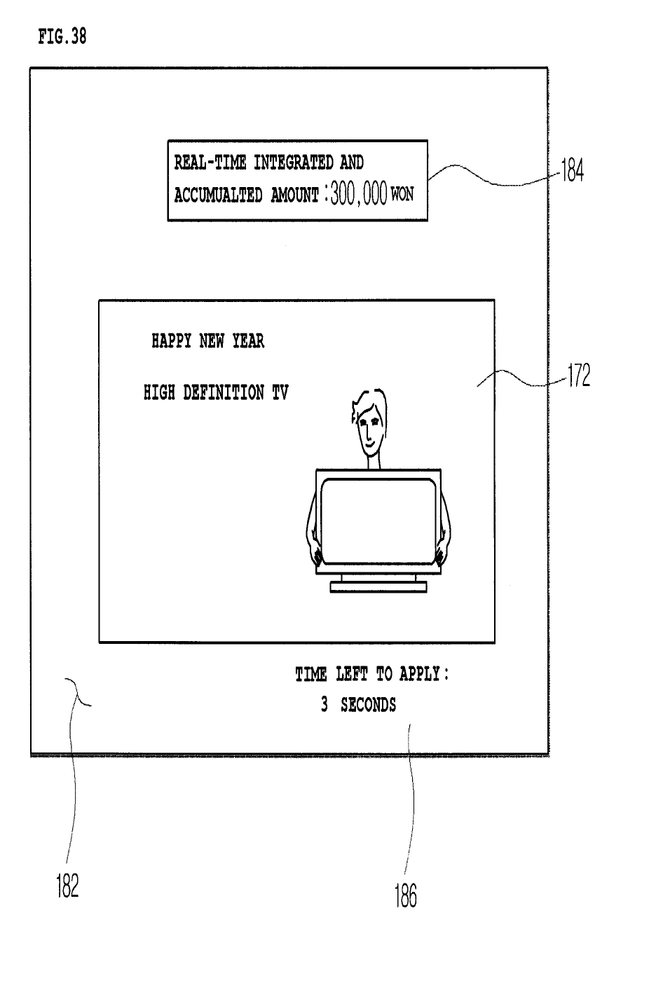

FIG. 38 is a view showing the screen of the homepage of a portal site implemented through an online advertising system in accordance with a twelfth embodiment of the present invention.

Referring to FIG. 38, the online advertising system in accordance with the twelfth embodiment of the present invention is a system, which provides a participation time during which a user can participate in the winning auction of an accumulated amount of money in response to a user's clicking on an advertisement, and allows the participation time of the user who can participate in the winning auction service of an accumulated amount of money to be controlled by the number of advertisement views and an advertisement viewing time, thereby promoting more advertisement viewings.

In other words, the online advertising system in accordance with the twelfth embodiment of the present invention is a system, which restricts a bidding time for participating in an advertising auction to the number of advertisements viewed by each user in order to offer more benefits to the user who viewed advertisement data more than other users.

Therefore, when a user selects a specific advertisement data on the homepage of the company where the advertisement data is displayed through the online advertising system in accordance with the twelfth embodiment of the present invention, screen information of a sub page 182 as shown in FIG. 358 is displayed on the web browser of the user terminals A1 to An.

An advertisement display window 172 for displaying the contents of the corresponding advertisement data is provided on the sub page 182. Auction bidding time information 178 for the corresponding advertiser and reserve amount information 184 for the corresponding site are displayed at the upper end of the advertisement display window 172, and information 186 of the time at which each user can participate in an auction upon the progress of the auction is displayed at the lower end of the advertisement display window 172.

The functions and operations of the online advertising system thus configured in accordance with the twelfth embodiment of the present invention will be described in detail with reference to the accompanying drawings.

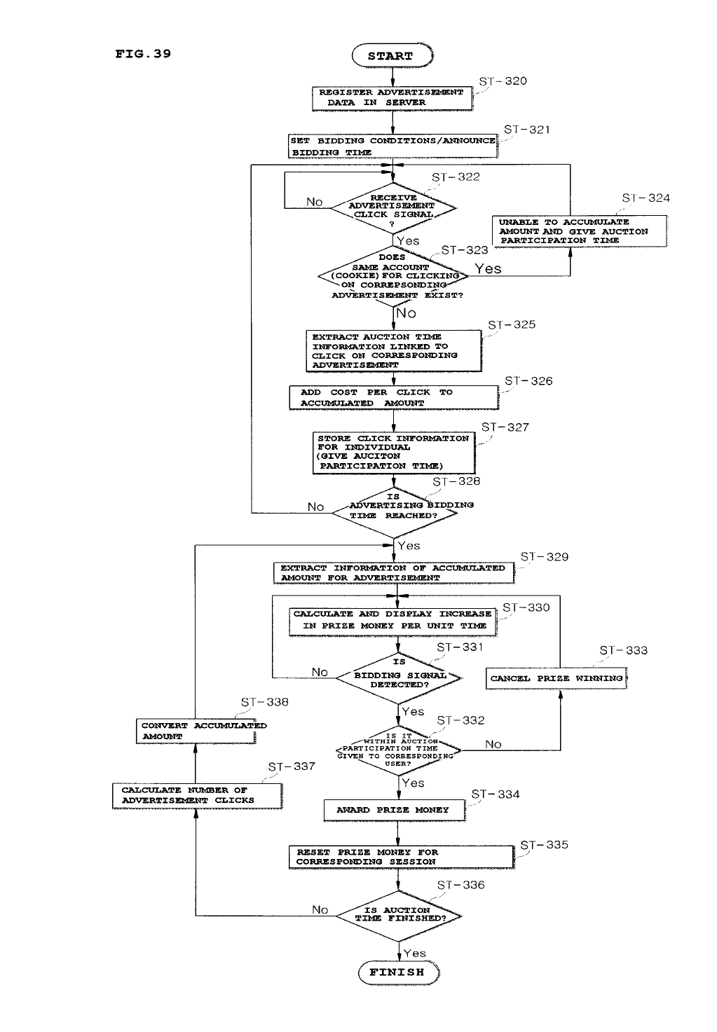

FIG. 39 is a flowchart showing a signal flow of the online advertising system in accordance with the twelfth embodiment of the present invention.

First, the online advertising management server OAMS receives advertisement data from the advertiser terminals B1 to Bn and registers it (ST-320), and announces an auction bidding time and a bidding condition on the homepage where the advertisement data is displayed (ST-321).

The bidding condition is as follows: upon participating in an advertising action, an auction participation time for each user is restricted.

Then, when the online advertising management server OAMS receives advertisement data information and its click information from the user terminals A1 to An (ST-322), it determines whether there exists an account of the same user for the click information of the corresponding advertisement (ST-323). The user account includes all the information, such as an ID, cookie information, an IP, and an MAC address, that can be used to identify the corresponding user.

As a result of determination of the online advertising management server OAMS, if the same user has ever clicked on the same advertisement data, the online advertising management server OAMS does not accumulate a reserve for the user's clicking (ST-324).

On the other hand, as a result of determination of the online advertising management server OAMS, if the same user has never clicked on the same advertisement data, the amount of reserve for each advertisement is integrated and accumulated in the total accumulated amount of reserve, auction time information for the corresponding advertisement is extracted (ST-325), and an auction participation time is given to each user (ST-327).

At this time, the auction participation time provided by the online advertising management server OAMS varies according to each advertisement. The auction participation time may be provided differentially by the advertiser's selection or by advertisement type, i.e., 3 seconds for a text advertisement, 5 seconds for an image advertisement, and 10 seconds for a moving image advertisement.

Accordingly, the online advertising management server OAMS stores auction participation time information for the corresponding advertisement data by user who has viewed the corresponding advertisement data.

In this state, the online advertising management server OAMS determines whether the advertising auction bidding time is reached (ST-328). If the advertising auction bidding time is reached, the online advertising management server OAMS divides the integrated and accumulated amount for the advertising auction in given time units (e.g., seconds or minutes), and displays an increase in the accumulated amount with the lapse of each time unit (ST-329 and ST-330). That is, the total accumulated amount for the advertising auction is divided by the advertising auction time, to calculate and display an increase per time unit in the prize money.

If the online advertising management server OAMS receives a bidding signal from any one of the user terminals A1 to An during the displaying of an increase in the reserve amount (ST-331), it determines whether the bidding signal is received within the auction participation time provided to the corresponding user by authentication of the account information of the corresponding user (ST-332).

If the online advertising management server OAMS has received the bidding signal transmitted from the user terminals A1 to An, with the auction participation time provided to the corresponding user being exceeded, the online advertising management server OAMS cancels the prize winning of the corresponding bidder (ST-333).

On the contrary, if the online advertising management server OAMS has received the bidding signal transmitted from the user terminals A1 to An within the auction participation time provided to the corresponding user, the online advertising management server OAMS decides the corresponding bidder as the prize winner and awards him or her the prize money (ST-334 and ST-335).

Then, the online advertising management server OAMS determines whether the advertising auction time is finished (ST-336). If there exists any remaining auction time, it receives an advertisement data click signal again from the user terminals A1 to An and calculates it (ST-337), converts the total accumulated amount of money (ST-338), and then returns to the step ST-329.

Hereinafter, an online advertising system in accordance with a thirteenth embodiment of the present invention will be described with reference to the accompanying drawings.

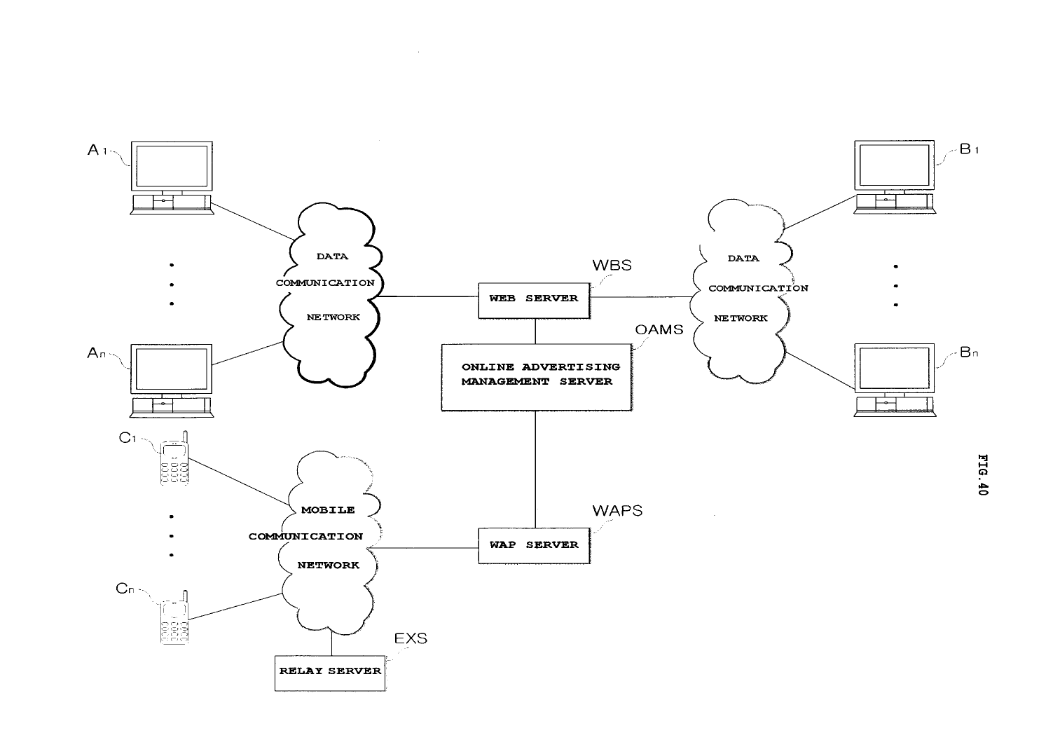

FIG. 40 is a frame format schematically showing the configuration of an online advertising system in accordance with a thirteenth embodiment of the present invention.

Referring to FIG. 40, the online advertising system in accordance with the thirteenth embodiment of the present invention is a system, which allows a user to freely accumulate auction participation times for participating in the winning auction service of an accumulated amount of money by outputting advertisement data for participation in the winning auction service of an accumulated amount of money to the cellular phone of the corresponding user through the wireless internet by the user's cellular phone authentication.

In other words, the online advertising system in accordance with the thirteenth embodiment of the present invention is a system which allows a user to easily view advertisement data through the user's cellular phone and allows a server to manage the viewing information since the user has to view the advertisement data in order to participate in an advertising auction.

For this, the online advertising system in accordance with the thirteenth embodiment of the present invention is provided with advertiser terminals B1 to Bn for registering advertisement data in the server, transferring advertising costs per click, and receiving member information registered in the server.

The online advertising system in accordance with the thirteenth embodiment of the present invention is provided with a communication module, such as a modem, therein for viewing advertisement data registered in the server, checking accumulated prize money information increasing in proportion to the lapse of time at a preset period of time for bidding for an advertising prize money auction, and issuing a bidding signal for a specific prize money, user terminals A1 to An having a web browser, and user cellular phones C1 to Cn for receiving an authentication signal from the online advertising management server OAMS to issue a wireless internet automatic callback setting request signal, receiving and viewing advertisement data from the online advertising management server OAMS, and automatically transmitting the viewing information to the online advertising management server OAMS.

The online advertising system in accordance with the thirteenth embodiment of the present invention is provided with the online advertising management server OAMS, which receives and registers advertisement information from the advertiser terminals B1 to Bn, receives an advertisement viewing signal from the user terminals A1 to An and the user cellular phones C1 to Cn and pays advertising costs, accumulates the advertising costs, cumulatively outputs accumulated amount information in proportion to the lapse of time when a specific period of time is reached, receives a bidding signal for a specific accumulated amount from the user terminals A1 to An, selects the corresponding user as the prize winner to award the user the prize money, and executes the accumulation of prize money of the next session.

A web server WBS for executing web communication with the advertiser terminals B1 to Bn and the user terminals A1 to An and a WAP server WAPS for performing a wireless data communication through the user cellular phones C1 to Cn are provided within the online advertising management server OAMS.

Meanwhile, the online advertising management server OAMS is set such that when it receives a bidding signal for a specific accumulated amount from the user terminals A1 to An and the cellular phones C1 to Cn, it is determined if the user is a user who clicks on advertisement data more than a predetermined number out of the advertisement data having the corresponding user registered, and then the user is selected as the prize winner.

Moreover, the online advertising management server OAMS is preset in such a manner that if the same user has viewed the same advertisement data multiple times by receiving, storing, and comparing the IP address, MAC address, and cookie information of the user terminals A1 to An or telephone number information from the user cellular phones C1 to Cn, the corresponding advertisement data is processed as being viewed one time.

Meanwhile, the present invention is provided with many company servers (not shown) which operate in conjunction with the online advertising management server OAMS, and display advertisement data transmitted from the online advertising management server OAMS on the homepages. The servers displaying advertisement data are company servers of general portals or the like, so a detailed description thereof will be omitted here.

The functions and operations of the online advertising system thus configured in accordance with the thirteenth embodiment of the present invention will be described in detail with reference to the accompanying drawings.

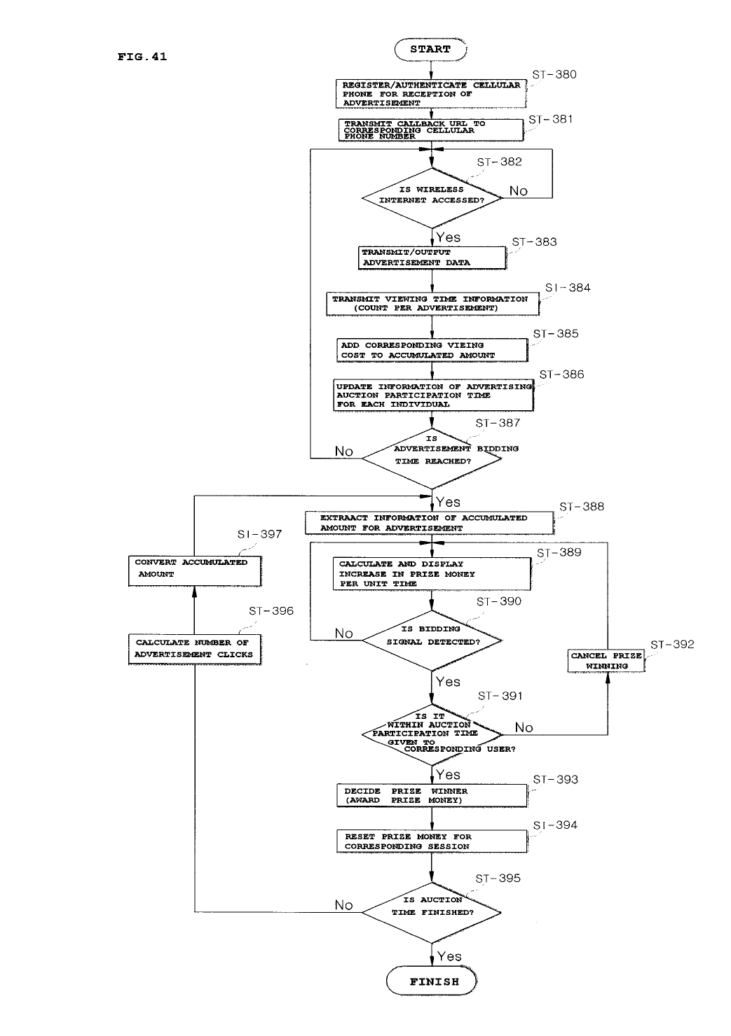

FIG. 41 is a flowchart showing a signal flow of the online advertising system in accordance with the thirteenth embodiment of the present invention.

First, in FIG. 41, only a signal flow performed through the user cellular phones C1 to Cn among the signal flows of the online advertising management system in accordance with the thirteenth embodiment of the present invention will be described.

With advertisement data received from the advertiser terminals B1 to Bn and registered, the online advertising management server receives a cellular phone registration request signal for advertisement reception from the user cellular phones C1 to Cn, and registers and authenticates the corresponding cellular phone number (ST-380).

In this state, the online advertising management server OAMS transmits a callback URL information to the user cellular phones C1 to Cn (ST-381). Then, the user cellular phones C1 to Cn receive the corresponding callback URL and output it on the screen. When a user accesses the wireless internet and selects the corresponding callback URL (ST-382), the online advertising management server OAMS, which is the address of the corresponding URL, is accessed. The online advertising management server OAMS extracts advertisement data preset in the corresponding URL, and transmits to the user cellular phones C1 to Cn and outputs the same on the screen (ST-383).

At this time, in the callback URL, the address of a server for connecting to a specific server through the wireless internet and information of a specific file (advertisement data file) are registered together.

Therefore, the online advertising management server OAMS registers auction participation time information and user information provided in reward for the viewing of advertisement data transmitted to the user cellular phones C1 to Cn, and integrates and accumulates reserves for each advertisement in the total accumulated amount of reserve (ST-384, ST-385 and ST-386).

In this state, the online advertising management server OAMS determines whether the advertising auction bidding time is reached (ST-387). If the advertising auction bidding time is reached, the online advertising management server OAMS divides the integrated and accumulated amount for the advertising auction in given time units (e.g., seconds or minutes) (ST-388), and displays an increase in the accumulated amount with the lapse of each time unit (ST-389). That is, the total accumulated amount for the advertising auction is divided by the advertising auction time, to calculate and display an increase per time unit in the prize money.

If the online advertising management server OAMS receives a bidding signal from any one of the user terminals A1 to An or any one of the user cellular phones C1 to Cn during the displaying of an increase in the reserve amount (ST-390), it determines whether the bidding signal is received within the auction participation time provided to the corresponding user by authentication of the account information of the corresponding user (ST-391).

If the online advertising management server OAMS has received the bidding signal transmitted from the user terminals A1 to An or the user cellular phones C1 to Cn, with the auction participation time provided to the corresponding user exceeded, the online advertising management server OAMS cancels the prize winning of the corresponding bidder (ST-392).

On the other hand, if the online advertising management server OAMS has received the bidding signal transmitted from the user terminals A1 to An within the auction participation time provided to the corresponding user, the online advertising management server OAMS decides the corresponding bidder as the prize winner and awards him or her the prize money (ST-393).

Then, the online advertising management server OAMS determines whether the advertising auction time is finished (ST-395). If there exists any remaining auction time, it receives an advertisement data click signal again from the user terminals A1 to An and calculates it (ST-396), changes the total accumulated amount of money (ST-397), and then returns to the step ST-388.

Hereinafter, an online advertising system in accordance with a fourteenth embodiment of the present invention will be described in detail with reference to the accompanying drawings.

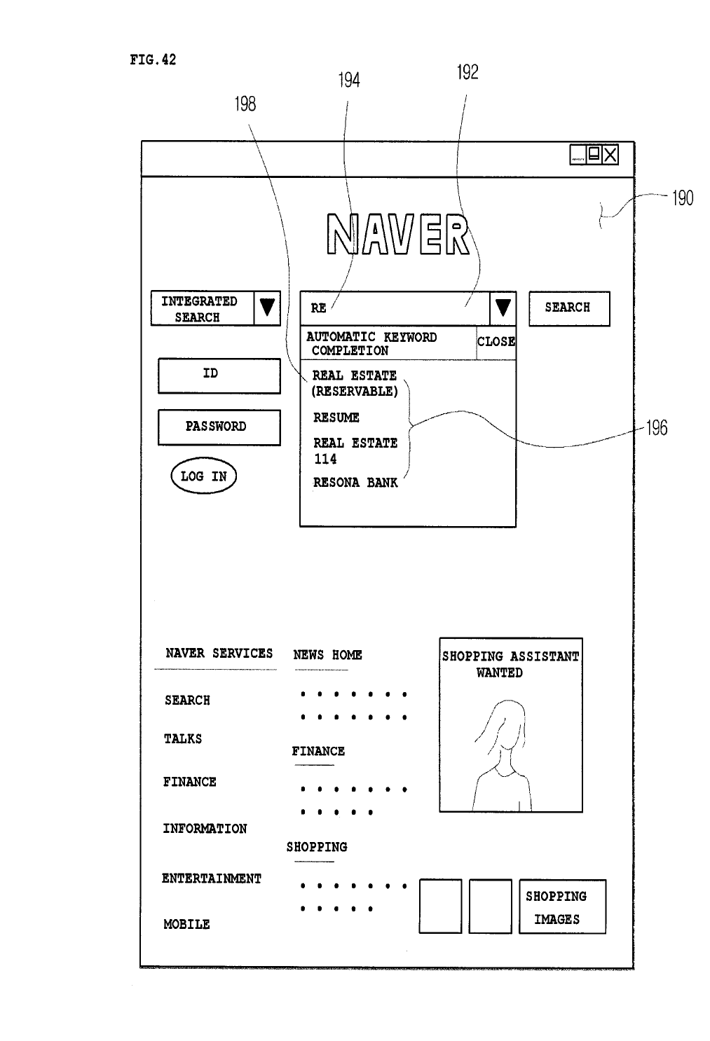

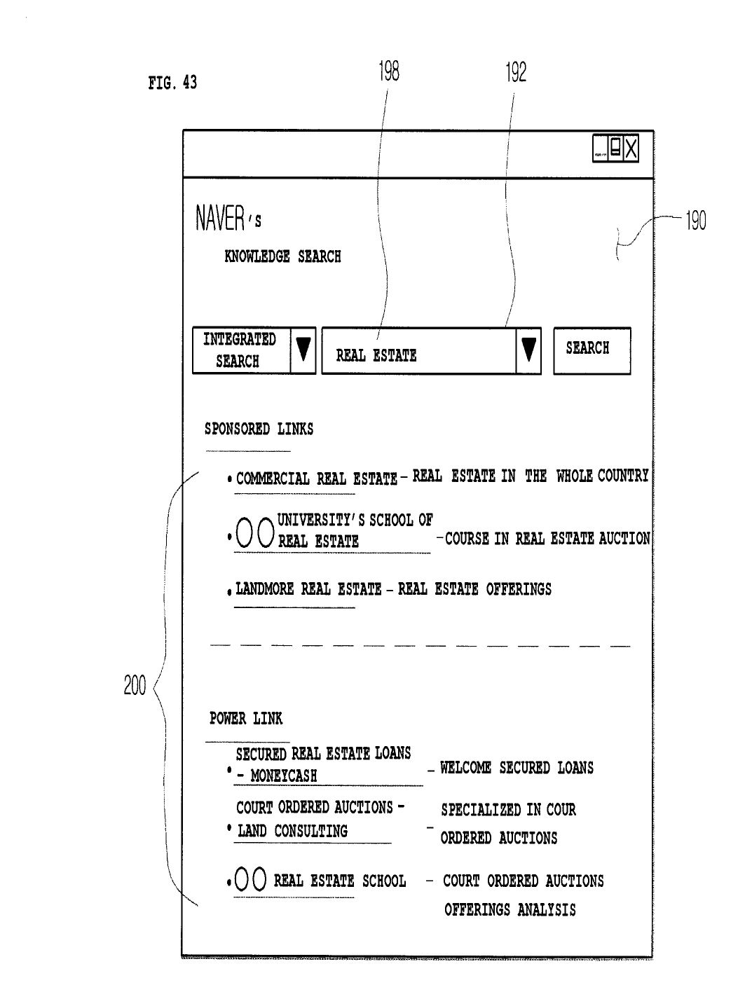

FIGS. 42 and 43 are views showing the screen of the homepage of a portal site implemented through an online advertising system in accordance with a fourteenth embodiment of the present invention

Referring to these drawings, the online advertising system in accordance with the fourteenth embodiment of the present invention is a system, which indicates information of an accumulated amount of time, during which a user can participate in the winning auction service of an accumulated amount of money, in specific leading keywords among a plurality of similar keywords linked in advance, so that it can be outputted in the search window by a specific keyword entered in the search window, and provides a predetermined auction participation time to the corresponding user and outputs search results if the corresponding leading keyword indicating the information of an accumulated amount of time is selected/entered, thereby encouraging the user to enter a specific leading keyword and accordingly outputting a specific advertisement as a result of the keyword.

In other words, the online advertising system in accordance with the fourteenth embodiment of the present invention is a system, which provides an advertising auction service in a similar manner to other embodiments but does not directly provide the benefit of auction participation to the user who has viewed advertisement data, indicates auction participation time provision information in some leading keywords among similar keywords to be outputted in the search window along with a keyword entered by the user upon entering a keyword through a search portal, and provides an auction participation time if search is executed by entering the leading keywords.

In short, like other embodiments, in order to participate in an advertising auction, the user gets the time capable of participating in the advertising auction by viewing advertisement data. Thus, in this embodiment, an advertising auction participation time can be given by selecting leading keywords and executing search upon searching keywords.

Preferably, separate symbols or characters indicative of keywords for providing an advertising auction participation time are indicated in specific leading keywords among similar keywords outputted in the search window.

Accordingly, a search portal homepage 190 configured under the support of the online advertising system in accordance with the fourteenth embodiment of the present invention is provided with a search window 192, and a keyword 194 to be entered by a user is entered in the search window 192.

When the user enters a keyword in the search window 192, a plurality of similar keywords 196 registered and supported in a search portal is generally outputted in the corresponding search window 192. In the present invention, leading keywords 198 for clicking a specific keyword are included in the similar keywords displayed together in the search window 192, and marks or information notifying the user that an auction time can be accumulated are displayed.

At this time, the leading keywords 198 may be keywords similar to the keyword 194 entered by the user or keywords not similar thereto at all.

If the user selects the leading keywords 198, enters them in the search window 192, and clicks on the search button, various search result information 200 as shown in FIG. 43 is displayed on the screen. The search result information 200 is advertiser information, such as Sponsored Links, Power Links, etc., on which the advertisers pay a predetermined advertising cost to the search portal.

Therefore, in the present invention, a predetermined cost for activating the exposure of search result information is paid from the advertisers of the advertisement information displayed in this search result information 200, and the corresponding financial resource is awarded as prize money for an advertising auction.

The functions and operations of the online advertising system thus configured in accordance with the fourteenth embodiment of the present invention will be described in detail with reference to the accompanying drawings.

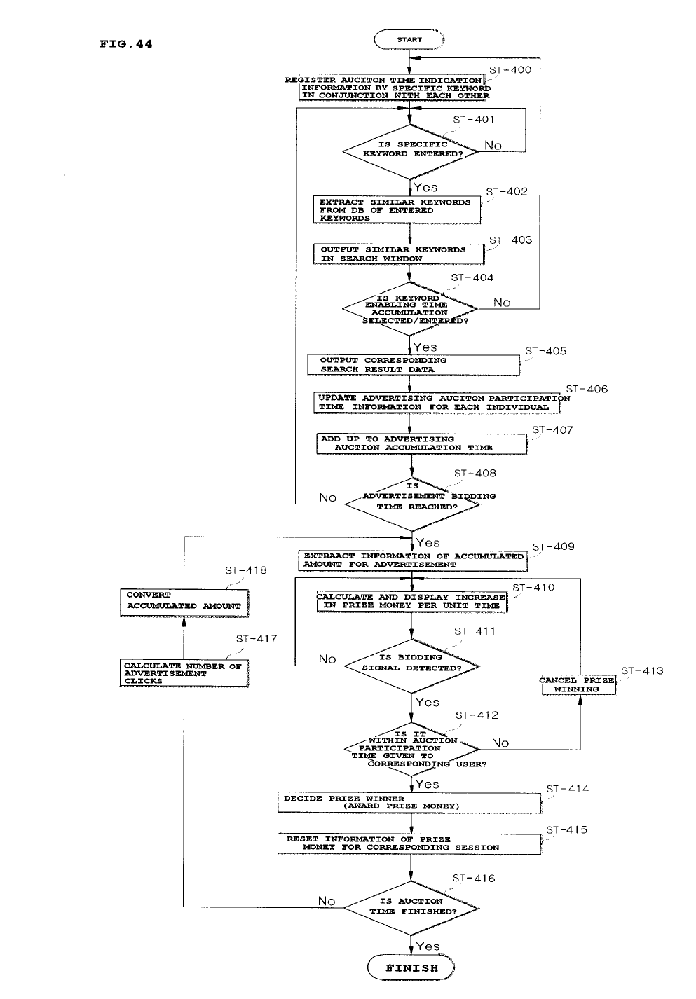

FIG. 44 is a flowchart showing a signal flow of the online advertising system in accordance with the fourteenth embodiment of the present invention.

First, with the application for registration of leading search cost for specific keywords and specific search portal information received from the advertiser terminals B1 to Bn, the online advertising management server OAMS registers leading keywords and auction time indication information in conjunction with each other in the corresponding search portal server (ST-400).

In this state, the search portal server determines whether a specific keyword is entered in the search window (ST-401), extracts leading keyword information established in advance in the DB in conjunction with the corresponding keyword (ST-402), and displays the same on the search window (ST-403).

Then, the search portal server determines whether a signal for selecting/entering a leading keyword enabling auction time accumulation is received from the user terminals A1 to An or not (ST-404). If a signal for selecting/entering a leading keyword enabling users to accumulate an auction time is received, the corresponding search result data is transmitted to the user terminals A1 to An (ST-405).

Then, the search portal server transmits advertising auction participation time accumulation information for the corresponding user to the online advertising management server OAMS, and the online advertising management server OAMS updates the advertising auction participation time accumulation information for the corresponding user (ST-406), and integrates and accumulates reserves for each advertisement in the total accumulated amount of reserve (ST-407).

In this state, the online advertising management server OAMS determines whether the advertising auction bidding time is reached (ST-408). If the advertising auction bidding time is reached, the online advertising management server OAMS divides the integrated and accumulated amount for the advertising auction in given time units (e.g., seconds or minutes)(ST-409), and displays an increase in the accumulated amount with the lapse of each time unit (ST-410). That is, the total accumulated amount for the advertising auction is divided by the advertising auction time, to calculate and display an increase per unit time in the prize money.

If the online advertising management server OAMS receives a bidding signal from any one of the user terminals A1 to An during the displaying of an increase in the reserve amount (ST-411), it determines whether the bidding signal is received within the auction participation time provided to the corresponding user by authentication of the account information of the corresponding user (ST-412).

If the online advertising management server OAMS has received the bidding signal transmitted from the user terminals A1 to An, with the auction participation time provided to the corresponding user exceeded, the online advertising management server OAMS cancels the prize winning of the corresponding bidder (ST-413).

On the other hand, if the online advertising management server OAMS has received the bidding signal transmitted from the user terminals A1 to An within the auction participation time provided to the corresponding user, the online advertising management server OAMS decides the corresponding bidder as the prize winner and awards him or her the prize money (ST-414 and ST-415).

Then, the online advertising management server DAMS determines whether the advertising auction time is finished (ST-416). If there exists any remaining auction time, it receives an advertisement data click signal again from the user terminals A1 to An and calculates it (ST-417), changes the total accumulated amount of money (ST-418), and then returns to the step ST-409.

It is to be understood that the online advertising system and method in accordance with the present invention the present invention are not limited to the above-described embodiments and various changes and modifications can be made without departing from the technical scope of the invention.

1. An online advertising system, comprising:
user terminals having a communication module, such as a modem, installed therein, for viewing advertisement information and product information displayed on web pages by accessing the web pages of an online advertising management server that offers member integrated reserve points;
first to N-th advertiser terminals, which provide and display advertisement information on the web pages of the online advertising management server so as to view advertisement information through the user terminals, and offer a predetermined amount of member integrated reserve points for a customers' advertisement viewing;
first to N-th seller terminals, which provide product information on the web pages of the online advertising management server so as to view product information through the user terminals and display the same for sales, and offer a predetermined amount of member integrated reserve points for the customers' viewing the product information; and
the online advertising management server, which receives the advertisement information and product information from the first to N-th advertiser terminals and the first to N-th seller servers and displays them on web pages, cumulatively accumulates awarded points in member integrated reserve points jointly saved by members in response to advertisement information and product information viewing signals transmitted from the user terminals, performs a discount processing on the purchase price of a corresponding customer with the member integrated reserve points upon receipt of the customers' product purchase signal, updates reserve point data, and sells products uploaded by the seller,
wherein the reserves earned by customers viewing advertisements and product information are jointly accumulated and awarded to purchase customers as a discount amount.

2. The system of claim 1, wherein the online advertising management server comprises:
a web server WBS for routing the URL of the online advertising management server is provided at the online advertising management server so that the first to N-th advertiser terminals, the first to N-th seller servers, and the user terminals can access the online advertising management server; and
first and second databases for storing the member integrated reserve point update information and customer purchase signals, customer information, seller information, and advertiser information.

3. The system of claim 1, wherein the online advertising management server is set to provide advertisement information differentiated by age, sex, and region of a corresponding customer based on members?log-in information.

4. The system of claim 1, wherein the online advertising management server is set to identify a corresponding member through the members' log-in information, and not to pay member integrated reserve points to the same member in reward of viewing the same advertisement.

5. The system of claim 1, wherein the online advertising management server is configured so as to display, at the upper end of the main screen of the web site, accumulation information of member integrated reserve points earned jointly by members by viewing advertisements and product information.

6. The system of claim 1, wherein the online advertising management server comprises:
a communication module which receives the advertisement information and product information from first to N-th advertiser terminals and first to N-th seller servers to display them on web pages, and is provided with a modem in order to receive advertisement information and product information viewing signals transmitted from the user terminals;
an advertisement information management unit which uploads and displays the advertisement information provided from the first to N-th advertiser terminals, and checks and manages a customer access status to the corresponding advertisement information;
a product information management unit which uploads and displays the product information provided from the first to N-th seller servers, and checks and manages a customers' access status to the corresponding product information;
a members information management unit which manages members information such as members gender, age, and region so as to enable target advertisement for member individuals;
an information viewing management unit which manages viewing information for each member about the advertisement information and product information in conjunction with the advertisement information management unit and the product information management unit;
a member integrated reserve management processor which receives advertisement information and product information viewing signals transmitted from the user terminals and updates member integrated reserve information, and pays the corresponding member integrated reserve in response to a product purchase signal transmitted from one of the user terminals, to thereby clear the corresponding member integrated reserve;
a payment processor which executes a payment for a purchase discount using an accumulated member integrated reserve in response to a product purchase signal transmitted from any one of the user terminals in conjunction with the member integrated reserve management processor;
an advertisement information DB for storing advertisement information provided from the first to N-th advertiser terminals;
a product information DB for storing product information provided from the first to N-th seller servers;
a members information DB which stores members information such as members gender, age, region, etc. so as to enable target advertisement for member individuals;
an information viewing DB which stores viewing information for each member about the advertisement information and product information in conjunction with the advertisement information management unit and the product information management unit;
a reserve change information DB which receives advertisement information and product information viewing signals transmitted from the user terminals and updates and stores member integrated reserve information, and updates and stores the corresponding member integrated reserve paid in response to a product purchase signal from a customer;
a product purchase discount information DB which stores information on a purchase discount using an accumulated member integrated reserve in response to a product purchase signal transmitted from any one of the user terminals in conjunction with the member integrated reserve management processor; and
a control unit which receives the advertisement information and product information from first to N-th advertiser terminals and first to N-th seller servers to display them on web pages, drives the member integrated reserve management processor in response to advertisement information and product information viewing signals transmitted from user terminals to thus cumulatively save member integrated reserve points, gives a discount on the corresponding customers' purchase price with the member integrated reserve points by the payment processor 30 upon receipt of a customers' product purchase signal, and performs a sales representation of products uploaded by sellers by driving the member integrated reserve management processor to update reserve point data, to thereby control the revitalization of advertisement viewing.

7. An online advertising method, comprising the steps of:
at advertiser terminals and seller terminals, uploading and registering advertisement information and product information to an online advertising management server which selects advertisement information and product information by a plurality of members to given member integrated reserve points, integrates and accumulates them until a product purchase signal is issued from a specific customer, and pays the member integrated reserve points as discount points when the product purchase signal is issued;
at the online advertising management server, receiving ID and password information and authenticating the information to execute a customers log-in process;
at the online advertising management server, determining whether any viewing signal for a specific advertisement or product information is applied from the user terminals;
at the online advertising management server, giving a predetermined number of points according to the corresponding customers' viewing activity, and adding up the points to the member integrated reserve points;
at the online advertising management server, determining whether a purchase signal for a specific product is applied from any one of the user terminals;
at the online advertising management server, awarding the member integrated reserve points accumulated up to the corresponding point of time as discount points for the corresponding purchased product in response to the customers' product purchase signal; and
updating, at the online advertising management server, the member integrated reserve points to the initial zero state (0).

8. The method of claim 7, wherein the step of determining, at the online advertising management server, whether any viewing signal for a specific advertisement or product information is applied from the user terminals comprises the steps of:
extracting and comparing prestored information about members who have viewed the corresponding advertisement or product information to determine whether the corresponding customer has ever viewed the same advertisement or product information before; and
as a result of the determination of the online advertising management server, if the corresponding customer has never viewed the corresponding advertisement and product information before, performing, at the online advertising management server, no processing on the accumulation of the member integrated reserve points according to the corresponding customer' viewing activity.

9. An online advertising system, comprising:
user terminals having a communication module, such as a modem, installed therein, for viewing advertisement information and product information displayed on web pages by accessing the web pages of an online advertising management server that offers member integrated reserve points;
first to N-th advertiser terminals, which provide and display advertisement information on the web pages of the online advertising management server so as to view advertisement information through the user terminals, and offer a predetermined amount of member integrated reserve points for a customers' advertisement viewing;
first to N-th seller terminals, which provide product information on the web pages of the online advertising management server so as to view product information through the user terminals and display the same for sales, and offer a predetermined amount of member integrated reserve points for the customers' viewing the product information; and
the online advertising management server, which receives the advertisement information and product information from the first to N-th advertiser terminals and the first to N-th seller servers and displays them on web pages, cumulatively accumulates, by category of product displayed according to the customers' selection, awarded points in member integrated reserve points jointly saved by members in response to advertisement information and product information viewing signals transmitted from the user terminals, performs a discount processing with the member integrated reserve points given to the category of the corresponding purchased product upon receipt of a customers' product purchase signal, updates reserve point data for the corresponding category, and sells products uploaded by the seller,
wherein the reserves earned by customers viewing advertisements and product information are jointly accumulated and awarded to purchase customers as a discount amount.

10. An online advertising method, comprising the steps of:
when an ID and password information are transmitted from user terminals, at an online advertising management server, executing customers' log-in process by authentication procedure of the corresponding information;
at the online advertising management server, determining whether any viewing signal for a specific advertisement or product information is applied from the user terminals;
if any viewing signal is applied, at the online advertising management server, extracting category information of a multiplicity of products stored in a database;
at the online advertising management server, transmitting, to the corresponding user terminal, a signal for selecting and requesting one of corresponding categories;
at the online advertising management server, cumulatively updating the member integrated reserve points for the corresponding category in response to the category selection signal transmitted from the user terminals;
at the online advertising management server, determining whether a purchase signal for a specific product is applied from any one of the user terminals;
extracting category information of a product selected by a corresponding customer and member integrated reserve point information accumulated for the corresponding category, and awarding the member integrated reserve points as discount points for the corresponding purchased product; and
at the online advertising management server, updating the member integrated reserve points for the corresponding category to the initial zero state (0).

11. An online advertising system, comprising:
user terminals having a communication module, such as a modem, installed therein, for viewing advertisement information and product information displayed on web pages by accessing the web pages of an online advertising management server that offers member integrated reserve points;
first to N-th advertiser terminals, which provide and display advertisement information on the web pages of the online advertising management server so as to view advertisement information through the user terminals, and offer a predetermined amount of member integrated reserve points for a customers' advertisement viewing;
first to N-th seller terminals, which provide product information on the web pages of the online advertising management server so as to view product information through the user terminals and display the same for sales, and offer a predetermined amount of member integrated reserve points for the customers' viewing the product information; and
the online advertising management server, which receives the advertisement information and product information from the first to N-th advertiser terminals and the first to N-th seller servers and displays them on web pages, classifies each of products by a plurality of product price ranges, cumulatively accumulates, by category of product price range according to the customers' selection, awarded points in member integrated reserve points jointly saved by members in response to advertisement information and product information viewing signals transmitted from the user terminals, performs a discount processing with the member integrated reserve points corresponding to the price range of the corresponding purchased product upon receipt of a customers' product purchase signal, updates reserve point data for the corresponding product price range, and sells products uploaded by the seller,
wherein the reserves earned by customers viewing advertisements and product information are jointly accumulated and awarded to purchase customers as a discount amount.

12. An online advertising method, comprising the steps of:
when an ID and password information are transmitted from user terminals, at an online advertising management server, executing customers' log-in process by authentication procedure of the corresponding information;
at the online advertising management server, determining whether any viewing signal for a specific advertisement or product information is applied from the user terminals;
if any viewing signal is applied, at the online advertising management server, extracting category information of a multiplicity of product price ranges stored in a database;
at the online advertising management server, transmitting, to the corresponding user terminal, a signal for selecting and requesting one of corresponding price ranges;
at the online advertising management server, cumulatively updating the member integrated reserve points for the corresponding price range in response to the price range selection signal transmitted from the user terminals;
at the online advertising management server, determining whether a purchase signal for a specific product is applied from any one of the user terminals;
extracting category information of a product selected by a corresponding customer for purchase and member integrated reserve point information corresponding to the price range of the corresponding purchased product, and awarding the member integrated reserve points as discount points for the corresponding purchased product; and
at the online advertising management server, updating the member integrated reserve points for the corresponding price range to the initial zero state (0).

13. An online advertising method, comprising the steps of:
at an online advertising management server, receiving and setting information on reserve to be given upon advertisement viewing from advertiser terminals;
at the online advertising management server, determining whether a customers' advertisement selection signal is transmitted from user terminals;
at the online advertising management server, extracting point setting information of the corresponding advertisement, and determining whether there exist any remaining points to be paid for the corresponding advertisement;
if there exist no remaining points to be paid for the corresponding advertisement, displaying information that points are unpayable upon advertisement viewing in the advertisement information displayed on the webpage;
if points are unpayable, at the online advertising management server, transmitting point clearing information to the corresponding advertiser terminal;
if there exist any remaining points to be paid for the corresponding advertisement, at the online advertising management server, cumulatively updates awarded points to the member integrated reserve points accumulated;
at the online advertising management server, determining whether a purchase signal for a specific product is applied from any one of the user terminals;
if the purchase signal for a specific product is applied from any one of the user terminals, at the online advertising management server, offering the member integrated reserve points accumulated until the corresponding point of time as discount points for the corresponding purchased product; and
at the online advertising management server, updating the member integrated reserve points with the initial zero state (0).

14. The method of claim 13, wherein the step of receiving and setting information on reserve to be given upon advertisement viewing from advertiser terminals comprises the steps of:
presetting an total point amount to be given upon advertisement viewing; and
setting information of point amount to be offered upon advertisement viewing once.

15. The method of claim 13, wherein the online advertising management server automatically sets an advertisement whose preset payable points are all cleared, displayed on the website, to be outputted on the screen in lower order than other advertisements.

16. The method of claim 13, wherein the online advertising management server automatically deletes an advertisement whose preset payable points are all cleared, displayed on the website.

17. An online advertising system, comprising:
user terminals having a communication module, such as a modem, installed therein, for viewing advertisement information and product information displayed on web pages by accessing the web pages of an online advertising management server that offers member integrated reserve points;
first to N-th advertiser terminals, which provide and display advertisement information on the web pages of the online advertising management server so as to view advertisement information through the user terminals, offer a predetermined amount of member integrated reserve points for a customers' advertisement viewing, and give class information for customer classification and additional purchase discount points by customer class;
first to N-th seller terminals, which provide product information on the web pages of the online advertising management server so as to view product information through the user terminals and display the same for sales, offer a predetermined amount of member integrated reserve points for the customers' viewing the product information, and give class information for customer classification and additional purchase discount points by customer class; and
the online advertising management server, which, with a plurality of user classes from the first to N-th advertiser terminals and the first to N-th seller terminals being classified and registered by product, if a signal for selecting and viewing a specific product information or advertisement is applied from any one of the user terminals, extracts product or advertisement information selected by the corresponding user, extracts the registered class information based on the corresponding user's login information, and further pays special purchase discount points to the corresponding user.

18. The system of claim 17, wherein the special purchase discount points refer to points that are additionally discounted only when the corresponding user issues a purchase signal.

19. The system of claim 17, wherein the user class is subdivided into a plurality of classes by a user?sex, region, and age.

20. The system of claim 17, wherein the online advertising management server comprises:
a communication module which is connected to advertiser servers, seller servers, and user computer terminals, matches a protocol for uploading and downloading various data, and executes data compatible processing;
a user authentication processor which executes authentication of a corresponding user based on the user's login information transmitted from the user computer terminals;
a control unit which controls the entire processors for registering by-product class information in advance, checking any product for which the user terminals issue a viewing signal, extracting the registered class information, determining the class of a corresponding user based on the corresponding user's login information, and giving the user special purchase discount points corresponding to the class;
a sales product class classification processor which registers information by sales product and user class classification information by product transmitted from the advertiser servers and the seller servers, checks an accessed user, and specifies the class of the corresponding user by product;
a user access check processor for checking a connection state of the user terminals signal-connected via the communication module;
an integrated reserve point management processor which manages integrated reserve points given as discount points upon a specific members' issuing a purchase signal and earned jointly by members, regardless of special purchase discount points, in response to an advertisement and product information viewing signal transmitted from the user computer terminals;
a class point management processor which accumulates and manages class points by product given for each user in conjunction with the sales product class classification processor; and
a purchase signal check processor which executes payment processing upon receipt of a purchase signal transmitted from any of the user terminals.

21. An online advertising method, comprising the steps of:
at advertiser terminals and seller servers, for uploading advertisement information and product information to an online advertising management server;
at the advertiser terminals and seller servers, transmitting class information (classified by age, region, and gender) of users who are targeted for the advertisement information and product information to the online advertising management server;
at the online advertising management server, displaying the uploaded advertisement information and product information and class information of users by product and advertisement through separate web pages, and setting the class information to be automatically processed by a processor;
at the online advertising management server, executing a log-in process in response to an ID and password information transmitted from user terminals;
at the online advertising management server, determining whether any viewing signal for a specific advertisement or product information is applied from the user terminals;
if any viewing signal is applied, extracting prestored information about members who have viewed the corresponding advertisement or product information, and extracting class information of users stored in conjunction with the corresponding product information and advertisement information, to thereby determine the class of the corresponding user;
at the online advertising management server, giving a predetermined number of points according to the corresponding customers' viewing activity, cumulatively calculating the corresponding points, and updating member integrated reserve point information;
at the online advertising management server, cumulatively calculating and updating special purchase discount points by class according to the determined class of the corresponding user based on the class information of users stored in conjunction with the corresponding product information and advertisement information;
at the online advertising management server, determining whether a purchase signal for a specific product is applied from any one of the user terminals;
if the purchase signal for a specific product is applied from any one of the user terminals, at the online advertising management server, checking class information of the corresponding user, and paying the member integrated reserve points and the class points of the corresponding user accumulated until the corresponding point of time as discount points; and
at the online advertising management server, updating the member integrated reserve points and the class points of the corresponding user with the initial zero state (0).

22. An online advertising system which comprises an online advertising management server, in which a user terminal selects and registers a specific product in advance, specifies an amount to be discounted with integrated reserve points, and registers an accumulated amount of the integrated reserve points, so that when member integrated reserve points integrated and accumulated by viewing advertisement or product information by the user reach a set number of points of the corresponding user, the online advertising management server automatically issues a purchase signal.

23. The system of claim 22, wherein the online advertising management server comprises:
a communication module which is connected to advertiser servers, seller servers, and user computer terminals, matches a protocol for uploading and downloading various data, and executes data compatible processing;
a user authentication processor which executes authentication of a corresponding user based on the user's login information transmitted from the user computer terminals;
a control unit which automatically gives a given amount of points in response to advertisement viewing and product information viewing signals transmitted from the user terminals, cumulatively calculates and manages member integrated reserve points by accumulating the points so that a specific user issuing a purchase signal can get a discount, receives and registers a reserved purchase signal and point setting information from the user terminals, and automatically issues a purchase signal of the corresponding user at the point of time the member integrated reserve points reaches the set amount of points of the corresponding user to execute a purchase process;
an integrated reserve point management processor which manages integrated reserve points given as discount points upon a specific members' issuing a purchase signal and earned jointly by members, regardless of special purchase discount points, in response to an advertisement and product information viewing signal transmitted from the user computer terminals;
a purchase point setting management processor which receives and registers a reserved purchase signal and point setting information from the user terminals, and automatically issues a purchase signal of the corresponding user at the point of time the member integrated reserve points reach the set amount of points of the corresponding user to execute a reserved purchase process; and
a purchase signal check processor which executes payment processing upon receipt of a purchase signal transmitted from any one of the user computer terminals.

24. An online advertising method, comprising the steps of:
connecting advertiser terminals and seller servers to an online advertising management server, and uploading advertisement information and product information to the online advertising management server;
at the online advertising management server, executing a log-in process in response to an ID and password information transmitted from user terminals;
at the online advertising management server, determining whether an automatic reserved purchase signal is applied from the user terminals connected thereto;
if any automatic reserved purchase signal is not applied from the user terminals, at the online advertising management server, determining whether any viewing signal for a specific advertisement or product information is applied from the user terminals;
if any viewing signal is applied, extracting prestored information about members who have viewed the corresponding advertisement or product information, and cumulatively adding a predetermined amount of points to the member integrated reserve points in reward of the viewing;
at the online advertising management server, determining whether a purchase signal for a specific product is applied from any one of the user terminals;
if an automatic reserved purchase signal, product information and set point information are applied from any one of the user terminals, at the online advertising management server, registering the corresponding product information, set point information and user information;
at the online advertising management server, determining whether a viewing signal for specific advertisement or product information is applied from any one of the user terminals;
if a viewing signal is applied, extracting prestored information about members who have viewed the corresponding advertisement or product information, and cumulatively adding a predetermined amount of points to the member integrated reserve points in reward of the viewing;
at the online advertising management server, determining whether the accumulated member integrated reserve points are equal to registered reserved purchase points;
if reserved purchase points preset by a certain user are equal to the member integrated reserve points, at the online advertising management server, transmitting a payment request signal to the corresponding user computer terminals;
at the online advertising management server, upon receipt of a payment signal from the corresponding user computer terminals, executing payment processing at a discount amount equivalent to the accumulated amount of member integrated reserve points; and
at the online advertising management server, updating the member integrated reserve points with the original zero state (0).

25. An online advertising system, comprising:
user terminals, in which a screen check program of checking output product information of a web browser is installed, for automatically transmitting, to an online advertising management server, product code information to be outputted to the web browser at regular time intervals;
a seller server for transmitting user and time condition information to the online advertising management server so as to pay special purchase points if the number of users displaying the company's product information on the screen and the number of corresponding users are maintained for a predetermined period of time; and
the online advertising management server which receives and registers the number of users displaying the company's product information from the seller servers on the screen, and user and time condition information so as to pay special purchase points if the number of corresponding users are maintained for a predetermined period of time, receives product code information from the screen check program installed on the plurality of user terminals to calculate the total number of users viewing the corresponding product information, and pays special purchase points at the point of time there are a predetermined or less number of corresponding users set by the seller and the number of corresponding users viewing the product information is maintained for a predetermined period of time.

26. An online advertising method, comprising the steps of:
at advertiser terminals and seller servers, uploading, to an online advertising management server, advertisement information, product information, the number of users who are displaying company's product information on the screen, and user and time condition information for paying special purchase points if the number of corresponding users is maintained for a predetermined period of time;
at the online advertising management server, receiving product code information from a screen check program installed on user computer terminals, and calculating the total number of users who are viewing the corresponding product information;
at the online advertising management server, determining whether the number of users who are viewing the same product information is less than a predetermined number set by the seller,
at the online advertising management server, determining whether the corresponding number of users who are viewing is maintained less than the predetermined number for a predetermined period of time;
at the online advertising management server, giving special purchase points at a point of time meeting the corresponding conditions;
if the number of users who are viewing the same product information is not less than the predetermined number set by the seller, or a purchase signal is applied from another user's terminals at the point of time the corresponding number of users who are viewing is not maintained less than a predetermined number for a predetermined period of time, at the online advertising management server, giving member integrated reserve points to the corresponding user as discount points;
if the number of users who are viewing the same product information is less than the predetermined number set by the seller, and a purchase signal is applied from the user's terminals that have received special purchase points at the point of time the corresponding number of users who are viewing is maintained less than a predetermined number for a predetermined period of time, at the online advertising management server, giving member integrated reserve points and special purchase points to the corresponding user as discount points to execute payment processing; and
at the online advertising management server, updating the member integrated reserve points and class points of the corresponding user with the initial zero state (0).

27. An online advertising system which comprises user terminals provided to output, a corresponding application program screen, a screen with purchase desired product information specified by a user in advance, integrated reserve point information, and a purchase decision means on the corresponding screen in conjunction with a variety of application programs (a word-processing program, an image editing program, a game program, and a windows explorer program) that run in Windows.

28. An online advertising system, comprising:
user terminals having a communication module, such as a modem, installed therein, for viewing advertisement information and product information displayed on web pages by accessing the web pages of an online advertising management server that offers member integrated reserve points;
first to N-th advertiser terminals, which provide and display advertisement information on the web pages of the online advertising management server so that a customer can view advertisement information through the user terminals, offer a predetermined amount of member integrated reserve points for the customers' advertisement viewing, sell the advertising/sales assistants advertising costs in an equity manner, and award selective incentives according to the advertising/sales assistant's equity upon selling a product;
first to N-th seller terminals, which provide and display product information on the web pages of the online advertising management server so that a customer can view product information through the user terminals, offer a predetermined amount of member integrated reserve points for the customers' viewing the product information, sell the advertising/sales assistants advertising costs in an equity manner, and award selective incentives according to the advertising/sales assistant's equity upon selling a product;
advertisement/sales assistant terminals, which view advertisement information and product information uploaded by the first to N-th advertiser terminals and the first to N-th seller servers, issue an advertisement/sales assistant apply signal and an advertisement equity purchase signal to the online advertising management server, with a specific product being specified, and issue a payment signal for advertising equity costs; and
the online advertising management server, which receives advertisement information and product information from the first to N-th advertiser terminals and the first to N-th seller servers and displays them on web pages, cumulatively accumulates member integrated reserve points in response to advertisement information and product information viewing signals transmitted from the user terminals, performs a discount processing on the purchase price of a corresponding customer with the member integrated reserve points upon receipt of a customers' product purchase signal, updates reserve point data, sells products uploaded by the seller, sells the advertising/sales assistants advertising costs in an equity manner, and awards selective incentives according to the advertising/sales assistant's equity upon payment processing by a product sales.

29. The system of claim 28, wherein the online advertising management server further comprises a web server for routing URL of the online advertising management server so that the first to N-th advertiser terminals, the first to N-th seller servers and the user terminals can access the online advertising management server, and further first and second databases for storing the member integrated reserve point update information and customer purchase signals, customer information, seller information, advertiser information, advertising/sales assistant information, and equity information for each advertising/seller assistant.

30. An online advertising method, comprising the steps of:
at advertiser terminals and seller servers, uploading advertisement information and product information to an online advertising management server;
at the online advertising management server, displaying the uploaded advertisement information and product information through separate web pages;
at the online advertising management server, receiving product selection information and advertising equity payment information from advertisement/sales assistant terminals, paying an advertising amount for a corresponding equity, and registering the corresponding advertisement/sales assistant information and payment information;
at the online advertising management server, determining whether a product is sold, and whether advertising/sales assistant information related to the corresponding product exists;
if there exist advertising/sales assistant information related to a sold product, at the online advertising management server, giving sales incentives to the corresponding advertising/sales assistant terminals based on equity information contained in the corresponding advertising/sales assistant information;
at the online advertising management server, determining whether the incentives paid due to product sale are greater than or equal to preset incentives by comparison between preset incentive information and information about the incentives paid due to product sales;
if the incentives paid due to product sale are greater than or equal to the preset incentives, at the online advertising management server, paying no incentives to the corresponding advertising/sales assistant; and
if the incentives paid due to product sale are smaller than the preset incentives, at the online advertising management server, continuing to pay incentives on the sale of the corresponding specified product.

31. An online advertising system which comprises a search window for entering a keyword is provided at a predetermined portion of the upper end of the main screen of a web site in order to display a search result of a specific product on the screen, and an online advertising management server having an accumulation order alignment button, an event alignment button, and an alignment-by-region button prepared at the lower end of the main screen of the web site in order to realign search result information in the descending order of member integrated reserve points, or in the descending order of an event amount or discount rate, or to select search result information by region.

32. An online advertising method, comprising the steps of:
at advertiser terminals and seller servers, uploading advertisement information and product information to an online advertising management server;
at the online advertising management server, displaying the uploaded advertisement information and product information through separate web pages;
at the online advertising management server, establishing a database in which the advertisement information and product information are aligned in order of an accumulation and event, or by region;
at the online advertising management server, receiving any one of an accumulation order alignment signal, an event alignment signal, and an alignment-by-region signal from the user computer terminals; and
at the online advertising management server, realigning output information of the advertisement information and product information in response to a signal transmitted from the user computer terminals.

33. An online advertising system, comprising:
advertiser terminals B1 to Bn which register advertisement data in a server, transfers advertising costs per click, and receive member information registered in the server;
user terminals A1 to An provided with a web browser, the user terminals A1 to An having a communication module, such as a modem, installed therein, for viewing advertisement information registered in the server, and checking accumulated prize money information increasing in proportion to the lapse of time at a preset period of time for the auction bidding of advertisement prize money;
an online advertising management server OAMS, which receives and registers advertisement data from the advertiser terminals B1 to Bn, receives an advertisement data viewing signal from the user terminals A1 to An and pays advertising costs, accumulates the advertising costs, cumulatively outputting information of accumulated amount in proportion to the lapse of time when a specific period of time is reached, receives a bidding signal for a specific accumulated amount from the user terminals A1 to An, selects the corresponding user as the prize winner to award the user the prize money, and executes the accumulation of prize money of the next session; and
advertisement data displaying servers which operate in conjunction with the online advertising management server OAMS, and display advertisement data transmitted from the online advertising management server OAMS on the homepages.

34. The system of claim 33, wherein the online advertising management server OAMS comprises a web server WBS for executing web communication with the advertiser terminals B1 to Bn and the user terminals A1 to An.

35. The system of claim 33, wherein the online advertising management server OAMS is preset such that when it receives a bidding signal for a specific accumulated amount from the user terminals A1 to An, it is determined whether the user is a user who clicks on advertisement data more than a predetermined number out of the registered advertisement data, and then the user is selected as the prize winner.

36. The system of claim 33, wherein the online advertising management server OAMS is preset to store the user's IP address of the user terminals A1 to An, MAC address, and cookie information, compare user terminals information that are viewed by advertisement data, and if the same user viewed the same advertisement data multiple times, determines the corresponding advertisement data as being viewed one time.

37. The system of claim 33, wherein the online advertising management server OAMS is preset to select, as the prize winner, a given-numbered user who clicks on the bid button, rather than the first user who clicks on the bid button, but also upon selecting the prize winner, and to randomly extract the order of winning for each session.

38. The system of claim 33, wherein a multiplicity of advertisement data is displayed on the homepage of the advertisement data displaying server, and the advertisement data is displayed in such a manner to divide the amount integrated and accumulated by a multiplicity of users viewing the advertisement data at a preset auction period of time and increase the same with the lapse of time, and winnable amount information changing with the lapse of time and an auction bid button are provided at a side of the winnable amount information.

39. The system of claim 33, wherein the online advertising management server OAMS comprises:
a communication module which receives advertisement data from the advertiser terminals B1 to Bn, receives an advertisement click signal from the user terminals A1 to An, provides accumulated reserve information in real time at an auction period of time, and receives a bidding signal from the user terminals;
a member/advertiser information management unit which registers member information and advertiser information and authenticates them;
an advertisement data registration management unit which registers and manages advertisement data transmitted from the advertiser terminals B1 to Bn;
an advertisement click number calculation unit which receives member information and click information for each advertisement from many company servers having advertisement data displayed on the homepages and calculates and manages them;
an accumulated amount management unit which cumulatively manages advertising costs per advertisement/per click in conjunction with the advertisement click number calculation unit;
an hourly prize money change/update management unit which cumulatively changes the amount of prize money divided by session with the lapse of time, and resets the amount of prize money for the corresponding session when the prize winner is selected;
a member IP management unit which stores and manages the IP or MAC address and cookie information of members in order to prevent repeated clicks on advertisement data and repeated prize winnings in daily auctions;
an advertising cost payment unit which calculates click signals for advertisement data received from the user terminals A1 to An and pays advertisement costs;
a member/advertiser DB for registering member information and advertiser information;
an advertisement data DB for registering advertisement data transmitted from the advertiser terminals B1 to Bn information;
a click number operation DB for receiving and storing member information and click information by advertisement from many company servers that have displayed advertisement data in the homepage;
an accumulated amount/prize money change DB for storing advertising costs per advertisement/per click number;
a member IP management unit which stores and manages the IP or MAC address and cookie information of members in order to prevent repeated clicks on advertisement data and repeated prize winnings in daily auctions;
an advertising cost payment dB which calculates click signals for advertisement data received from the user terminals A1 to An and stores advertisement cost information; and
a control unit which receives and registers advertisement data from the advertiser terminals B1 to Bn, pays advertising costs upon receipt of an advertisement data viewing signal from the user terminals A1 to An, accumulates the advertising costs in real time, determines whether an auction time is reached, divides and accumulates prize money in proportion to the lapse of time, receives a selection signal for a specific amount of prize money from the user terminals A1 to An, selects the corresponding user as the prize winner to award him or her the prize money, and executes the accumulation of prize money for the next session.

40. The system of claim 33, wherein the accumulated amount for the whole advertising auction is divided by the user's clicking on an advertisement and displayed on the advertisement data displaying server separately by advertisement site, along with advertising auction time information, in order to execute individual advertising auction by advertisement site.

41. An online advertising method, comprising the steps of:
at an online advertising management server OAMS, receiving and registering advertisement data from advertiser terminals B1 to Bn;
announcing an auction bidding time on the homepage where the advertisement data is displayed;
at the online advertising management server OAMS, receiving the advertisement data information and click information thereof transmitted from the user terminals A1 to An to calculate the number of clicks per advertisement;
integrating and accumulating the amount of reserve per click for the corresponding advertisement;
at the online advertising management server OAMS, determining whether the auction bidding time is reached;
if the auction bidding time is reached, at the online advertising management server OAMS, dividing the total amount of reserve in the auction in given time units (e.g., seconds or minutes), and displaying an increase in the reserve amount with the lapse of each time unit;
at the online advertising management server OAMS receiving a bidding signal from any one of the user terminals A1 to An during the displaying of an increase in the reserve amount;
at the online advertising management server OAMS, fixing the accumulated prize money at the corresponding point of time as the prize money to be awarded to the corresponding bidder;
deducting the prize money for the corresponding session from the total accumulated amount of prize money;
at the online advertising management server OAMS, determining whether the auction time is finished; and
if the auction time is finished, at the online advertising management server OAMS, awarding the prize winner for each session the prize money.

42. The method of claim 41, wherein the step of receiving a bidding signal further comprises the step of receiving a click signal and user information transmitted from each of the user terminals A1 to An, sequentially accumulating them in a DB, and selecting a given-numbered user as a prize winner.

43. The method of claim 41, wherein the step of receiving the advertisement data information and click information further comprises the steps of:
when the online advertising management server OAMS receives advertisement data information and its click information from the user terminals A1 to An, determining whether there exists an account (ID, cookie information, IP, and MAC address) of the same user for the click information of the corresponding advertisement; and
if the same user has ever clicked on the same advertisement data, at the online advertising management server OAMS, accumulating no reserve for the user's clicking.

44. The method of claim 41, further comprising, between the step of receiving a bidding signal and the step of fixing the accumulated prize money at the corresponding point of time as the prize money, the steps of:
determining whether the number of the corresponding user's clicks on the advertisement on the same date is greater than or equal to a preset number of clicks by authentication of account information of the corresponding user;
if the number of the corresponding user's clicks on the advertisement on the same date is smaller than a preset number of clicks, canceling the prize winning of the corresponding user; and
as a result of determination of the online advertising management server OAMS, if the number of the corresponding user's clicks on the same advertisement is greater than or equal to a preset number of clicks, fixing the corresponding user as a prize winner.

45. The method of claim 41, wherein the step of awarding the prize winner for each session the prize money further comprises the step of:
at the online advertising management server OAMS, determining whether a corresponding preliminary winner is a member or not through a member account received through the user terminals A1 to An;
if the preliminary winner is not a member, counting a stand-by time;
after the lapse of a given set time, determining whether the corresponding preliminary winner has subscribed;
if preliminary winner has not subscribed, canceling the winning of the corresponding user;
adding the prize winning amount for the corresponding session to the total accumulated amount; and
if the corresponding preliminary winner has subscribed for a predetermined time or is an existing member, at the online advertising management server OAMS, deciding the corresponding preliminary winner as the prize winner for the corresponding session, and awarding him or her the prize money.

46. The method of claim 41, wherein the step of fixing the accumulated prize money at the corresponding point of time as the prize money further comprises the step of:
at the online advertising management server OAMS, accumulating and storing bidder information by bid order;
extracting information of the first bidder who issues a bidding signal and deciding him or her as a prize winner; and
at the online advertising management server OAMS, terminating the corresponding session, awarding an accumulated amount for the corresponding session as prize money, and resetting the accumulated amount information for the corresponding session.

47. An online advertising method, comprising the steps of:
at an online advertising management server OAMS, receiving advertisement data from the advertiser terminals B1 to Bn and registering it;
announcing a whole advertising auction and an individual advertising auction bidding time by advertisement site on the homepage of a company where the advertisement data is displayed;
at the online advertising management server OAMS, receives advertisement data information and its click information from the user terminals A1 to An, and calculating the number of clicks for each advertisement;
accumulating a reserve amount by click of the corresponding advertisement separately as a share of the whole advertising auction and a share of the advertising auction for each advertising side;
at the online advertising management server OAMS, determining whether the whole advertising auction bidding time is reached;
if the whole advertising auction bidding time is reached, at the online advertising management server OAMS, dividing the accumulated amount for the whole advertising auction in given time units (e.g., seconds or minutes), and displays an increase in the accumulated amount with the lapse of each time unit;
at the online advertising management server OAMS, receiving a bidding signal from any one of the user terminals A1 to An during the displaying of an increase in the accumulated amount;
at the online advertising management server OAMS, awarding a prize winner of each session a prize money;
deducting the prize money of the corresponding session from the total accumulated prize money amount;
at the online advertising management server OAMS, determining whether the whole advertising auction time is finished;
if the whole advertising auction time is finished, at the online advertising management server OAMS, extracting information of the accumulated amount for each advertisement data;
dividing the accumulated amount for the corresponding advertisement in given time units (e.g., seconds or minutes), and displaying an increase in the accumulated amount with the lapse of each time unit;
at the online advertising management server OAMS, receiving a bidding signal from any one of the user terminals A1 to An deducting the corresponding prize money amount from the accumulated prize money amount;
at the online advertising management server OAMS, determining whether the corresponding individual advertising auction time is finished; and
if the individual advertising auction time is finished, at the online advertising management server OAMS, awarding the prize money to the prize winner for each session.

48. The method of claim 47, wherein the step of receiving a bidding signal restricts a user who can participate in an individual advertising auction for each advertisement and issue a bidding time to a user who viewed the corresponding advertisement information on the corresponding date.

49. The method of claim 47, wherein the step of receiving a bidding signal further comprises the steps of:
determining whether the corresponding user has ever clicked on the corresponding advertisement data on the corresponding date based on the account information of the corresponding user;
if the corresponding user has never clicked on the corresponding advertisement data on the corresponding date, at the online advertising management server OAMS, determining whether the corresponding advertisement has ever clicked for a set period of time by counting the number of clicks for a predetermined time;
if the advertisement has been clicked, fixing the prize money and deducting the corresponding prize money amount from the accumulated prize money amount;
if the advertisement has never been clicked, canceling the corresponding prize winner; and
as a result of the online advertising management server OAMS, if the corresponding user has ever clicked on the corresponding advertisement data on the corresponding date, fixing the amount of prize money at the corresponding point of time.

50. An online advertising method, comprising the steps of:
at an online advertising management server OAMS, receiving and registering advertisement data from advertiser terminals B1 to Bn;
announcing an auction bidding time and a bidding condition on the homepage where the advertisement data is displayed;
at the online advertising management server OAMS, receiving advertisement data information and its click information from the user terminals A1 to An;
integrating and accumulating the amount of reserve for each advertisement in the total accumulated amount of reserve, extracting auction time information for the corresponding advertisement, and giving an auction participation time for an individual;
at the online advertising management server OAMS, determining whether the advertising auction bidding time is reached;
if the advertising auction bidding time is reached, at the online advertising management server OAMS, dividing the integrated and accumulated amount for the advertising auction in given time units, and displays an increase in the accumulated amount with the lapse of each time unit;
at the online advertising management server OAMS determining whether a bidding signal is received from any one of the user terminals A1 to An during the displaying of an increase in the reserve amount;
determining whether the bidding signal is received within the auction participation time provided to the corresponding user by authentication of the account information of the corresponding user;
if the bidding signal transmitted is received from the user terminals A1 to An, with the auction participation time provided to the corresponding user being exceeded, at the online advertising management server OAMS, canceling the prize winning of the corresponding bidder;
if the online advertising management server OAMS has received the bidding signal transmitted from the user terminals A1 to An within the auction participation time provided to the corresponding user, deciding the corresponding bidder as the prize winner and awarding him or her the prize money; and
at the online advertising management server OAMS, determining whether the advertising auction time is finished, and if there exists any remaining auction time, receiving and calculating an advertisement data click signal again from the user terminals A1 to An, and executing an auction for the next session while changing the total accumulated amount of money.

51. The method of claim 50, wherein the step of integrating and accumulating the amount of reserve further comprises the step of differentially offering the auction participation time provided by the online advertising management server OAMS by the advertiser's selection, or offering the auction participation time differentiated by the type of advertisement data.

52. An online advertising system, comprising:
advertiser terminals B1 to Bn for registering advertisement data in a server, transferring advertising costs per click, and receiving member information registered in the server;
user terminals A1 to An provided with a web browser, the user terminals having a communication module, such as a modem, installed therein for viewing advertisement data registered in the server, checking accumulated prize money information increasing in proportion to the lapse of time at a preset period of time for bidding for an advertising prize money auction and issuing a bidding signal for a specific prize money;
user cellular phones C1 to Cn for receiving an authentication signal from an online advertising management server OAMS to issue a wireless internet automatic callback setting request signal, receiving and viewing advertisement data from the online advertising management server OAMS, and automatically transmitting the viewing information to the online advertising management server OAMS;
the online advertising management server OAMS, which receives and registers advertisement information from the advertiser terminals B1 to Bn, receives an advertisement viewing signal from the user terminals A1 to An and the user cellular phones C1 to Cn and pays advertising costs, accumulates the advertising costs, cumulatively outputs accumulated amount information in proportion to the lapse of time when a specific period of time is reached, receives a bidding signal for a specific accumulated amount from the user terminals A1 to An, selects the corresponding user as the prize winner to award the user the prize money, and executes the accumulation of prize money of the next session;
a web server WBS for executing web communication with the advertiser terminals B1 to Bn and the user terminals A1 to An and a WAP server WAPS for performing a wireless data communication through the user cellular phones C1 to Cn, which are provided within the online advertising management server OAMS; and
an advertisement data displaying server, which operates in conjunction with the online advertising management server OAMS, and display advertisement data transmitted from the online advertising management server OAMS on the homepages.

53. An online advertising method using the system of claim 52, the method comprising the steps of:
at an online advertising management server OAMS, receiving and registering advertisement data from advertiser terminals B1 to Bn;
receiving a cellular phone registration request signal for advertisement reception from user cellular phones C1 to Cn, and registering and authenticating the corresponding cellular phone number;
at the online advertising management server OAMS, transmitting a callback URL information to the user cellular phones C1 to Cn;
when the corresponding callback URL is selected by the user cellular phones C1 to Cn, accessing the online advertising management server OAMS, which is the address of the corresponding URL, and transmitting advertisement data preset in the corresponding URL to the user cellular phones C1 to Cn to output the same on the screen;
at the online advertising management server OAMS, registering auction participation time information and user information provided in reward for the viewing of advertisement data transmitted to the user cellular phones C1 to Cn, and integrating and accumulating reserves for each advertisement in the total accumulated amount of reserve;
at the online advertising management server OAMS, determining whether the advertising auction bidding time is reached;
if the advertising auction bidding time is reached, at the online advertising management server OAMS, dividing the integrated and accumulated amount for the advertising auction in given time units (seconds/minutes), and displaying an increase in the accumulated amount with the lapse of each time unit;
receiving a bidding signal from any one of the user terminals A1 to An or any one of the user cellular phones C1 to Cn during the displaying of an increase in the reserve amount;
determining whether the bidding signal is received within the auction participation time provided to the corresponding user by authentication of the account information of the corresponding user;
if the online advertising management server OAMS has received the bidding signal transmitted from the user terminals A1 to An or the user cellular phones C1 to Cn, with the auction participation time provided to the corresponding user exceeded, canceling the prize winning of the corresponding bidder;
if the online advertising management server OAMS has received the bidding signal transmitted from the user terminals A1 to An within the auction participation time provided to the corresponding user, deciding the corresponding bidder as the prize winner and awards him or her the prize money;
at the online advertising management server OAMS, determining whether the advertising auction time is finished; and
if there exists any remaining auction time, receiving an advertisement data click signal again from the user terminals A1 to An and calculates it, and executing an auction for the next session while changing the total accumulated amount of money.

54. An online advertising system, comprising:
advertiser terminals B1 to Bn for registering advertisement data in a server, transferring advertising costs per click and leading keyword selection costs, and receiving member information registered in the server;
user terminals A1 to An provided with a web browser, the user terminals having a communication module, such as a modem, installed therein for viewing advertisement data registered in the server, selecting a leading keyword displayed in a search window of search portal and receiving a reserve amount and a reserve time, checking accumulated prize money information increasing in proportion to the lapse of time at a preset period of time for bidding for an advertising prize money auction and issuing a bidding signal for a specific prize money;
the online advertising management server OAMS, which receives and registers advertisement information from the advertiser terminals B1 to Bn, receives an advertisement data viewing signal from the user terminals A1 to An and the user cellular phones C1 to Cn or a signal for selecting a leading keyword outputted in the search window from a search portal server and pays advertising costs, accumulates the advertising costs, accumulates the advertising costs and cumulatively outputs accumulated amount information in proportion to the lapse of time when a specific period of time is reached, receives a bidding signal for a specific accumulated amount from the user terminals A1 to An, selects the corresponding user as the prize winner to award the user the prize money, and executes the accumulation of prize money of the next session;
an advertisement data displaying server, which operates in conjunction with the online advertising management server OAMS, and display advertisement data transmitted from the online advertising management server OAMS on the homepages; and
the search portal server for storing leading keyword information transmitted from the online advertising management server OAMS in a DB in conjunction with a specific keyword and similar keywords similar thereto, receiving an entered signal of the specific keyword from the user terminals A1 to An and displaying the similar keywords and leading keywords in the search window, and receiving a selection signal of the leading keywords to transmit it to the online advertising management server OAMS.

55. The system of claim 54, wherein the search portal server is implemented such that information that the auction participation time is provided to a user who selected the leading keyword is indicated as character or pattern separately in the leading keyword outputted along with the similar keywords through the search window.

56. The system of claim 54, wherein the leading keywords are keywords similar to the keyword entered by the user or keywords not similar thereto at all are established in a DB in conjunction with the specific keyword.

57. An online advertising method using the system of claim 54, the method comprising the steps of:
at an online advertising management server OAMS, with the application for registration of leading search cost for specific keywords and specific search portal information received from the advertiser terminals B1 to Bn, registering leading keywords and auction time indication information in conjunction with each other in the corresponding search portal server;
at the search portal server, determining whether a specific keyword is entered in the search window;
extracting leading keyword information established in advance in the DB in conjunction with the corresponding keyword, and displaying the same on the search window;
at the search portal server, determining whether a signal for selecting/entering a leading keyword enabling auction time accumulation is received from the user terminals A1 to An or not;
if a signal for selecting/entering a leading keyword enabling users to accumulate an auction time is received, transmitting the corresponding search result data to the user terminals A1 to An;
at the search portal server, transmitting advertising auction participation time accumulation information for the corresponding user to the online advertising management server OAMS;
at the online advertising management server OAMS, updating the advertising auction participation time accumulation information for the corresponding user, and integrating and accumulating reserves for each advertisement in the total accumulated amount of reserve;
at the online advertising management server OAMS, determining whether the advertising auction bidding time is reached, if the advertising auction bidding time is reached, at the online advertising management server OAMS, dividing the integrated and accumulated amount for the advertising auction in given time units (seconds/minutes), and displaying an increase in the accumulated amount with the lapse of each time unit;
at the online advertising management server OAMS, determining whether a bidding signal is received from any one of the user terminals A1 to An during the displaying of an increase in the reserve amount;
determining whether the bidding signal is received within the auction participation time provided to the corresponding user by authentication of the account information of the corresponding user;
if the online advertising management server OAMS has received the bidding signal transmitted from the user terminals A1 to An, with the auction participation time provided to the corresponding user exceeded, canceling the prize winning of the corresponding bidder;
if the online advertising management server OAMS has received the bidding signal transmitted from the user terminals A1 to An within the auction participation time provided to the corresponding user, deciding the corresponding bidder as the prize winner and awards him or her the prize money;
at the online advertising management server OAMS, determining whether the advertising auction time is finished; and
if there exists any remaining auction time, receiving and calculating an advertisement data click signal again from the user terminals A1 to An, and executing an auction for the next session while changing the total accumulated amount of money.
